(19) United States
(12) Patent Application Publication
(10) Pub. No.: US 2023/0359851 A1
(43) Pub. Date: Nov. 9, 2023

(54) PORTABLE WIRELESS NETWORK ENHANCEMENT DEVICE AND ASSOCIATED METHODS

(71) Applicant: Trackonomy Systems, Inc., San Jose, CA (US)

(72) Inventors: Hendrik J. Volkerink, Palo Alto, CA (US); Ajay Khoche, West San Jose, CA (US); Lawrence William Mcgary, JR., Pacific Palisades, CA (US); Amanuel Zeryihun, San Jose, CA (US)

(21) Appl. No.: 18/143,452

(22) Filed: May 4, 2023

Related U.S. Application Data
(60) Provisional application No. 63/338,031, filed on May 4, 2022.
(60) Provisional application No. 63/339,386, filed on May 6, 2022.

(51) Int. Cl. G06K 19/07; H04W 76/15; G06K 19/077

(52) U.S. Cl. CPC G06K 19/0724; H04W 76/15; G06K 19/07798

(57) ABSTRACT

A portable device may include a housing sized and shaped to enclose: a power source, a wireless communication module including an antenna and associated transceiver circuitry coupled with the antenna to receive and transmit wireless signals, a human-interaction interface, a memory storing computer-readable instructions; and a processor in communication with the power source, the wireless communication module, and the memory. The housing may be sized and shaped to self-stand when placed at a location. The computer-readable instructions, when executed by the processor, may cause the portable device to: scan, using the wireless communication module, for ones of the plurality of wireless nodes within operating range of the wireless communication module, receive, in response to the scan, wireless-node data from responding ones of the plurality of wireless nodes, generate a user-interpretable signal based on the wireless-node data; and output, using the human-interaction interface, the user-interpretable signal.

### CROSS-REFERENCE TO RELATED APPLICATIONS

This application claims priority to, and benefits from, U.S. Provisional Application Ser. No. 63/338,031, entitled “Smart Cone” and filed May 4, 2022. This application also claims priority to, and benefits from, U.S. Provisional Application Ser. No. 63/339,386, entitled “Interface and Software for Locating an Asset Using a Wireless IOT System and Method Thereof” and filed May 6, 2022. Each of the aforementioned applications are incorporated by reference herein in their entirety.

### FIELD OF THE DISCLOSURE

This disclosure generally relates to wireless internet of things (IOT) devices.

### BACKGROUND

Installing additional IOT devices, sensors, and other electronics devices increases the complexity of managing an environment and workflows. For applications where tracking of assets and wireless communications are required, it is desirable to be able to implement wireless network infrastructure and tracking capabilities without increasing the number of objects, devices, and other factors that need to be installed or placed in an environment.

### SUMMARY

Disclosed herein is a smart cone that has the appearance and structure of a cone, pylon, a sign, a post, a delineator tube, or another marker object, all of which may be referred to herein as a “cone,” while being integrated with electronics for wireless communication and asset tracking capabilities. The smart cone acts as an infrastructure node for a wireless IOT device network that is configured to communicate with wireless nodes of the IOT network while also functioning as a cone for other practical purposes.

In some aspects, the techniques described herein relate to a portable device for enhancing network of a plurality of wireless nodes, including: a housing sized and shaped to enclose: a power source; a wireless communication module including an antenna and associated transceiver circuitry coupled with the antenna to receive and transmit wireless signals; a human-interaction interface; a memory storing computer-readable instructions; and a processor in communication with the power source, the wireless communication module, and the memory; the housing being sized and shaped to self-stand when placed at a location; the computer-readable instructions, when executed by the processor, cause the portable device to: scan, using the wireless communication module, for ones of the plurality of wireless nodes within operating range of the wireless communication module; receive, in response to the scan, wireless-node data from responding ones of the plurality of wireless nodes; generate a user-interpretable signal based on the wireless-node data; and output, using the human-interaction interface, the user-interpretable signal.

In some aspects, the techniques described herein relate to a method for performing a task using a portable wireless network enhancement device, the method including: assigning a task to the portable wireless network enhancement device; receiving, at the portable wireless network enhancement device, wireless node data from at least one wireless node; generating a user-interpretable signal based on the wireless-node data; and, control a human-interaction interface based on the user-interpretable signal.

### BRIEF DESCRIPTION OF THE FIGURES

FIG. 1 is a schematic illustrating one example adhesive tape-agent platform used to seal a package for shipment, in embodiments.

FIG. 2 is a schematic illustrating a non-adhesive surface of a segment of the adhesive tape agent platform of FIG. 1, in embodiments.

FIG. 3 shows one example adhesive tape platform that includes a set of adhesive tape platform segments on a backing sheet, in embodiments.

FIG. 4 is a block diagram illustrating components of an example wireless transducing circuit that includes one or more wireless communication modules, in embodiments.

FIG. 5 is a top view of a portion of an example flexible adhesive tape platform illustrating a first segment and a portion of a second segment, in embodiments.

FIGS. 6A-C are schematic diagrams illustrating cross-sectional side views of portions of example segments of three types of flexible adhesive tape agent platforms, in embodiments.

FIG. 7 shows an example network communications environment that includes a network for communication between one or more servers, mobile gateways, and various types of tape nodes that are associated with assets, in embodiments.

FIG. 8 is a schematic illustrating an example network communications environment that includes a network supporting communications between servers, mobile gateways, a stationary gateway, and various types of tape nodes associated with various assets, in embodiments.

FIG. 9 is a schematic illustrating one example hierarchical wireless communications network of tape nodes, in embodiments.

FIG. 10A shows a node (Node A) associated with a package (Package A), in embodiments.

FIG. 10B shows a node (Node C) associated with a package (Package C), in embodiments.

FIG. 10C shows a pallet associated with a master node that includes a low-power communications interface, a GPS receiver, and a cellular communications interface, in embodiments.

FIG. 11 is a schematic illustrating a truck configured as a mobile node, or mobile hub, with a cellular communications interface, a medium-power communications interface, and a low power communications interface, in embodiments.

FIG. 12 is a schematic illustrating a master node associated with a logistic item that is grouped together with other logistic items associated with peripheral nodes, in embodiments.

FIG. 13A is a schematic diagram illustrating an adhesive tracking product with a first example wake circuit that delivers power from an energy source to the tracking circuit in response to an event, in embodiments.

FIG. 13B is a schematic diagram illustrating an adhesive tracking product with a second example wake circuit that delivers power from an energy source to the tracking circuit in response to an event, in embodiments.

FIG. 13C is a diagrammatic cross-sectional front view of an example adhesive tape platform and a perspective view of an example asset, in embodiments.

FIG. 14 shows an example wireless network having a portable wireless network enhancement device included therein to provide additional fidelity to infrastructure components within the wireless network.

FIG. 15 shows the portable wireless network enhancement device in additional detail, in embodiments.

FIG. 16 shows a block diagram of various components of portable wireless network enhancement device, including the enhancement controller of FIG. 15 in further detail, in embodiments.

FIG. 17 shows an embodiment of portable wireless network enhancement device having a cone form factor.

FIG. 18 shows an embodiment of portable wireless network enhancement device having a box (or “briefcase”) form factor.

FIG. 19A and FIG. 19B show a side view and front view, respectively, of a “pluggable” form factor in including a plug that directly plugs into a wall socket.

FIG. 20 shows application of portable wireless network enhancement device in use with an external device, in an embodiment.

FIG. 21 shows an example storage rack, storing a plurality of portable wireless network enhancement devices, in an embodiment.

FIG. 22 shows a working example of wireless network, wherein a user may utilize user device to obtain information related to wireless node, either from user device or additionally or alternatively using portable wireless network enhancement device.

FIG. 23 shows an example map including a virtual representation of wireless monitor area radius showing asset closest to portable wireless network enhancement device.

FIG. 24 shows a working example of wireless network wherein portable wireless network enhancement device is placed in a hospital setting to monitor location of one or more assets, in an embodiment.

FIG. 25 shows an example display of various searched—for “bladder scanners” in list-format, as opposed to map-format of FIG. 24.

FIGS. 26-28 show a series of screen shots of potential user-device application that is used to provide input.

FIG. 29 is a flowchart of an example method for performing a task using a portable wireless network enhancement device.

FIG. 30 shows an example embodiment of computer apparatus that, either alone or in combination with one or more other computing apparatus, is operable to implement one or more of the computer systems described in this specification.

### DETAILED DESCRIPTION OF THE EMBODIMENTS

The present invention is not limited in any way to the illustrated embodiments. Instead, the illustrated embodiments described below are merely examples of the invention. Therefore, the structural and functional details disclosed herein are not to be construed as limiting the claims. The disclosure merely provides bases for the claims and representative examples that enable one skilled in the art to make and use the claimed inventions. Furthermore, the terms and phrases used herein are intended to provide a comprehensible description of the invention without being limiting.

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements and are not drawn to scale.

The term “tape node” refers to an adhesive tape platform or a segment thereof that is equipped with sensor, processor, memory, energy source/harvesting mechanism, and wireless communications functionality, where the adhesive tape platform (also referred to herein as an “adhesive product” or an “adhesive tape product”) has a variety of different form factors, including a multilayer roll or a sheet that includes a plurality of divisible adhesive segments. Once deployed, each tape node can function, for example, as an adhesive tape, label, sticker, decal, or the like, and as a wireless communications device.

In some contexts, the term “agent” may refer to a “node”, and an “agent” or “node” may be adhesively applied to a surface and denoted as a “tape node” or “tape agent”. These terms may be used interchangeably, depending on the context. Further, the “agent” or “node” may have two forms of hierarchy: one depending on the functionality of the “agent” or “node”, such as the range of a wireless communication interface, and another depending on which “agent” or “node” may control another “agent” or “node”. For example, an agent with a low-power wireless-communication interface may be referred to a “master agent”.

In some embodiments, a low-power wireless communication interface may have a first wireless range and be operable to implement one or more protocols including Zigbee, near-field communication (NFC), Bluetooth Low Energy, Bluetooth Classic, Wi-Fi, and ultra-wideband. For example, the low-power wireless-communication interface may have a range of between 0 and 300 meters or farther, depending on the implemented protocol. The communication interface implementation, e.g., Zigbee or Bluetooth Low Energy, may be selected based upon the distance of communication between the low-power wireless-communication interface and the recipient, and/or a remaining battery level of the low-power wireless-communication interface.

An agent with a medium-power wireless communication-interface may be referred to as a “secondary agent”. The medium-power wireless communication interface may have a second wireless range and be operable to implement one or more protocols including Zigbee, Bluetooth Low Energy interface, LoRa. For example, the medium-power wireless-communication interface may have a range of between 0 and 20 kilometers. The communication interface implementation, e.g., Zigbee, Bluetooth Low Energy, or LoRa, may be selected based upon the distance of communication between the medium-power wireless-communication interface and the recipient, and/or a remaining battery level of the medium-power wireless-communication interface.

An agent with a high-power wireless communication-interface may be referred to as a “tertiary agent”. The high-power wireless communication interface may have a third wireless range and be operable to implement one or more protocols including Zigbee, Bluetooth Low Energy, LoRa, Global System for Mobile Communication, General Packet Radio Service, cellular, near-field communication, and radio-frequency identification. For example, the high-power wireless-communication interface may have a global range, where the high-power wireless-communication interface may communicate with any electronic device implementing a similar communication protocol. The communication interface protocol selected may depend on the distance of communication between the high-power wireless-communication interface and a recipient, and/or a remaining battery level of the high-power wireless-communication interface.

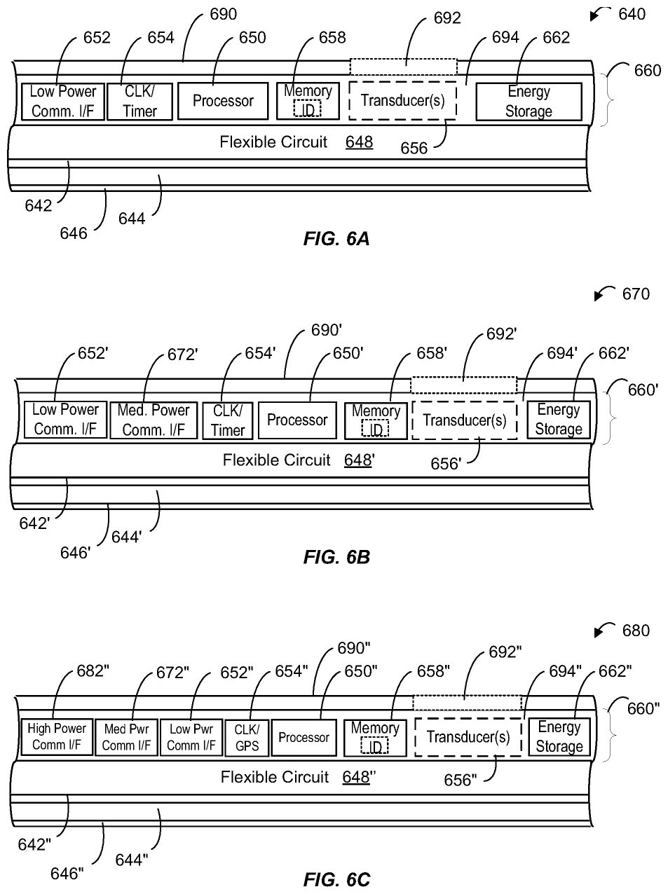

In some examples, a secondary agent may also include a low-power wireless-communication interface and a tertiary agent may also include low and medium-power wireless-communication interfaces, as discussed below with reference to FIGS. 6A-C. Further continuing the example, a “master agent”, a “secondary agent”, or a “tertiary agent” may refer to a “master tape node”, a “secondary tape node”, or a “tertiary tape node”.

With regard to the second form of hierarchy, the “agent”, “node”, “tape agent”, and “tape node”, may be qualified as a parent, child, or master, depending on whether a specific “agent” or “node” controls another “agent” or “node”. For example, a master-parent agent controls the master-child agent and a secondary or tertiary-parent agent controls a master-child agent. The default, without the qualifier of “parent” or “child” is that the master agent controls the secondary or tertiary agent Further, the “master tape node” may control a “secondary tape node” and a “tertiary tape node”, regardless of whether the master tape node is a parent node.

Further, each of the “agents”, “nodes”, “tape nodes”, and “tape agents” may be referred to as “intelligent nodes”, “intelligent tape nodes”, “intelligent tape agents”, and/or “intelligent tape agents” or any variant thereof, depending on the context and, for ease, may be used interchangeably.

Further, each of the “agents”, “nodes”, “tape nodes”, and “tape agents” may include flexible or non-flexible form factors unless otherwise specified. Thus, each of the “agents”, “nodes”, “tape nodes”, and “tape agents” include flexible and non-flexible (rigid) form factors, or a combination thereof including flexible components and non-flexible components.

An adhesive tape platform includes a plurality of segments that may be separated from the adhesive product (e.g., by cutting, tearing, peeling, or the like) and adhesively attached to a variety of different surfaces to inconspicuously implement any of a wide variety of different wireless communications-based network communications and transducing (e.g., sensing, actuating, etc.) applications. In certain embodiments, each segment of an adhesive tape platform has an energy source, wireless communication functionality, transducing hardware/functionality (e.g., sensor and energy harvesting functionality), and processing hardware/functionality that enable the segment to perform one or more transducing functions and report the results to a remote server or other computer system directly or through a network (e.g., formed by tape nodes and/or other network components). The components of the adhesive tape platform are encapsulated within a flexible adhesive structure that protects the components from damage while maintaining the flexibility needed to function as an adhesive tape (e.g., duct tape or a label) for use in various applications and workflows. In addition to single function applications, example embodiments also include multiple transducers (e.g., sensing and/or actuating transducers) that extend the utility of the platform by, for example, providing supplemental information and functionality relating characteristics of the state and/or environment of, for example, an article, object, vehicle, or person, over time.

Systems and processes for fabricating flexible multifunction adhesive tape platforms in efficient and low-cost ways also are described in US Patent Application Publication No. US-2518-0165568-A1. For example, in addition to using roll-to-roll and/or sheet-to-sheet manufacturing techniques, the fabrication systems and processes are configured to optimize the placement and integration of components within the flexible adhesive structure to achieve high flexibility and ruggedness. These fabrication systems and processes are able to create useful and reliable adhesive tape platforms that may provide local sensing, wireless transmitting, and positioning functionalities. Such functionality together with the low cost of production is expected to encourage the ubiquitous deployment of adhesive tape platform segments and thereby alleviate at least some of the problems arising from gaps in conventional infrastructure coverage that prevent continuous monitoring, event detection, security, tracking, and other logistics applications across heterogeneous environments.

In certain contexts, the terms “parcel,” “envelope,” “box,” “package,” “container,” “pallet,” “carton,” “wrapping,” and the like are used interchangeably herein to refer to a packaged item or items.

In certain contexts, the terms “wireless tracking system,” “hierarchical communications network,” “distributed agent operating system,” and the like are used interchangeably herein to refer to a system or network of wireless nodes.

As used herein, the term “or” refers an inclusive “or” rather than an exclusive “or.” In addition, the articles “a” and “an” as used in the specification and claims mean “one or more” unless specified otherwise or clear from the context to refer the singular form.

The terms “module,” “manager,” “component”, and “unit” refer to hardware, software, or firmware, or a combination thereof. The term “processor” or “computer” or the like includes one or more of: a microprocessor with one or more central processing unit (CPU) cores, a graphics processing unit (GPU), a digital signal processor (DSP), a field-programmable gate array (FPGA), a system-on-chip (SoC), a microcontroller unit (MCU), and an application-specific integrated circuit (ASIC), a memory controller, bus controller, and other components that manage data flow between said processor associated memory, and other components communicably coupled to the system bus. Thus the terms “module,” “manager,” “component”, and “unit” may include computer-readable instructions that, when executed by a processor, implement the functionality discussed herein with respect to said “module,” “manager,” “component”, and “unit”.

### Adhesive Tape Agent Platform

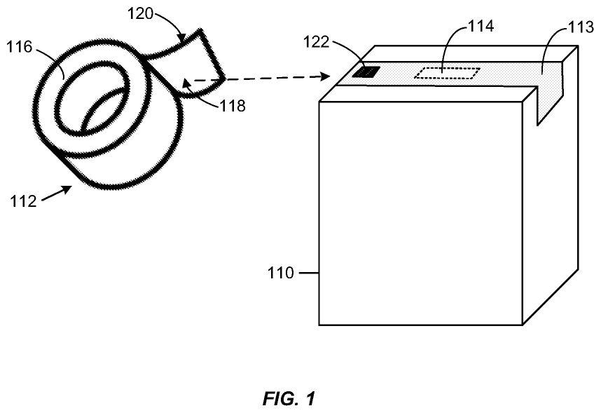

FIG. 1 is a schematic showing one example adhesive tape-agent platform 112, including wireless transducing circuit 114, used to seal a package 110 for shipment. In this example, a segment 113 of the adhesive tape-agent platform 112 is dispensed from a roll 116 and affixed to the package 110. The adhesive tape-agent platform 112 includes an adhesive side 118 and a non-adhesive surface 120. The adhesive tape-agent platform 112 may be dispensed from the roll 116 in the same way as any conventional packing tape, shipping tape, or duct tape. For example, the adhesive tape-agent platform 112 may be dispensed from the roll 116 by hand, laid across the seam where the two top flaps of the package 110 meet, and cut to a suitable length either by hand or using a cutting instrument (e.g., scissors or an automated or manual tape dispenser). Examples of such tape agents include tape agents having non-adhesive surface 120 that carry one or more coatings or layers (e.g., colored, light reflective, light absorbing, and/or light emitting coatings or layers). Further, the segment 113 may include an identifier 122 (e.g., a QR code, RFID chip, etc.) that may be used to associate the segment 113 with the package 110, as discussed below.

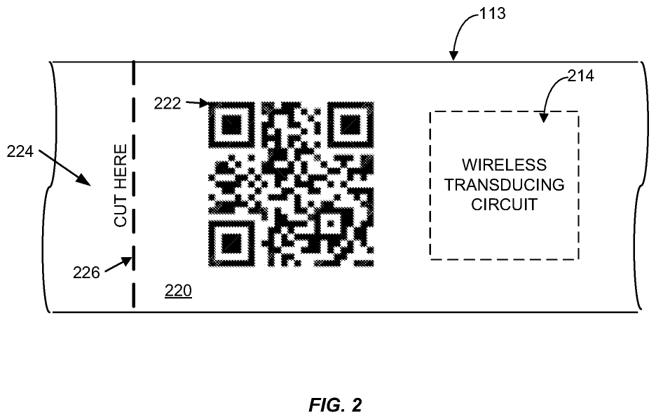

FIG. 2 is a schematic showing the non-adhesive surface 120 of the segment 113 of the adhesive tape agent platform 112 of FIG. 1 including writing or other markings that convey instructions, warnings, or other information to a person or machine (e.g., a bar code reader), or may simply be decorative and/or entertaining. For example, different types of adhesive tape-agent platforms may be marked with distinctive colorations to distinguish one type of adhesive tape agent platform from another. In the illustrated example of FIG. 2, the segment 113 of the adhesive tape agent platform 112 includes an identifier 122 (e.g., a two-dimensional bar code, such as a QR Code), written instructions 224 (e.g., “Cut Here”), and an associated cut line 226 that indicates where the user should cut the adhesive tape agent platform 112. The written instructions 224 and the cut line 226 typically are printed or otherwise marked on the top non-adhesive surface 120 of the adhesive tape agent platform 112 during manufacture. The identifier 122 (e.g., a two-dimensional bar code), on the other hand, may be marked on the non-adhesive surface 120 of the adhesive tape agent platform 112 during the manufacture of the adhesive tape agent platform 112 or, alternatively, may be marked on the non-adhesive surface 120 of the adhesive tape agent platform 112 as needed using, for example, a printer or other marking device.

To avoid damaging the functionality of the segments of the adhesive tape agent platform 112, the cut lines 226 may demarcate the boundaries between adjacent segments at locations that are free of any active components of the wireless transducing circuit 114. The spacing between the wireless transducing circuit 114 and the cut lines 226 may vary depending on the intended communication, transducing and/or adhesive taping application. In the example illustrated in FIG. 1, the length of the adhesive tape-agent platform 112 that is dispensed to seal the package 110 corresponds to a single segment of the adhesive tape-agent platform 112. In other examples, the length of the adhesive tape-agent platform 112 needed to seal a package or otherwise serve the adhesive function for which the adhesive tape-agent platform 112 is being applied may include multiple segments 113 of the adhesive tape-agent platform 112, one or more of which segments 113 may be activated upon cutting the length of the adhesive tape-agent platform 112 from the roll 116 and/or applying the segment 113 of the adhesive tape agent platform to the package 110.

In some examples, the wireless transducing circuits 114 embedded in one or more segments 113 of the adhesive tape-agent platform 112 are activated when the adhesive tape agent platform 112 is cut along the cut line 226. In these examples, the adhesive tape-agent platform 112 includes one or more embedded energy sources (e.g., thin film batteries, which may be printed, or conventional cell batteries, such as conventional watch style batteries, rechargeable batteries, or other energy storage device, such as a super capacitor or charge pump) that supply power to the wireless transducing circuit 114 in one or more segments of the adhesive tape-agent platform 112 in response to being separated from the adhesive tape-agent platform 112 (e.g., along the cut line 226).

In some examples, each segment 113 of the adhesive tape agent platform 112 includes its own respective energy source. In some embodiments, the energy source is a battery of a type described above, an energy harvesting component or system that harvests energy from the environment, or both. In some of these examples, each energy source is configured to only supply power to the components in its respective adhesive tape platform segment regardless of the number of contiguous segments that are in a given length of the adhesive tape-agent platform 112. In other examples, when a given length of the adhesive tape agent platform 112 includes multiple segments 113, the energy sources in the respective segments 113 are configured to supply power to the wireless transducing circuit 114 in all of the segments 113 in the given length of the adhesive tape agent platform 112. In some of these examples, the energy sources are connected in parallel and concurrently activated to power the wireless transducing circuit 114 in all of the segments 113 at the same time. In other examples, the energy sources are connected in parallel and alternately activated to power the wireless transducing circuit 114 in respective ones of the segments 113 at different time periods, which may or may not overlap.

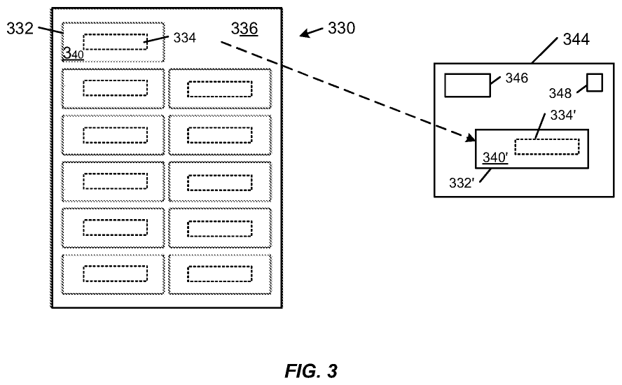

FIG. 3 is a schematic showing one example adhesive tape platform 330 that includes a set of adhesive tape platform segments 332 each of which includes a respective set of embedded wireless transducing circuit components 334, and a backing sheet 336 with a release coating that prevents the adhesive segments 332 from adhering strongly to the backing sheet 336. Adhesive tape platform 330 may represent adhesive tape platform 112 if FIG. 1. Each adhesive tape platform segment 332 includes an adhesive side facing the backing sheet 336, and an opposing non-adhesive side 340. In this example, a particular segment 332 of the adhesive tape platform 330 has been removed from the backing sheet 336 and affixed to an envelope 344. Each segment 332 of the adhesive tape platform 330 can be removed from the backing sheet 336 in the same way that adhesive labels can be removed from a conventional sheet of adhesive labels (e.g., by manually peeling a segment 332 from the backing sheet 336). In general, the non-adhesive side 340 of the segment 332 may include any type of writing, markings, decorative designs, or other ornamentation. In the illustrated example, the non-adhesive side 340 of the segment 332 includes writing or other markings that correspond to a destination address for the envelope 344. The envelope 44 also includes a return address 346 and, optionally, a postage stamp or mark 348.

In some examples, segments of the adhesive tape platform 330 are deployed by a human operator. The human operator may be equipped with a mobile phone or other device that allows the operator to authenticate and initialize the adhesive tape platform 330. In addition, the operator can take a picture of a parcel including the adhesive tape platform and any barcodes associated with the parcel and, thereby, create a persistent record that links the adhesive tape platform 330 to the parcel. In addition, the human operator typically will send the picture to a network service and/or transmit the picture to the adhesive tape platform 330 for storage in a memory component of the adhesive tape platform 330.

In some examples, the wireless transducing circuit components 334 that are embedded in a segment 332 of the adhesive tape platform 330 are activated when the segment 332 is removed from the backing sheet 336. In some of these examples, each segment 332 includes an embedded capacitive sensing system that can sense a change in capacitance when the segment 332 is removed from the backing sheet 336. As explained in detail below, a segment 332 of the adhesive tape platform 330 includes one or more embedded energy sources (e.g., thin film batteries, common disk-shaped cell batteries, or rechargeable batteries or other energy storage devices, such as a super capacitor or charge pump) that can be configured to supply power to the wireless transducing circuit components 334 in the segment 332 in response to the detection of a change in capacitance between the segment 332 and the backing sheet 336 as a result of removing the segment 332 from the backing sheet 336.

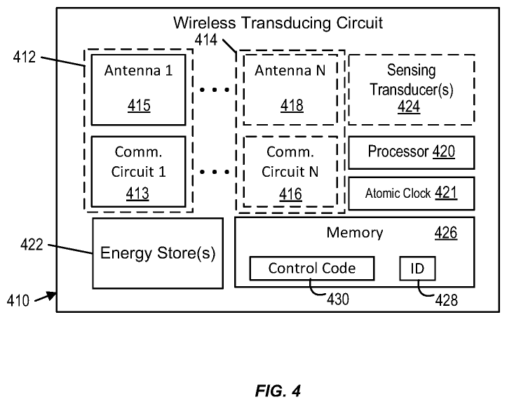

FIG. 4 is a block diagram illustrating components of an example wireless transducing circuit 410 (e.g., an agent) that includes one or more wireless communication modules 412, 414. Each wireless communication module 412, 414 includes a wireless communication circuit 413, 416, and an antenna 415, 418, respectively. Each wireless communication circuit 413, 416 may represent a receiver or transceiver integrated circuit that implements one or more of GSM/GPRS, Wi-Fi, LoRa, Bluetooth, Bluetooth Low Energy, Z-wave, and ZigBee. The wireless transducing circuit 410 also includes a processor 420 (e.g., a microcontroller or microprocessor), a solid-state atomic clock 421, at least one energy store 422 (e.g., non-rechargeable or rechargeable printed flexible battery, conventional single or multiple cell battery, and/or a super capacitor or charge pump), one or more sensing transducers 424 (e.g., sensors and/or actuators, and, optionally, one or more energy harvesting transducers). In some examples, the conventional single or multiple cell battery may be a watch style disk or button cell battery that is in an associated electrical connection apparatus (e.g., a metal clip) that electrically connects the electrodes of the battery to contact pads on the wireless transducing circuit 410.

Sensing transducers 424 may represent one or more of a capacitive sensor, an altimeter, a gyroscope, an accelerometer, a temperature sensor, a strain sensor, a pressure sensor, a piezoelectric sensor, a weight sensor, an optical or light sensor (e.g., a photodiode or a camera), an acoustic or sound sensor (e.g., a microphone), a smoke detector, a radioactivity sensor, a chemical sensor (e.g., an explosives detector), a biosensor (e.g., a blood glucose biosensor, odor detectors, antibody based pathogen, food, and water contaminant and toxin detectors, DNA detectors, microbial detectors, pregnancy detectors, and ozone detectors), a magnetic sensor, an electromagnetic field sensor, a humidity sensor, a light emitting units (e.g., light emitting diodes and displays), electro-acoustic transducers (e.g., audio speakers), electric motors, and thermal radiators (e.g., an electrical resistor or a thermoelectric cooler).

Wireless transducing circuit 410 includes a memory 426 for storing data, such as profile data, state data, event data, sensor data, localization data, security data, and/or at least one unique identifier (ID) 428 associated with the wireless transducing circuit 410, such as one or more of a product ID, a type ID, and a media access control (MAC) ID. Memory 426 may also store control code 430 that includes machine-readable instructions that, when executed by the processor 420, cause processor 420 to perform one or more autonomous agent tasks. In certain embodiments, the memory 426 is incorporated into one or more of the processor 420 or sensing transducers 424. In other embodiments, memory 426 is integrated in the wireless transducing circuit 410 as shown in FIG. 4. The control code 430 may implement programmatic functions or program modules that control operation of the wireless transducing circuit 410, including implementation of an agent communication manager that manages the manner and timing of tape agent communications, a node-power manager that manages power consumption, and a tape agent connection manager that controls whether connections with other nodes are secure connections (e.g., connections secured by public key cryptography) or unsecure connections, and an agent storage manager that securely manages the local data storage on the wireless transducing circuit 410. In certain embodiments, a node connection manager ensures the level of security required by the end application and supports various encryption mechanisms. In some examples, a tape agent power manager and communication manager work together to optimize the battery consumption for data communication. In some examples, execution of the control code by the different types of nodes described herein may result in the performance of similar or different functions.

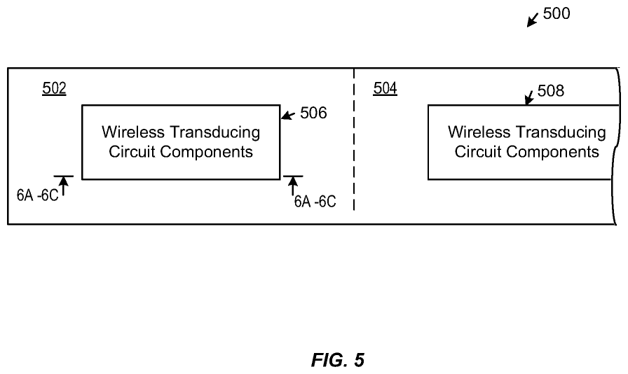

FIG. 5 is a top view of a portion of an example flexible adhesive tape platform 500 that shows a first segment 502 and a portion of a second segment 504. Each segment 502, 504 of the flexible adhesive tape platform 500 includes a respective set 506, 508 of the components of the wireless transducing circuit 410 of FIG. 4. The segments 502, 504 and their respective sets of components 506, 508 typically are identical and configured in the same way. In some other embodiments, however, the segments 502, 504 and/or their respective sets of components 506, 508 are different and/or configured in different ways. For example, in some examples, different sets of the segments of the flexible adhesive tape platform 500 have different sets or configurations of tracking and/or transducing components that are designed and/or optimized for different applications, or different sets of segments of the flexible adhesive tape platform may have different ornamentations (e.g., markings on the exterior surface of the platform) and/or different (e.g., alternating) lengths.

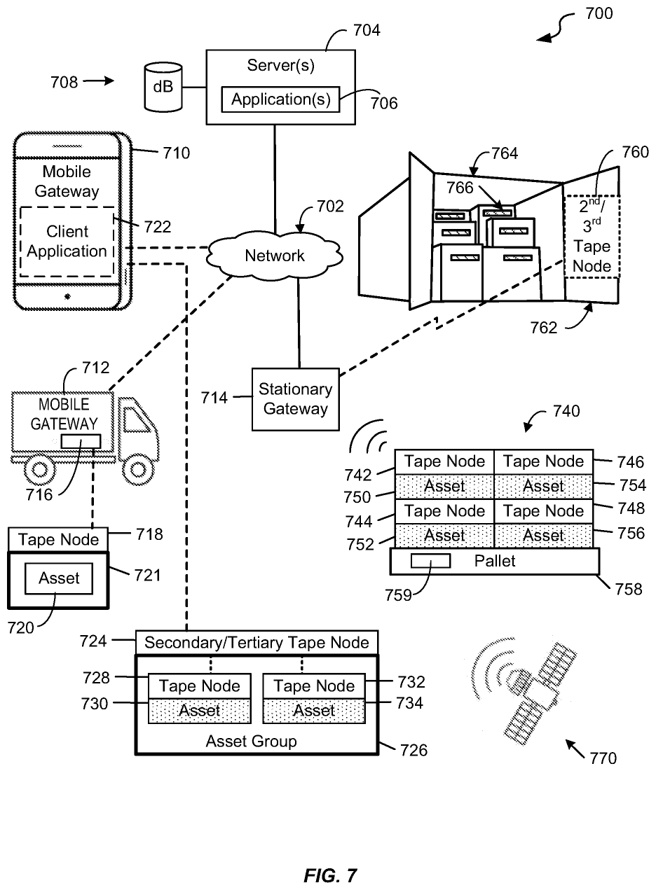

An example method of fabricating the adhesive tape platform 500 according to a roll-to-roll fabrication process is described in connection with FIGS. 6A-6C and as shown in FIGS. 7A and 7C of U.S. patent application Ser. No. 15/842,861, filed Dec. 14, 2517, the entirety of which is incorporated herein by reference.

The instant specification describes an example system of adhesive tape platforms (also referred to herein as “tape nodes”) that can be used to implement a low-cost wireless network infrastructure for performing monitoring, tracking, and other asset management functions relating to, for example, parcels, persons, tools, equipment and other physical assets and objects. The example system includes a set of three different types of tape nodes that have different respective functionalities and different respective cover markings that visually distinguish the different tape node types from one another. In one non-limiting example, the covers of the different tape node types are marked with different colors (e.g., white, green, and black). In the illustrated examples, the different tape node types are distinguishable from one another by their respective wireless communications capabilities and their respective sensing capabilities.

FIG. 6A shows a cross-sectional side view of a portion of an example segment 640 of a flexible adhesive tape agent platform (e.g., platform 500 of FIG. 5) that includes a respective set of the components of the wireless transducing circuit 410 corresponding to the first tape-agent type (e.g., white). The segment 640 includes an adhesive layer 642, an optional flexible substrate 644, and an optional adhesive layer 646 on the bottom surface of the flexible substrate 644. When the bottom adhesive layer 646 is present, a release liner (not shown) may be (weakly) adhered to the bottom surface of the adhesive layer 646. In certain embodiments where adhesive layer 646 is included, the adhesive layer 646 is an adhesive (e.g., an acrylic foam adhesive) with a high-bond strength that is sufficient to prevent removal of the segment 640 from a surface on which the adhesive layer 646 is adhered to without destroying the physical or mechanical integrity of the segment 640 and/or one or more of its constituent components.

In certain embodiments including the optional flexible substrate 644, the optional flexible substrate 644 is a prefabricated adhesive tape that includes the adhesive layers 642 and 646 and the optional release liner. In other embodiments including the optional flexible substrate 644, the adhesive layers 642, 646 are applied to the top and bottom surfaces of the flexible substrate 644 during the fabrication of the adhesive tape platform. The adhesive layer 642 may bond the flexible substrate 644 to a bottom surface of a flexible circuit 648, that includes one or more wiring layers (not shown) that connect the processor 650, a low-power wireless-communication interface 652 (e.g., a Zigbee, Bluetooth® Low Energy (BLE) interface, or other low power communication interface), a clock and/or a timer circuit 654, transducing and/or transducer(s) 656 (if present), the memory 658, and other components in a device layer 660 to each other and to the energy storage device 662 and, thereby, enable the transducing, tracking and other functionalities of the segment 640. The low-power wireless-communication interface 652 typically includes one or more of the antennas 415, 418 and one or more of the wireless communication circuits 413, 416 of FIG. 4. The segment 640 may further include a flexible cover 690, an interfacial region 692, and a flexible polymer layer 694.

FIG. 6B shows a cross-sectional side-view of a portion of an example segment 670 of a flexible adhesive tape agent platform (e.g., platform 500 of FIG. 5) that includes a respective set of the components of the wireless transducing circuit 410 corresponding to a second tape-agent type (e.g., green). The segment 670 is similar to the segment 640 shown in FIG. 6A but further includes a medium-power communication-interface 672′ (e.g., a LoRa interface) in addition to the low-power communications-interface 652. The medium-power communication-interface 672′ has a longer communication range than the low-power communication-interface 652′. In certain embodiments, one or more other components of the segment 670 differ from the segment 640 in functionality or capacity (e.g., larger energy source). The segment 670 may include further components, as discussed above and below with reference to FIGS. 6A, and 6C.

FIG. 6C shows a cross-sectional side view of a portion of an example segment 680 of the flexible adhesive tape-agent platform that includes a respective set of the components of the wireless transducing circuit 410 corresponding to the third tape-node type (e.g., black). The segment 680 is similar to the segment 670 of FIG. 6B, but further includes a high-power communications-interface 682″ (e.g., a cellular interface; e.g., GSM/GPRS) in addition to a low-power communications-interface 652″ and may include a medium-power communications-interface 672″. The high-power communications-interface 682″ has a range that provides global coverage to available infrastructure (e.g., the cellular network). In certain embodiments, one or more other components of the segment 680 differ from the segment 670 in functionality or capacity (e.g., larger energy source).

FIGS. 6A-6C show embodiments in which the flexible covers 690, 690′, 690″ of the respective segments 640, 670, and 680 include one or more interfacial regions 692, 692′, 692″ positioned over one or more of the transducers 656, 656′, 656″. In certain embodiments, one or more of the interfacial regions 692, 692′, 692″ have features, properties, compositions, dimensions, and/or characteristics that are designed to improve the operating performance of the platform for specific applications. In certain embodiments, the flexible adhesive tape platform includes multiple interfacial regions 692, 692′, 692″ over respective transducers 656, 656′, 656″, which may be the same or different depending on the target applications. Interfacial regions may represent one or more of an opening, an optically transparent window, and/or a membrane located in the interfacial regions 692, 692′, 692″ of the flexible covers 690, 690′, 690″ that is positioned over the one or more transducers and/or transducers 656, 656′, 656″. Additional details regarding the structure and operation of example interfacial regions 692, 692′, 692″ are described in U.S. Provisional Patent Application No. 62/680,716, filed Jun. 5, 2518, and U.S. Provisional Patent Application No. 62/670,712, filed May 11, 2518.

In certain embodiments, a planarizing polymer 694, 694′, 694″ encapsulates the respective device layers 660, 660′, 660″ and thereby reduces the risk of damage that may result from the intrusion of contaminants and/or liquids (e.g., water) into the device layer 660, 660′, 660″. The flexible polymer layers 694, 694′, 694″ may also planarize the device layers 660, 660′, 660″. This facilitates optional stacking of additional layers on the device layers 660, 660′, 660″ and also distributes forces generated in, on, or across the segments 640, 670, 680 so as to reduce potentially damaging asymmetric stresses that might be caused by the application of bending, torquing, pressing, or other forces that may be applied to the segments 640, 670, 680 during use. In the illustrated example, a flexible cover 690, 690′, 690″ is bonded to the planarizing polymer 694, 694′, 694″ by an adhesive layer (not shown).

The flexible cover 690, 690′, 690″ and the flexible substrate 644, 644′, 644″ may have the same or different compositions depending on the intended application. In some examples, one or both of the flexible cover 690, 690′, 690″ and the flexible substrate 644, 644′, 644″ include flexible film layers and/or paper substrates, where the film layers may have reflective surfaces or reflective surface coatings. Compositions for the flexible film layers may represent one or more of polymer films, such as polyester, polyimide, polyethylene terephthalate (PET), and other plastics. The optional adhesive layer on the bottom surface of the flexible cover 690, 690′, 690″ and the adhesive layers 642, 642′, 642″, 646, 646′, 646″ on the top and bottom surfaces of the flexible substrate 644, 644′, 644″ typically include a pressure-sensitive adhesive (e.g., a silicon-based adhesive). In some examples, the adhesive layers are applied to the flexible cover 690, 690′, 690″ and the flexible substrate 644, 644′, 644″ during manufacture of the adhesive tape-agent platform (e.g., during a roll-to-roll or sheet-to-sheet fabrication process). In other examples, the flexible cover 690, 690′, 690″ may be implemented by a prefabricated single-sided pressure-sensitive adhesive tape and the flexible substrate 644, 644′, 644″ may be implemented by a prefabricated double-sided pressure-sensitive adhesive tape; both kinds of tape may be readily incorporated into a roll-to-roll or sheet-to-sheet fabrication process. In some examples, the flexible substrate 644, 644′, 644″ is composed of a flexible epoxy (e.g., silicone).

In certain embodiments, the energy storage device 662, 662′, 662″ is a flexible battery that includes a printed electrochemical cell, which includes a planar arrangement of an anode and a cathode and battery contact pads. In some examples, the flexible battery may include lithium-ion cells or nickel-cadmium electro-chemical cells. The flexible battery typically is formed by a process that includes printing or laminating the electro-chemical cells on a flexible substrate (e.g., a polymer film layer). In some examples, other components may be integrated on the same substrate as the flexible battery. For example, the low-power wireless-communication interface 652, 652′, 652″ and/or the processor(s) 650, 650′, 650″ may be integrated on the flexible battery substrate. In some examples, one or more of such components also (e.g., the flexible antennas and the flexible interconnect circuits) may be printed on the flexible battery substrate.

In examples of manufacture, the flexible circuit 648, 648′, 648″ is formed on a flexible substrate by one or more of printing, etching, or laminating circuit patterns on the flexible substrate. In certain embodiments, the flexible circuit 648, 648′, 648″ is implemented by one or more of a single-sided flex circuit, a double access or back-bared flex circuit, a sculpted flex circuit, a double-sided flex circuit, a multi-layer flex circuit, a rigid flex circuit, and a polymer-thick film flex circuit. A single-sided flexible circuit has a single conductor layer made of, for example, a metal or conductive (e.g., metal filled) polymer on a flexible dielectric film. A double access or back bared flexible circuit has a single conductor layer but is processed so as to allow access to selected features of the conductor pattern from both sides. A sculpted flex circuit is formed using a multi-step etching process that produces a flex circuit that has finished copper conductors that vary in thickness along their respective lengths. A multilayer flex circuit has three of more layers of conductors, where the layers typically are interconnected using plated through holes. Rigid flex circuits are a hybrid construction of flex circuit consisting of rigid and flexible substrates that are laminated together into a single structure, where the layers typically are electrically interconnected via plated through holes. In polymer thick film (PTF) flex circuits, the circuit conductors are printed onto a polymer base film, where there may be a single conductor layer or multiple conductor layers that are insulated from one another by respective printed insulating layers.

In the example segments 640, 670, 680 shown in FIGS. 6A-6C, the flexible circuit 648, 648′, 648″ represents a single-access flex-circuit that interconnects the components of the adhesive tape platform on a single side of the flexible circuit 648, 648′, 648″. However, in other embodiments, the flexible circuit 648, 648′, 648″ represents a double access flex circuit that includes a front-side conductive pattern that interconnects the low-power communications interface 652, 652′, 652″, the timer circuit 654, 654′, 654″, the processor 650, 650′, 650″, the one or more sensor transducers 656, 656′, 656″ (if present), and the memory 658, 658′, 658″, and allows through-hole access (not shown) to a back-side conductive pattern that is connected to the flexible battery (not shown). In these embodiments, the front-side conductive pattern of the flexible circuit 648, 648′, 648″ connects the communications circuits 652, 652′, 652″, 672′, 672″, 682″ (e.g., receivers, transmitters, and transceivers) to their respective antennas and to the processor 650, 650′, 650″ and also connects the processor 650, 650′, 650″ to the one or more sensors and the memory 658, 658′, and 658″. The backside conductive pattern connects the active electronics (e.g., the processor 650, 650′, 650″, the communications circuits 652, 652′, 652″, 672′, 672″, 682″ and the transducers) on the front-side of the flexible circuit 648, 648′, 648″ to the electrodes of the energy storage device 662, 662′, 662″ via one or more through holes in the substrate of the flexible circuit 648, 648′, 648″.

The various units of the segments 640, 670, 680 shown in FIGS. 6A-6C may be arranged to accommodate different objects or structures (e.g., trash bins, fire extinguishers, etc.) and sensors may be added to, or subtracted from, the segments 640, 670, and 680, according to a particular task.

FIG. 7 shows an example network communications environment 700 that includes a network 702 that supports communications between one or more servers 704 executing one or more applications of a network service 708, mobile gateways 710 (a smart device mobile gateway), 712 (a vehicle mobile gateway), a stationary gateway 714, and various types of tape nodes that are associated with various assets (e.g., parcels, equipment, tools, persons, and other things). Network communications environment 700 may also be called a wireless tracking system 700. Hereinafter “tape nodes” may be used interchangeably with the “agents”, as described above, with reference to FIGS. 1-6C; the “agents” are in the form of a “tape node” attached to different objects, e.g., an asset, storage container, vehicle, equipment, etc.; the master agent may be referred to as a master tape node, a secondary agent may be referred to as a secondary tape node; and a tertiary agent may be referred to as a tertiary tape node.

In some examples, the network 702 (e.g., a wireless network) includes one or more network communication systems and technologies, including any one or more of wide area networks, local area networks, public networks (e.g., the internet), private networks (e.g., intranets and extranets), wired networks, and wireless networks. For example, the network 702 includes communications infrastructure equipment, such as a geolocation satellite system 770 (e.g., GPS, GLONASS, and NAVSTAR), cellular communication systems (e.g., GSM/GPRS), Wi-Fi communication systems, RF communication systems (e.g., LoRa), Bluetooth communication systems (e.g., a Bluetooth Low Energy system), Z-wave communication systems, and ZigBee communication systems.

In some examples, the one or more network service applications leverage the above-mentioned communications technologies to create a hierarchical wireless network of tape nodes improves asset management operations by reducing costs and improving efficiency in a wide range of processes, from asset packaging, asset transporting, asset tracking, asset condition monitoring, asset inventorying, and asset security verification. Communication across the network is secured by a variety of different security mechanisms. In the case of existing infrastructure, a communication link uses the infrastructure security mechanisms. In the case of communications among tapes nodes, the communication is secured through a custom security mechanism. In certain cases, tape nodes may also be configured to support block chain to protect the transmitted and stored data.

A network of tape nodes may be configured by the network service to create hierarchical communications network. The hierarchy may be defined in terms of one or more factors, including functionality (e.g., wireless transmission range or power), agent “identity” or “role” (e.g., master-tape node vs. peripheral-tape node), or cost (e.g., a tape node equipped with a cellular transceiver vs. a peripheral tape node equipped with a Bluetooth LE transceiver). As described above with reference to the agents, tape nodes may be assigned to different levels of a hierarchical network according to one or more of the above-mentioned factors. For example, the hierarchy may be defined in terms of communication range or power, where tape nodes with higher-power or longer-communication range transceivers are arranged at a higher level of the hierarchy than tape nodes with lower-power or lower-range power or lower range transceivers. In another example, the hierarchy is defined in terms of role, where, e.g., a master tape node is programmed to bridge communications between a designated group of peripheral tape nodes and a gateway node or server node. The problem of finding an optimal hierarchical structure may be formulated as an optimization problem with battery capacity of nodes, power consumption in various modes of operation, desired latency, external environment, etc. and may be solved using modern optimization methods e.g. neural networks, artificial intelligence, and other machine learning computing systems that take expected and historical data to create an optimal solution and may create algorithms for modifying the system's behavior adaptively in the field.

The tape nodes may be deployed by automated equipment or manually. In this process, a tape node typically is separated from a roll or sheet and adhered to a parcel (e.g., asset 720) or other stationary (e.g., stationary gateway 714) or mobile object (e.g., a, such as a delivery truck, such as mobile gateway 712) or stationary object (e.g., a structural element of a building). This process activates the tape node (e.g., the tape node 718) and causes the tape node 718 to communicate with the one or more servers 704 of the network service 708. In this process, the tape node 718 may communicate through one or more other tape nodes (e.g., the tape nodes 742, 744, 746, 748) in the communication hierarchy. In this process, the one or more servers 704 executes the network service application 706 to programmatically configure tape nodes 718, 724, 728, 732, 742, 744, 746, 748, that are deployed in the network communications environment 700. In some examples, there are multiple classes or types of tape nodes (e.g., the master agent, secondary agent, or tertiary agent discussed herein), where each tape node class has a different respective set of functionalities and/or capacities, as described herein with respect to the “agents.”

In some examples, the one or more servers 704 communicate over the network 702 with one or more gateways 710, 712, 714 that are configured to send, transmit, forward, or relay messages to the network 702 in response to transmissions from the tape nodes 718, 724, 728, 732, 742, 744, 746, 748 that are associated with respective assets and within communication range. Example gateways include mobile gateways 710, 712 and a stationary gateway 714. In some examples, the mobile gateways 710, 712, and the stationary gateway 714 are able to communicate with the network 702 and with designated sets or groups of tape nodes.

In some examples, the mobile gateway 712 is a vehicle (e.g., a delivery truck or other mobile hub) that includes a wireless communications unit 716 that is configured by the network service 708 to communicate with a designated network of tape nodes, including tape node 718 (e.g., a master tape node) in the form of a label that is adhered to a parcel 721 (e.g., an envelope) that contains an asset 720, and is further configured to communicate with the network service 708 over the network 702. In some examples, the tape node 718 includes a lower-power wireless-communications interface of the type used in, e.g., segment 640 (shown in FIG. 6A), and the wireless communications unit 716 may implemented by a secondary or tertiary tape node (e.g., one of segment 670 or segment 680, respectively shown in FIGS. 6B and 6C) that includes a lower-power communications interfaces for communicating with tape nodes within range of the mobile gateway 712 and a higher-power communications-interface for communicating with the network 702. In this way, the tape node 718 and wireless communications unit 716 create a hierarchical wireless network of tape nodes for transmitting, forwarding, bridging, relaying, or otherwise communicating wireless messages to, between, or on behalf of the tape node 718 in a power-efficient and cost-effective way.

In some examples, a mobile gateway 710 is a mobile phone that is operated by a human operator and executes a client application 722 that is configured by a network service to communicate with a designated set of tape nodes, including a secondary or tertiary tape node 724 that is adhered to a parcel 726 (e.g., a box), and is further configured to communicate with a server 704 over the network 702. In the illustrated example, the parcel 726 contains a first parcel labeled or sealed by a master tape node 728 and containing a first asset 730, and a second parcel labeled or sealed by a master tape node 732 and containing a second asset 734. The secondary or tertiary tape node 724 communicates with each of the master tape nodes 728, 732 and also communicates with the mobile gateway 710. In some examples, each of the master tape nodes 728, 732 includes a lower-power wireless-communications interface of the type used in, e.g., segment 640 (shown in FIG. 6A), and the secondary/tertiary tape node 724 is implemented by a tape node (e.g., segment 670 or segment 680, shown in FIGS. 6B and 6C) that includes a low-power communications interface for communicating with the master tape nodes 728, 732 contained within the parcel 726, and a higher-power communications interface for communicating with the mobile gateway 710. The secondary or tertiary tape node 724 is operable to relay wireless communications between the master tape nodes 728, 732 contained within the parcel 726 and the mobile gateway 710, and the mobile gateway 710 is operable to relay wireless communications between the secondary or tertiary tape node 724 and the server 704 over the network 702. In this way, the master tape nodes 728 and 732 and the secondary or tertiary tape node 724 create a wireless network of nodes for transmitting, forwarding, relaying, or otherwise communicating wireless messages to, between, or on behalf of the master tape nodes 728, 732, the secondary or tertiary tape node 724, and the network service (not shown) in a power-efficient and cost-effective way.

In some embodiments, the client application 722 is installed on a mobile device (e.g., smartphone) that may also operate as mobile gateway 710. The client application 722 may cause the mobile device to function as a mobile gateway 710. For example, the client application 722 runs in the background to allow the mobile device to bridge communications between tape nodes that are communicating on one protocol to other tape nodes that are communicating on another protocol. For example, a tape node transmits data to the mobile device through Bluetooth, and the mobile device (running the client application 722) relays that data to the server 704 via cellular (2G, 3G, 4G, 5G) or Wi-Fi. Further, the client application 722 may cause the mobile device to establish a connection with, and receive pings (e.g., alerts to nearby assets that an environmental profile threshold has been exceeded), from the tape nodes or from the server 704. The tape nodes or server may request services (e.g., to display alert messages within a graphical user interface of the mobile device, relay messages to nearby tape nodes or mobile or stationary gateways, delegate tasks to the mobile device, such as determining the location of the tape node, etc.) from the mobile device. For example, the mobile device running the client application 722 may share location data with the tape node, allowing the tape node to pinpoint its location.

In some examples, the stationary gateway 714 is implemented by a server 704 executing a network service application 706 that is configured by the network service 708 to communicate with a designated set 740 of master tape nodes 742, 744, 746, 748 that are adhered to respective parcels containing respective assets 750, 752, 754, 756 on a pallet 758. In other examples, the stationary gateway 714 is implemented by a secondary or tertiary tape node 760 (e.g., segments 670 or 680, respectively shown in FIGS. 6B and 6C) that is adhered to, for example, a wall, column or other infrastructure component of the physical premise's environment 700, and includes a low-power communications interface for communicating with nodes within range of the stationary gateway 714 and a higher-power communications interface for communicating with the network 702.

In one embodiment, each of the master tape nodes 742-748 is a master tape node and is configured by the network service 708 to communicate individually with the stationary gateway 714, which relays communications from the master tape nodes 742-748 to the network service 708 through the stationary gateway 714 and over the network 702. In another embodiment, one of the master tape nodes 742-748 at a time is configured to transmit, forward, relay, or otherwise communicate wireless messages to, between, or on behalf of the other master nodes on the pallet 758. In this embodiment, the master tape node may be determined by the master tape nodes 742-748 or designated by the network service 708. In some examples, the master tape nodes 742-748 with the longest range or highest remaining power level is determined to be the master tape node. In some examples, when the power level of the current master tape node drops below a certain level (e.g., a fixed power threshold level or a threshold level relative to the power levels of one or more of the other master tape nodes), another one of the master tape nodes assumes the role of the master tape node. In some examples, a master tape node 759 is adhered to the pallet 758 and is configured to perform the role of a master node for the other master tape nodes 742-748. In these ways, the master tape nodes 742-748, 759 are configurable to create different wireless networks of nodes for transmitting, forwarding, relaying, bridging, or otherwise communicating wireless messages with the network service 408 through the stationary gateway 714 and over the network 702 in a power-efficient and cost-effective way.

In the illustrated example, the stationary gateway 714 also is configured by the network service 708 to communicate with a designated network of tape nodes, including the secondary or tertiary tape node 760 that is adhered to the inside of a door 762 of a shipping container 764, and is further configured to communicate with the network service 708 over the network 702. In the illustrated example, the shipping container 764 contains a number of parcels labeled or sealed by respective master tape nodes 766 and containing respective assets. The secondary or tertiary tape node 760 communicates with each of the master tape nodes 766 within the shipping container 764 and communicates with the stationary gateway 714. In some examples, each of the master tape nodes 766 includes a low-power wireless communications-interface (e.g., the low-power wireless-communication interface 652, with reference to FIG. 6A), and the secondary or tertiary tape node 760 includes a low-power wireless-communications interface (low-power wireless-communication interfaces 652′, 652″, with reference to FIGS. 6B-6C) for communicating with the master tape nodes 766 contained within the shipping container 764, and a higher-power wireless-communications interface (e.g., medium-power wireless-communication interface 672′, medium-power wireless-communication interface 672″, high-power wireless-communication interface 682″, with reference to FIGS. 6B-6C) for communicating with the stationary gateway 714. In some examples, either a secondary or tertiary tape node, or both, may be used, depending on whether a high-power wireless-communication interface is necessary for sufficient communication.

In some examples, when the doors of the shipping container 764 are closed, the secondary or tertiary tape node 760 is operable to communicate wirelessly with the master tape nodes 766 contained within the shipping container 764. In some embodiments, both a secondary and a tertiary node are attached to the shipping container 764. Whether a secondary and a tertiary node are used may depend on the range requirements of the wireless-communications interface. For example, if out at sea a node will be required to transmit and receive signals from a server located outside the range of a medium-power wireless-communications interface, a tertiary node will be used because the tertiary node includes a high-power wireless-communications interface.

In an example, the secondary or tertiary tape node 760 is configured to collect sensor data from master tape nodes 766 and, in some embodiments, process the collected data to generate, for example, statistics from the collected data. When the doors of the shipping container 764 are open, the secondary or tertiary tape node 760 is programmed to detect the door opening (e.g., using a photodetector or an accelerometer component of the secondary or tertiary tape node 760) and, in addition to reporting the door opening event to the network service 708, the secondary or tertiary tape node 760 is further programmed to transmit the collected data and/or the processed data in one or more wireless messages to the stationary gateway 714. The stationary gateway 714, in turn, is operable to transmit the wireless messages received from the secondary or tertiary tape node 760 to the network service 708 over the network 702. Alternatively, in some examples, the stationary gateway 714 also is operable to perform operations on the data received from the secondary or tertiary tape node 760 with the same type of data produced by the secondary or tertiary tape node 760 based on sensor data collected from the master tape nodes 742-748. In this way, the secondary or tertiary tape node 760 and master tape node 766 create a wireless network of nodes for transmitting, forwarding, relaying, or otherwise communicating wireless messages to, between, or on behalf of the master tape node 766, the secondary or tertiary tape nodes 760, and the network service 708 in a power-efficient and cost-effective way.

In an example of the embodiment shown in FIG. 7, there are three types of backward compatible tape nodes: a short-range master tape node (e.g., segment 640), a medium-range secondary tape node (e.g., segment 670), and a long-range tertiary tape node (e.g. segment 680), as respectively shown in FIGS. 6A-6C (here, “tape node” is used interchangeably with “agent”, as described with reference to FIGS. 1-6C). The short-range master tape nodes typically are adhered directly to parcels containing assets. In the illustrated example, the master tape nodes 718, 728, 732, 742-748, 766 are short-range tape nodes. The short-range tape nodes typically communicate with a low-power wireless-communication protocol (e.g., Bluetooth LE, Zigbee, or Z-wave). The segment 670 are typically adhered to objects (e.g., a parcel 726 and a shipping container 764) that are associated with multiple parcels that are separated from the medium-range tape nodes by a barrier or a long distance. In the illustrated example, the secondary and/or tertiary tape nodes 724 and 760 are medium-range tape nodes. The medium-range tape nodes typically communicate with low and medium-power wireless-communication protocols (e.g., Bluetooth, LoRa, or Wi-Fi). The segments 680 typically are adhered to mobile or stationary infrastructure of the network communications environment 700.

In the illustrated example, the mobile gateway 712 and the stationary gateway 714 are implemented by, e.g., segment 680. The segments 680 typically communicate with other nodes using a high-power wireless-communication protocol (e.g., a cellular data communication protocol). In some examples, the wireless communications unit 716 (a secondary or tertiary tape node) is adhered to a mobile gateway 712 (e.g., a truck). In these examples, the wireless communications unit 716 may be moved to different locations in the network communications environment 700 to assist in connecting other tape nodes to the wireless communications unit 716. In some examples, the stationary gateway 714 is a tape node that may be attached to a stationary structure (e.g., a wall) in the network communications environment 700 with a known geographic location (e.g., GPS coordinates). In these examples, other tape nodes in the environment may determine their geographic location by querying the stationary gateway 714.

In some examples, in order to conserve power, the tape nodes typically communicate according to a schedule promulgated by the network service 708. The schedule usually dictates all aspects of the communication, including the times when particular tape nodes should communicate, the mode of communication, and the contents of the communication. In one example, the server (not shown) transmits programmatic Global Scheduling Description Language (GSDL) code to the master tape node and each of the secondary and tertiary tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the server 704, either directly or indirectly through a gateway tape node (e.g., the long-range tape node, such as wireless communication unit 716, adhered to the mobile gateway 712, or a long-range tape node, such as stationary gateway 714, that is adhered to an infrastructure component of the network communications environment 700). In other examples, the master tape node processes the information contained in the received data packets and transmits the processed information to the server 704.

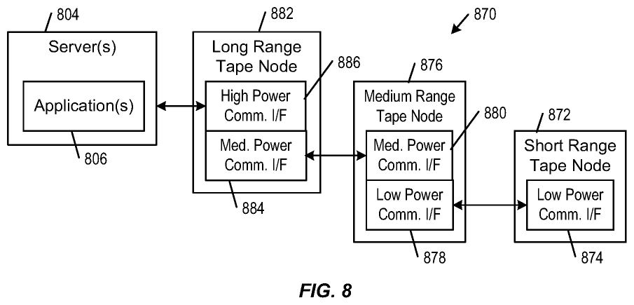

FIG. 8 shows an example hierarchical wireless communications network 870 of tape nodes. In this example, the short-range tape node 872 and the medium range tape node 876 communicate with one another over their respective low power wireless communication interfaces 874, 878. The medium range tape node 876 and the long-range tape node 882 communicate with one another over their respective medium power wireless communication interfaces 880, 884. The long-range tape node 882 and the one or more network service servers 804 (e.g., server(s) 704, FIG. 7) running applications 806 (e.g., application(s) 706, FIG. 7) communicate with one another over the high-power communication interface 884. In some examples, the low power communication interfaces 874, 878 establish wireless communications with one another in accordance with the Bluetooth LE protocol, the medium power communication interfaces 880, 884 establish wireless communications with one another in accordance with the LoRa communications protocol, and the high-power communication interface 886 establishes wireless communications with the one or more network service servers 804 in accordance with a cellular communications protocol.

In some examples, the different types of tape nodes are deployed at different levels in the communications hierarchy according to their respective communications ranges, with the long-range tape nodes generally at the top of the hierarchy, the medium range tape nodes generally in the middle of the hierarchy, and the short-range tape nodes generally at the bottom of the hierarchy. In some examples, the different types of tape nodes are implemented with different feature sets that are associated with component costs and operational costs that vary according to their respective levels in the hierarchy. This allows system administrators flexibility to optimize the deployment of the tape nodes to achieve various objectives, including cost minimization, asset tracking, asset localization, and power conservation.

In some examples, one or more network service servers 804 designates a tape node at a higher level in a hierarchical communications network as a master node of a designated set of tape nodes at a lower level in the hierarchical communications network. For 4example, the designated master tape node may be adhered to a parcel (e.g., a box, pallet, or shipping container) that contains one or more tape nodes that are adhered to one or more packages containing respective assets. In order to conserve power, the tape nodes typically communicate according to a schedule promulgated by the one or more network service servers 804. The schedule usually dictates all aspects of the communication, including the times when particular tape nodes should communicate, the mode of communication, and the contents of the communication. In one example, the one or more network service servers 804 transmits programmatic Global Scheduling Description Language (GSDL) code to the master tape node and each of the lower-level tape nodes in the designated set. In this example, execution of the GSDL code causes each of the tape nodes in the designated set to connect to the master tape node at a different respective time that is specified in the GSDL code, and to communicate a respective set of one or more data packets of one or more specified types of information over the respective connection. In some examples, the master tape node simply forwards the data packets to the one or more network service servers 804, either directly or indirectly through a gateway tape node (e.g., the long-range wireless communication unit 716 adhered to the mobile gateway 712 (which could be a vehicle, ship, plane, etc.) or the stationary gateway 714 is a long-range tape node adhered to an infrastructure component of the environment 700). In other examples, the master tape node processes the information contained in the received data packets and transmits the processed information to the one or more network service servers 804/704.

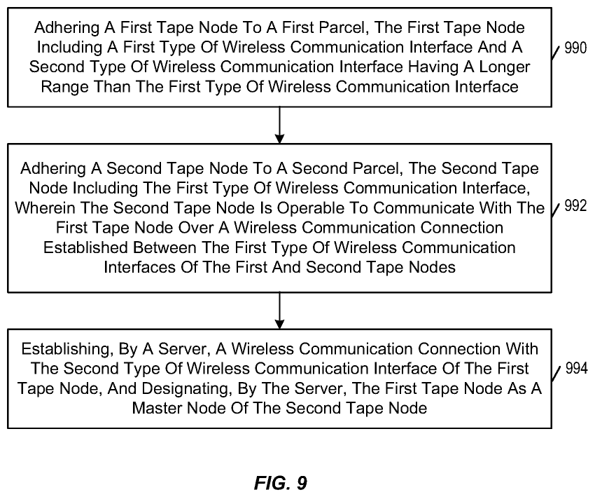

FIG. 9 shows an example method of creating a hierarchical communications network. In accordance with this method, a first tape node is adhered to a first parcel in a set of associated parcels, the first tape node including a first type of wireless communication interface and a second type of wireless communication interface having a longer range than the first type of wireless communication interface (FIG. 9, block 990). A second tape node is adhered to a second parcel in the set, the second tape node including the first type of wireless communication interface, wherein the second tape node is operable to communicate with the first tape node over a wireless communication connection established between the first type of wireless communication interfaces of the first and second tape nodes (FIG. 9, block 992). An application executing on a computer system (e.g., the one or more network service servers 804 of a network service 808) establishes a wireless communication connection with the second type of wireless communication interface of the first tape node, and the application transmits programmatic code executable by the first tape node to function as a master tape node with respect to the second tape node (FIG. 9, block 994).

As used herein, the term “node” refers to both a tape node and a non-tape node unless the node is explicitly designated as a “tape node” or a “non-tape node.” In some embodiments, a non-tape node may have the same or similar communication, sensing, processing and other functionalities and capabilities as the tape nodes described herein, except without being integrated into a tape platform. In some embodiments, non-tape nodes can interact seamlessly with tape nodes. Each node is assigned a respective unique identifier.

Embodiments of the present disclosure further describe a distributed software operating system that is implemented by distributed hardware nodes executing intelligent agent software to perform various tasks or algorithms. In some embodiments, the operating system distributes functionalities (e.g., performing analytics on data or statistics collected or generated by nodes) geographically across multiple intelligent agents that are bound to logistic items (e.g., parcels, containers, packages, boxes, pallets, a loading dock, a door, a light switch, a vehicle such as a delivery truck, a shipping facility, a port, a hub, etc.). In addition, the operating system dynamically allocates the hierarchical roles (e.g., master and slave roles) that nodes perform over time in order to improve system performance, such as optimizing battery life across nodes, improving responsiveness, and achieving overall objectives. In some embodiments, optimization is achieved using a simulation environment for optimizing key performance indicators (PKIs).

In some embodiments, the nodes are programmed to operate individually or collectively as autonomous intelligent agents. In some embodiments, nodes are configured to communicate and coordinate actions and respond to events. In some embodiments, a node is characterized by its identity, its mission, and the services that it can provide to other nodes. A node's identity is defined by its capabilities (e.g., battery life, sensing capabilities, and communications interfaces). A node may be defined by the respective program code, instructions, or directives it receives from another node (e.g., a server or a master node) and the actions or tasks that it performs in accordance with that program code, instructions, or directives (e.g., sense temperature every hour and send temperature data to a master node to upload to a server). A node's services may be defined by the functions or tasks that it is permitted to perform for other nodes (e.g., retrieve temperature data from a peripheral node and send the received temperature data to the server). At least for certain tasks, once programmed and configured with their identities, missions, and services, nodes can communicate with one another and request services from and provide services to one another independently of the server.

Thus, in accordance with the runtime operating system every agent knows its objectives (programmed). Every agent knows which capabilities/resources it needs to fulfill objective. Every agent communicates with every other node in proximity to see if it can offer the capability. Examples include communicate data to the server, authorize going to lower-power level, temperature reading, send an alert to local hub, send location data, triangulate location, any boxes in same group that already completed group objectives.

Nodes can be associated with logistic items. Examples of a logistic item includes, for example, a package, a box, pallet, a container, a truck or other conveyance, infrastructure such as a door, a conveyor belt, a light switch, a road, or any other thing that can be tracked, monitored, sensed, etc. or that can transmit data concerning its state or environment. In some examples, a server or a master node may associate the unique node identifiers with the logistic items.

Communication paths between tape and/or non-tape nodes may be represented by a graph of edges between the corresponding logistic items (e.g., a storage unit, truck, or hub). In some embodiments, each node in the graph has a unique identifier. A set of connected edges between nodes is represented by a sequence of the node identifiers that defines a communication path between a set of nodes.

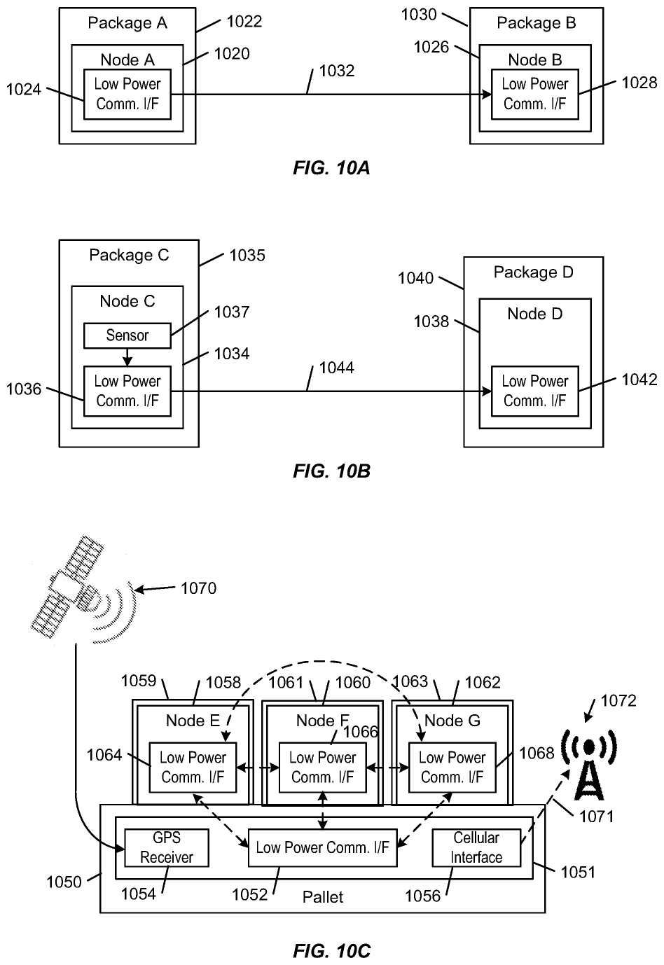

Referring to FIG. 10A, a node 1020 (Node A) is associated with a package 1022 (Package A). In some embodiments, the node 1020 may be implemented as a tape node that is used to seal the package 1022 or it may be implemented as a label node that is used to label the package 1022; alternatively, the node 1020 may be implemented as a non-tape node that is inserted within the package 1022 or embedded in or otherwise attached to the interior or exterior of the package 1022. In the illustrated embodiment, the node 1020 includes a low power communications interface 1024 (e.g., a Bluetooth Low Energy communications interface). Another node 1026 (Node B), which is associated with another package 1030 (Package B), is similarly equipped with a compatible low power communications interface 1028 (e.g., a Bluetooth Low Energy communications interface).

In an example scenario, in accordance with the programmatic code stored in its memory, node 1026 (Node B) requires a connection to node 1020 (Node A) to perform a task that involves checking the battery life of Node A. Initially, Node B is unconnected to any other nodes. In accordance with the programmatic code stored in its memory, Node B periodically broadcasts advertising packets into the surrounding area. When the other node 1020 (Node A) is within range of Node B and is operating in a listening mode, Node A will extract the address of Node B and potentially other information (e.g., security information) from an advertising packet. If, according to its programmatic code, Node A determines that it is authorized to connect to Node B, Node A will attempt to pair with Node B. In this process, Node A and Node B determine each other's identities, capabilities, and services. For example, after successfully establishing a communication path 1032 with Node A (e.g., a Bluetooth Low Energy formatted communication path), Node B determines Node A's identity information (e.g., master node), Node A's capabilities include reporting its current battery life, and Node A's services include transmitting its current battery life to other nodes. In response to a request from Node B, Node A transmits an indication of its current battery life to Node B.

Referring to FIG. 10B, a node 1034 (Node C) is associated with a package 1035 (Package C). In the illustrated embodiment, the Node C includes a low power communications interface 1036 (e.g., a Bluetooth Low Energy communications interface), and a sensor 1037 (e.g., a temperature sensor). Another node 1038 (Node D), which is associated with another package 1040 (Package D), is similarly equipped with a compatible low power communications interface 1042 (e.g., a Bluetooth Low-Energy communications interface).

In an example scenario, in accordance with the programmatic code stored in its memory, Node D requires a connection to Node C to perform a task that involves checking the temperature in the vicinity of Node C. Initially, Node D is unconnected to any other nodes. In accordance with the programmatic code stored in its memory, Node D periodically broadcasts advertising packets in the surrounding area. When Node C is within range of Node D and is operating in a listening mode, Node C will extract the address of Node D and potentially other information (e.g., security information) from the advertising packet. If, according to its programmatic code, Node C determines that it is authorized to connect to Node D, Node C will attempt to pair with Node D. In this process, Node C and Node D determine each other's identities, capabilities, and services. For example, after successfully establishing a communication path 1044 with Node C (e.g., a Bluetooth Low Energy formatted communication path), Node D determines Node C's identity information (e.g., a peripheral node), Node C's capabilities include retrieving temperature data, and Node C's services include transmitting temperature data to other nodes. In response to a request from Node D, Node C transmits its measured and/or locally processed temperature data to Node D.

Referring to FIG. 10C, a pallet 1050 is associated with a master node 1051 that includes a low-power communications interface 1052, a GPS receiver 1054, and a cellular communications interface 1056. In some embodiments, the master node 1051 may be implemented as a tape node or a label node that is adhered to the pallet 1050. In other embodiments, the master node 1051 may be implemented as a non-tape node that is inserted within the body of the pallet 1050 or embedded in or otherwise attached to the interior or exterior of the pallet 1050.

The pallet 1050 provides a structure for grouping and containing packages 1059, 1061, 1063 each of which is associated with a respective peripheral node 1058, 1060, 1062 (Node E, Node F, and Node G). Each of the peripheral nodes 1058, 1060, 1062 includes a respective low power communications interface 1064, 1066, 1068 (e.g., Bluetooth Low Energy communications interface). In the illustrated embodiment, each of the nodes E, F, G, and the master node 1051 are connected to each of the other nodes over a respective low power communications path (shown by dashed lines).

In some embodiments, the packages 1059, 1061, 1063 are grouped together because they are related. For example, the packages 1059, 1061, 1063 may share the same shipping itinerary or a portion thereof. In an example scenario, the master pallet node 1051 scans for advertising packets that are broadcasted from the peripheral nodes 1058, 1060, 1062. In some examples, the peripheral nodes broadcast advertising packets during respective scheduled broadcast intervals. The master node 1051 can determine the presence of the packages 1059, 1061, 1063 in the vicinity of the pallet 1050 based on receipt of one or more advertising packets from each of the nodes E, F, and G. In some embodiments, in response to receipt of advertising packets broadcasted by the peripheral nodes 1058, 1060, 1062, the master node 1051 transmits respective requests to the server to associate the master node 1051 and the respective peripheral nodes 1058, 1060, 1062. In some examples, the master tape node requests authorization from the server to associate the master tape node and the peripheral tape nodes. If the corresponding packages 1059, 1061, 1063 are intended to be grouped together (e.g., they share the same itinerary or certain segments of the same itinerary), the server authorizes the master node 1051 to associate the peripheral nodes 1058, 1060, 1062 with one another as a grouped set of packages. In some embodiments, the server registers the master node and peripheral tape node identifiers with a group identifier. The server also may associate each node ID with a respective physical label ID that is affixed to the respective package.

In some embodiments, after an initial set of packages is assigned to a multi package group, the master node 1051 may identify another package arrives in the vicinity of the multi-package group. The master node may request authorization from the server to associate the other package with the existing multi-package group. If the server determines that the other package is intended to ship with the multi-package group, the server instructs the master node to merge one or more other packages with currently grouped set of packages. After all packages are grouped together, the server authorizes the multi-package group to ship. In some embodiments, this process may involve releasing the multi-package group from a containment area (e.g., customs holding area) in a shipment facility.

In some embodiments, the peripheral nodes 1058, 1060, 1062 include environmental sensors for obtaining information regarding environmental conditions in the vicinity of the associated packages 1059, 1061, 1063. Examples of such environmental sensors include temperature sensors, humidity sensors, acceleration sensors, vibration sensors, shock sensors, pressure sensors, altitude sensors, light sensors, and orientation sensors.

In the illustrated embodiment, the master node 1051 can determine its own location based on geolocation data transmitted by a satellite-based radio navigation system 1070 (e.g., GPS, GLONASS, and NAVSTAR) and received by the GPS receiver 1054 component of the master node 1051. In an alternative embodiment, the location of the master pallet node 1051 can be determined using cellular based navigation techniques that use mobile communication technologies (e.g., GSM, GPRS, CDMA, etc.) to implement one or more cell-based localization techniques. After the master node 1051 has ascertained its location, the distance of each of the packages 1059, 1061, 1063 from the master node 1051 can be estimated based on the average signal strength of the advertising packets that the master node 1051 receives from the respective peripheral node. The master node 1051 can then transmit its own location and the locations of the package nodes E, F, and G to a server over a cellular interface connection with a cellular network 1072. Other methods of determining the distance of each of the packages 1059, 1061, 1063 from the master node 1051, such as Received Signal-Strength Index (RSSI) based indoor localization techniques, also may be used.

In some embodiments, after determining its own location and the locations of the peripheral nodes, the master node 1051 reports the location data and the collected and optionally processed (e.g., either by the peripheral nodes peripheral nodes 1058, 1060, 1062 or the master node 1051) sensor data to a server over a cellular communication path 1071 on a cellular network 1072.

In some examples, nodes are able to autonomously detect logistics execution errors if packages that are supposed to travel together no longer travel together and raise an alert. For example, a node (e.g., the master node 1051 or one of the peripheral nodes 1058, 1060, 1062) alerts the server when the node determines that a particular package 1059 is being or has already been improperly separated from the group of packages. The node may determine that there has been an improper separation of the particular package 1059 in a variety of ways. For example, the associated peripheral node 1058 that is bound to the particular package 1059 may include an accelerometer that generates a signal in response to movement of the package from the pallet. In accordance with its intelligent agent program code, the associated peripheral node 1058 determines that the master node 1051 has not disassociated the particular package 1059 from the group and therefore broadcasts advertising packets to the master node, which causes the master node 1051 to monitor the average signal strength of the advertising packets and, if the master node 1051 determines that the signal strength is decreasing over time, the master node 1051 will issue an alert either locally (e.g., through a speaker component of the master node 1051) or to the server.

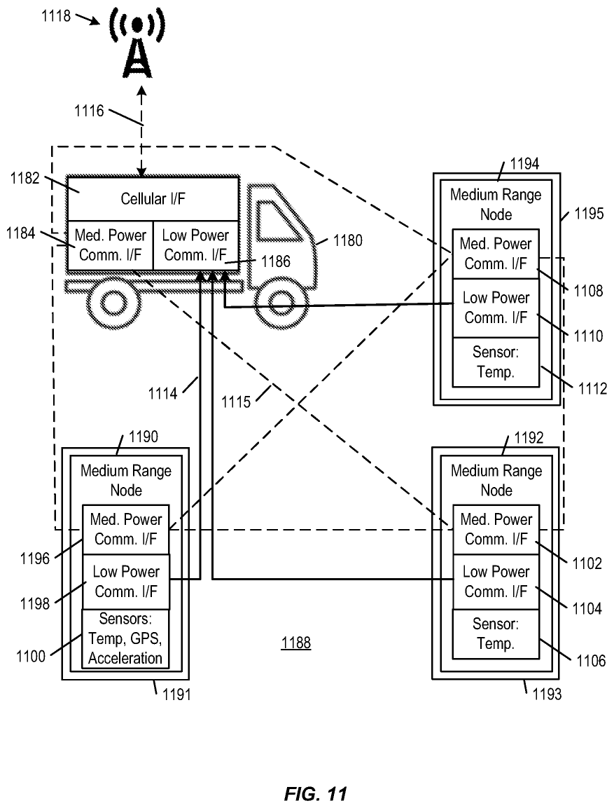

Referring to FIG. 11, a truck 1180 is configured as a mobile node or mobile hub that includes a cellular communications interface 1182, a medium-power communications interface 1184, and a low power communications interface 1186. The communications interfaces 1180-1186 may be implemented on one or more tape and non-tape nodes. In an illustrative scenario, the truck 1180 visits a logistic storage facility, such as a warehouse 1188, to wirelessly obtain temperature data generated by temperature sensors in the medium range nodes 1190, 1192, 1194. The warehouse 1188 contains nodes 1190, 1192, and 1194 that are associated with respective logistic containers 1191, 1193, 1195. In the illustrated embodiment, each node 1190-1194 is a medium range node that includes a respective medium power communications interface 1196, 1102, 1108, a respective low power communications interface 1198, 1104, 1110 and one or more respective sensors 1100, 1106, 1112. In the illustrated embodiment, each of the package nodes 1190, 1192, 1194 and the truck 1180 is connected to each of the other ones of the package nodes through a respective medium power communications path (shown by dashed lines). In some embodiments, the medium power communications paths are LoRa formatted communication paths.

In some embodiments, the communications interfaces 1184 and 1186 (e.g., a LoRa communications interface and a Bluetooth Low Energy communications interface) on the node on the truck 1180 is programmed to broadcast advertisement packets to establish connections with other network nodes within range of the truck node. A warehouse 1188 includes medium range nodes 1190, 1192, 1194 that are associated with respective logistic containers 1191, 1193, 1195 (e.g., packages, boxes, pallets, and the like). When the truck node's low power interface 1186 is within range of any of the medium range nodes 1190, 1192, 1194 and one or more of the medium range nodes is operating in a listening mode, the medium range node will extract the address of truck node and potentially other information (e.g., security information) from the advertising packet. If, according to its programmatic code, the truck node determines that it is authorized to connect to one of the medium range nodes 1190, 1192, 1194, the truck node will attempt to pair with the medium range node. In this process, the truck node and the medium range node determine each other's identities, capabilities, and services. For example, after successfully establishing a communication path with the truck node (e.g., a Bluetooth Low Energy formatted communication path 1114 or a LoRa formatted communication path 1117), the truck node determines the identity information for the medium range node 1190 (e.g., a peripheral node), the medium range node's capabilities include retrieving temperature data, and the medium range node's services include transmitting temperature data to other nodes. Depending of the size of the warehouse 1188, the truck 1180 initially may communicate with the nodes 1190, 1192, 1194 using a low power communications interface (e.g., Bluetooth Low Energy interface). If any of the anticipated nodes fails to respond to repeated broadcasts of advertising packets by the truck 1180, the truck 1180 will try to communicate with the non-responsive nodes using a medium power communications interface (e.g., LoRa interface). In response to a request from the medium-power communication interface 1184, the medium range node 1190 transmits an indication of its measured temperature data to the truck node. The truck node repeats the process for each of the other medium range nodes 1192, 1194 that generate temperature measurement data in the warehouse 1188. The truck node reports the collected (and optionally processed, either by the medium range nodes 1190, 1192, 1194 or the truck node) temperature data to a server over a cellular communication path 1116 with a cellular network 1118.

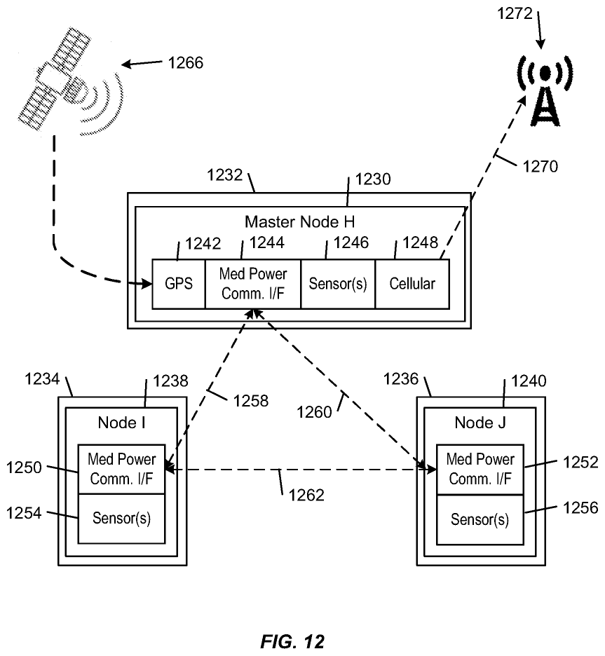

Referring to FIG. 12, a master node 1230 is associated with a logistic item 1232 (e.g., a package) and grouped together with other logistic items 1234, 1236 (e.g., packages) that are associated with respective peripheral nodes 1238, 1240. The master node 1230 includes a GPS receiver 1242, a medium power communications interface 1244, one or more sensors 1246, and a cellular communications interface 1248. Each of the peripheral nodes 1238, 1240 includes a respective medium power communications interface 1250, 1252 and one or more respective sensors 1254, 1256. In the illustrated embodiment, the peripheral and master nodes are connected to one another other over respective pairwise communications paths (shown by dashed lines). In some embodiments, the nodes 1230, 1238, 1240 communicate through respective LoRa communications interfaces over LoRa formatted communications paths 1258, 1260, 1262.

In the illustrated embodiment, the master and peripheral nodes 1230, 1238, 1240 include environmental sensors for obtaining information regarding environmental conditions in the vicinity of the associated logistic items 1232, 1234, 1236. Examples of such environmental sensors include temperature sensors, humidity sensors, acceleration sensors, vibration sensors, shock sensors, pressure sensors, altitude sensors, light sensors, and orientation sensors.

In accordance with the programmatic code stored in its memory, the master node 1230 periodically broadcasts advertising packets in the surrounding area. When the peripheral nodes 1238, 1240 are within range of master node 1230, and are operating in a listening mode, the peripheral nodes 1238, 1240 will extract the address of master node 1230 and potentially other information (e.g., security information) from the advertising packets. If, according to their respective programmatic code, the peripheral nodes 1238, 1240 determine that they are authorized to connect to the master node 1230, the peripheral nodes 1238, 1240 will attempt to pair with the master node 1230. In this process, the peripheral nodes 1238, 1240 and the master node 1230 determine each other's identities, capabilities, and services. For example, after successfully establishing a respective communication path 1258, 1260 with each of the peripheral nodes 1238, 1240 (e.g., a LoRa formatted communication path), the master node 1230 determines certain information about the peripheral nodes 1238, 1240, such as their identity information (e.g., peripheral nodes), their capabilities (e.g., measuring temperature data), and their services include transmitting temperature data to other nodes.

After establishing LoRa formatted communications paths 1258, 1260 with the peripheral nodes 1238, 1240, the master node 1230 transmits requests for the peripheral nodes 1238, 1240 to transmit their measured and/or locally processed temperature data to the master node 1230.

In the illustrated embodiment, the master node 1230 can determine its own location based on geolocation data transmitted by a satellite-based radio navigation system 1266 (e.g., GPS, GLONASS, and NAVSTAR) and received by the GPS receiver 1242 component of the master node 1230. In an alternative embodiment, the location of the master node 1230 can be determined using cellular based navigation techniques that use mobile communication technologies (e.g., GSM, GPRS, CDMA, etc.) to implement one or more cell-based localization techniques. After the master node 1230 has ascertained its location, the distance of each of the logistic items 1234, 1236 from the master node 1230 can be estimated based on the average signal strength of the advertising packets that the master node 1230 receives from the respective peripheral node. The master node 1230 can then transmit its own location and the locations of the package nodes H, J, and I to a server over a cellular interface connection with a cellular network 1272. Other methods of determining the distance of each of the logistic items 1234, 1236 from the master node 1230, such as Received Signal-Strength Index (RSSI) based indoor localization techniques, also may be used.

In some embodiments, after determining its own location and the locations of the peripheral nodes, the master node 1230 reports the location data, the collected and optionally processed (e.g., either by the peripheral nodes peripheral nodes 1238, 1240 or the master node 1230) sensor data to a server over a cellular communication path 1270 on a cellular network 1272.

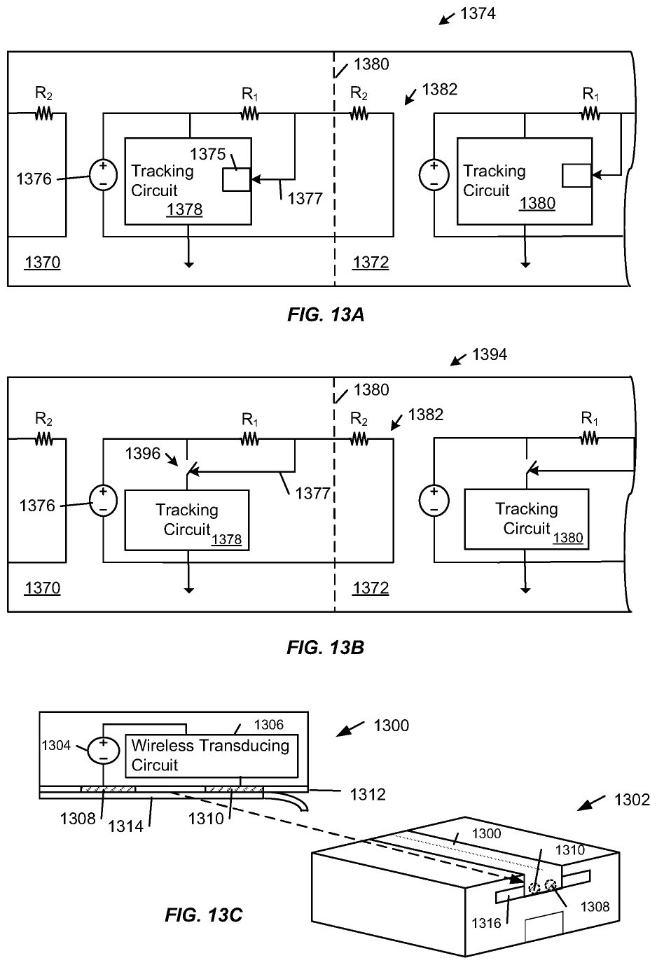

Referring to FIG. 13A, in some examples, each of one or more of the segments 1370, 1372 of a tracking adhesive product 1374 includes a respective circuit 1375 that delivers power from the respective energy source 1376 to the respective tracking circuit 1378 (e.g., a processor and one or more wireless communications circuits) in response to an event. In some of these examples, the wake circuit 1375 is configured to transition from an off-state to an on-state when the voltage on the wake node 1377 exceeds a threshold level, at which point the wake circuit transitions to an on-state to power-on the segment 1370. In the illustrated example, this occurs when the user separates the segment from the tracking adhesive product 1374, for example, by cutting across the tracking adhesive product 1374 at a designated location (e.g., along a designated cut-line 1380). In particular, in its initial, un-cut state, a minimal amount of current flows through the resistors R1 and R2. As a result, the voltage on the wake node 1377 remains below the threshold turn-on level. After the user cuts across the tracking adhesive product 1374 along the designated cut-line 1380, the user creates an open circuit in the loop 1382, which pulls the voltage of the wake node above the threshold level and turns on the wake circuit 1375. As a result, the voltage across the energy source 1376 will appear across the tracking circuit 1378 and, thereby, turn on the segment 1370. In particular embodiments, the resistance value of resistor R1 is greater than the resistance value of R2. In some examples, the resistance values of resistors R1 and R2 are selected based on the overall design of the adhesive product system (e.g., the target wake voltage level and a target leakage current).

In some examples, each of one or more of the segments of a tracking adhesive product includes a respective sensor and a respective wake circuit that delivers power from the respective energy source to the respective one or more components of the respective tracking circuit 1378 in response to an output of the sensor. In some examples, the respective sensor is a strain sensor that produces a wake signal based on a change in strain in the respective segment. In some of these examples, the strain sensor is affixed to a tracking adhesive product and configured to detect the stretching of the tracking adhesive product segment as the segment is being peeled off a roll or a sheet of the tracking adhesive product. In some examples, the respective sensor is a capacitive sensor that produces a wake signal based on a change in capacitance in the respective segment. In some of these examples, the capacitive sensor is affixed to a tracking adhesive product and configured to detect the separation of the tracking adhesive product segment from a roll or a sheet of the tracking adhesive product. In some examples, the respective sensor is a flex sensor that produces a wake signal based on a change in curvature in the respective segment. In some of these examples, the flex sensor is affixed to a tracking adhesive product and configured to detect bending of the tracking adhesive product segment as the segment is being peeled off a roll or a sheet of the tracking adhesive product. In some examples, the respective sensor is a near field communications sensor that produces a wake signal based on a change in inductance in the respective segment.

FIG. 13B shows another example of a tracking adhesive product 1394 that delivers power from the respective energy source 1376 to the respective tracking circuit 1378 (e.g., a processor and one or more wireless communications circuits) in response to an event. This example is similar in structure and operation as the tracking adhesive product 1394 shown in FIG. 13A, except that the wake circuit 1375 is replaced by a switch 1396 that is configured to transition from an open state to a closed state when the voltage on the switch node 1377 exceeds a threshold level. In the initial state of the tracking adhesive product 1394, the voltage on the switch node is below the threshold level as a result of the low current level flowing through the resistors R1 and R2. After the user cuts across the tracking adhesive product 1394 along the designated cut-line 1380, the user creates an open circuit in the loop 1382, which pulls up the voltage on the switch node above the threshold level to close the switch 1396 and turn on the tracking circuit 1378.

A wireless sensing system includes a plurality of wireless nodes configured to detect tampering in assets. Tampering may include, but is not limited to, opening assets such as boxes, containers, storage, or doors, moving the asset without authorization, moving the asset to an unintended location, moving the asset in an unintended way, damaging the asset, shaking the asset in an unintended way, orienting an asset in a way that it is not meant to be oriented. In many cases, these actions may compromise the integrity or safety of assets. Wireless nodes associated with the asset are configured to detect a tampering event. In an embodiment, a tampering event is associated with an action, a time, and a location. In an embodiment, the wireless nodes communicate the tampering event to the wireless sensing system. The wireless sensing system is configured to provide a notification or alert to a user of the wireless sensing system. In some embodiments, a wireless node may directly transmit the notification or alert to the user. In other embodiments, a wireless node may include a display that indicates whether or not a tampering event has occurred (e.g., the display may be an indicator light or LED).

Alerts may be transmitted to server/cloud, other wireless nodes, a client device, or some combination thereof. For example, in an embodiment, a wireless node of the wireless sensing system captures sensor data, detects a tampering event, and transmits an alarm to a user of the wireless sensing system (e.g., without communicating with a server or cloud of the wireless sensing system). In another embodiment, a wireless node of the wireless sensing system captures sensor data and transmits the sensor data to a gateway, parent node (e.g., black tape), or client device. The gateway, parent node, or client device detects a tampering event based on the received sensor data and transmits an alarm to a user of the wireless sensing system. In another embodiment, the wireless node of the wireless sensing system captures sensor data, detects a tampering event, and transmits information describing the tampering event to a server or cloud of the wireless sensing system. The server or cloud of the wireless sensing system transmits an alarm to a user of the wireless sensing system.

FIG. 13C shows a diagrammatic cross-sectional front view of an example adhesive tape platform 1300 and a perspective view of an example asset 1302. Instead of activating the adhesive tape platform in response to separating a segment of the adhesive tape platform from a roll or a sheet of the adhesive tape platform, this example is configured to supply power from the energy source 1304 to turn on the wireless transducing circuit 1306 in response to establishing an electrical connection between two power terminals 1308, 1310 that are integrated into the adhesive tape platform. In particular, each segment of the adhesive tape platform 1300 includes a respective set of embedded tracking components, an adhesive layer 1312, and an optional backing sheet 1314 with a release coating that prevents the segments from adhering strongly to the backing sheet 1314. In some examples, the power terminals 1308, 1310 are composed of an electrically conductive material (e.g., a metal, such as copper) that may be printed or otherwise patterned and/or deposited on the backside of the adhesive tape platform 1300. In operation, the adhesive tape platform can be activated by removing the backing sheet 1314 and applying the exposed adhesive layer 1312 to a surface that includes an electrically conductive region 1316. In the illustrated embodiment, the electrically conductive region 1316 is disposed on a portion of the asset 1302. When the adhesive backside of the adhesive tape platform 1300 is adhered to the asset with the exposed terminals 1308, 1310 aligned and in contact with the electrically conductive region 1316 on the asset 1302, an electrical connection is created through the electrically conductive region 1316 between the exposed terminals 1308, 1310 that completes the circuit and turns on the wireless transducing circuit 1306. In particular embodiments, the power terminals 1308, 1310 are electrically connected to any respective nodes of the wireless transducing circuit 1306 that would result in the activation of the tracking circuit 1306 in response to the creation of an electrical connection between the power terminals 1308, 1310.

In some examples, after a tape node is turned on, it will communicate with the network service to confirm that the user/operator who is associated with the tape node is an authorized user who has authenticated himself or herself to the network service. In these examples, if the tape node cannot confirm that the user/operator is an authorized user, the tape node will turn itself off.

### Portable Wireless Network Enhancement Device

The systems and methods described herein are described with the realization that for wireless networks, there is limited infrastructure resources to provide the necessary hardware to implement coverage for providing ubiquitous functionality within the wireless network. For example, in wireless tracking systems that utilize a plurality of wireless nodes to track a plurality of assets, there may be dead zones within the wireless network that are difficult to add the necessary hardware to resolve said dead zones. Moreover, as the assets move around, such as in warehousing and distribution centers, there may be locations within the warehouse or the warehouse yard that, at certain times but not others, have more assets with associated tracking nodes. These situations may result in desirable additional fidelity at the locations with higher-density of wireless tracking nodes than typical where existing infrastructure hardware implementing the wireless network is limited in ability to provide coverage at the high-density area.

The systems and methods described herein resolve the above-discussed problems by providing a portable wireless network enhancement device that, when deployed to a desired location, enhances and coordinates with the current infrastructure hardware to improve the functionality of the wireless network. Said enhancement and coordination may include a variety of functionality that is not available by the currently deployed infrastructure hardware, or is redundant to the current deployed infrastructure hardware but reassigned to the portable wireless network enhancement device to save resources (e.g., bandwidth, power management, sensor availability, etc.) of the current deployed infrastructure hardware. As an example, certain embodiments of the systems and methods herein may provide ad-hoc geofencing and cordoning systems where one or more portable wireless network enhancement devices are deployed within an area and act as a geofence to prevent and alert when assets (or the wireless nodes attached thereto) breach a defined geofence. As another example, certain embodiments of the systems and methods may be deployed to a high-density area of wireless nodes and coordinate with said wireless nodes and additional infrastructure hardware devices (such as wireless gateways) to shift functionality of the wireless nodes to the temporarily-deployed portable wireless network enhancement device to reduce power consumption of the wireless gateways and/or wireless tracking nodes.

The systems and methods described herein are described with the additional realization that, in certain environments, human interfacing with a wireless tracking system should not have undesirable lag, such as when data must go to a cloud network prior to being presented to a human that is interpreting said data; or such as when a human must pull out a user device (e.g., user phone, tablet, computer, screen, etc.). Users may be loading packages into a distribution vehicle, or working on an assembly line, or other environments where it is impractical to stop what the user is doing and pull out the user device in order to be alerted of events occurring and detectable within the wireless tracking nodes data generated by wireless tracking nodes attached to assets. Additionally, alerts that are transmitted to a user device may not always be noticed or received by a distracted user or by a user in an environment that is noisy or has low signal reception. Certain embodiments of the systems and methods described herein resolve the above-discussed problems by providing a portable wireless network enhancement device that includes a human-interface that allows the user to directly interact with the portable wireless network enhancement device to obtain and request information associated with wireless nodes of the wireless network. As an example, a portable wireless network enhancement device may be deployed to a location to provide functionality that is not achievable by current infrastructure of the wireless network such as being alerted about an event within the data and the human using voice or other interaction with the portable wireless network enhancement device to directly obtain definition of the event. As another example, a user may interact directly with a portable wireless network device to ensure that all necessary assets for performing a job (e.g., surgical procedure, mechanical work, etc.) having associated wireless nodes attached thereto, are in vicinity of the portable wireless network enhancement device before performing the job. As another example, a user may interact directly to ensure that proper assets are being loaded and/or unloaded from a delivery vehicle, airplane cargo, train cargo, marine cargo, etc.

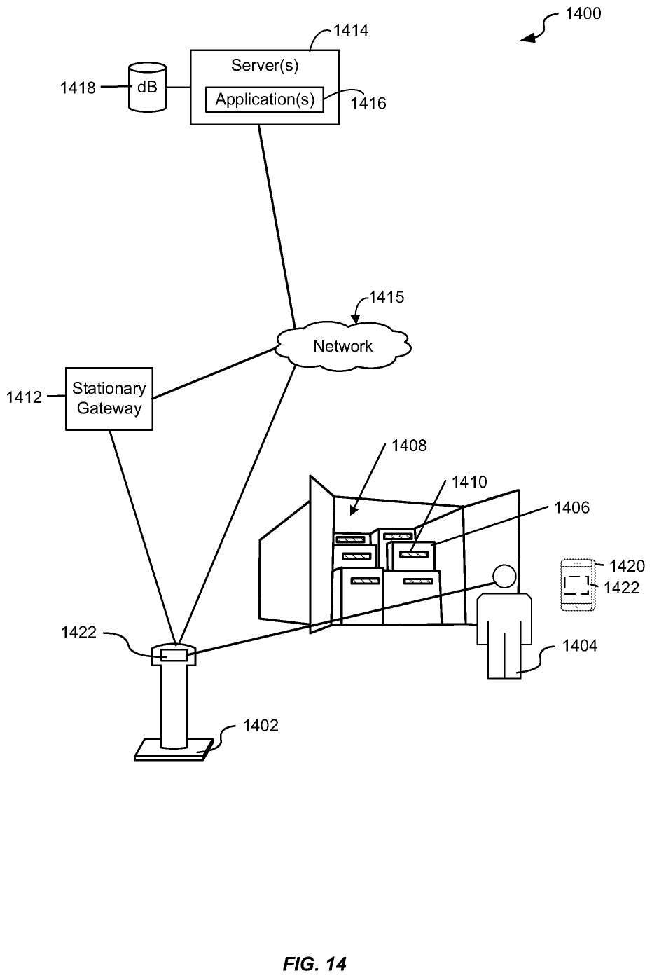

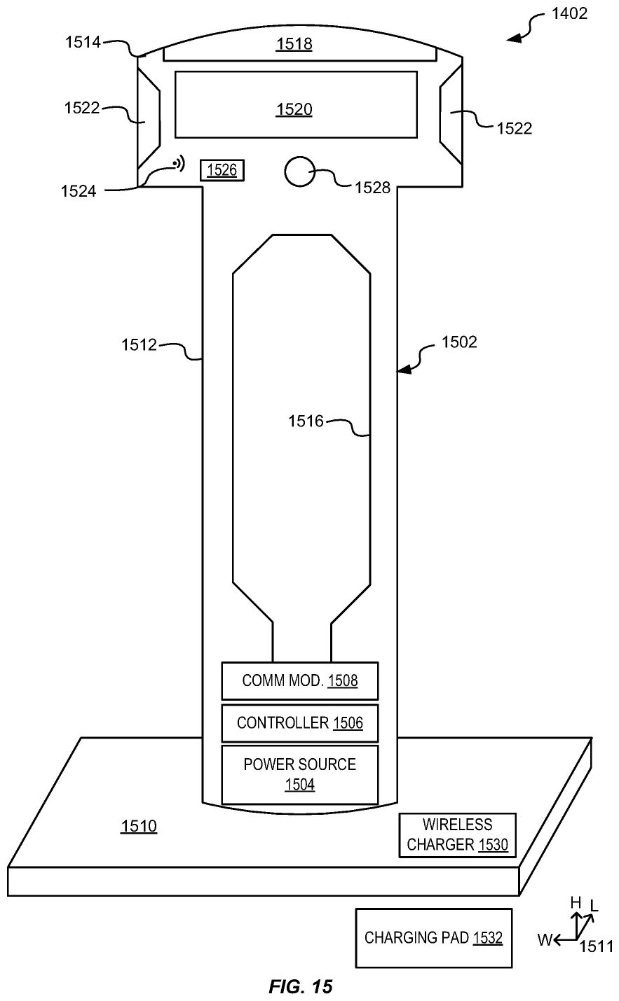

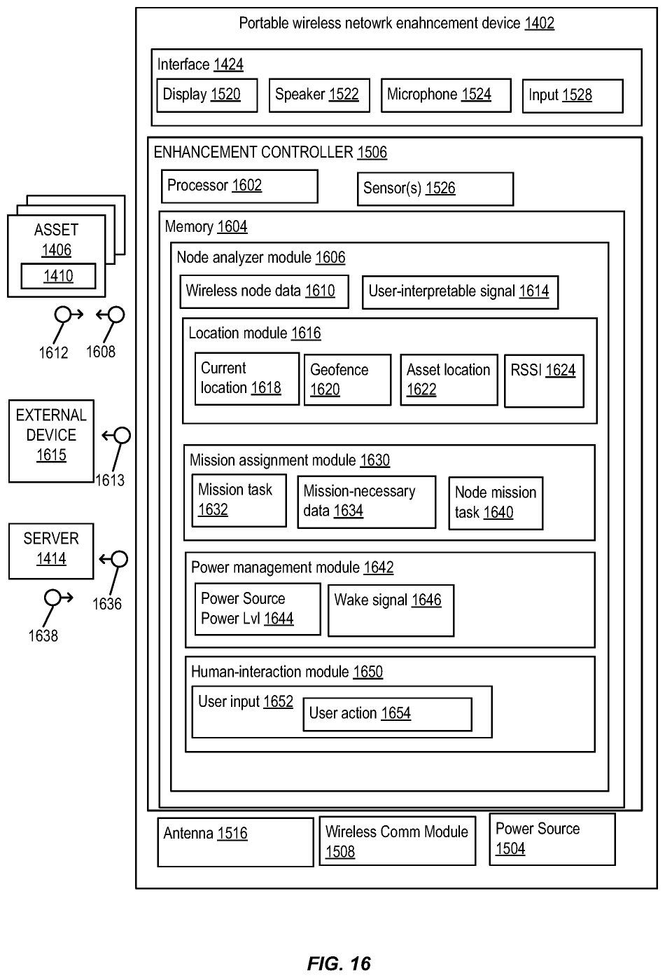

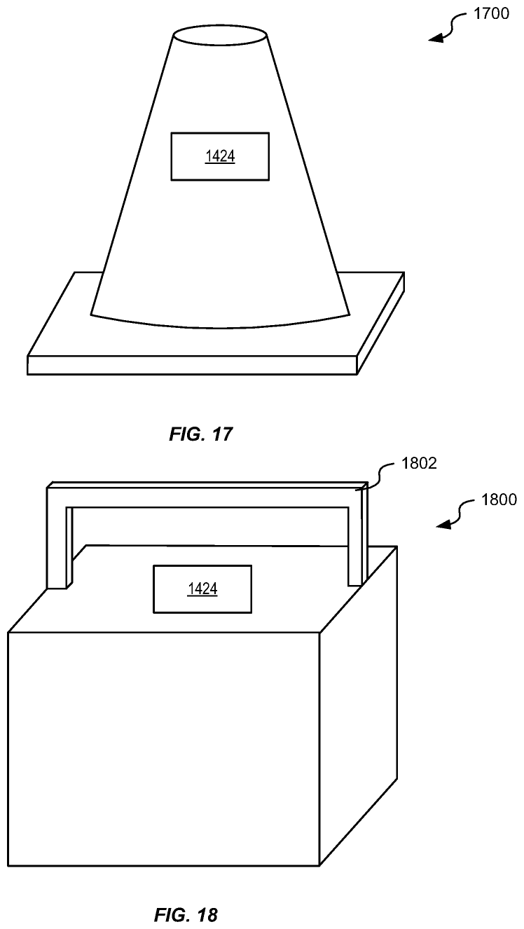

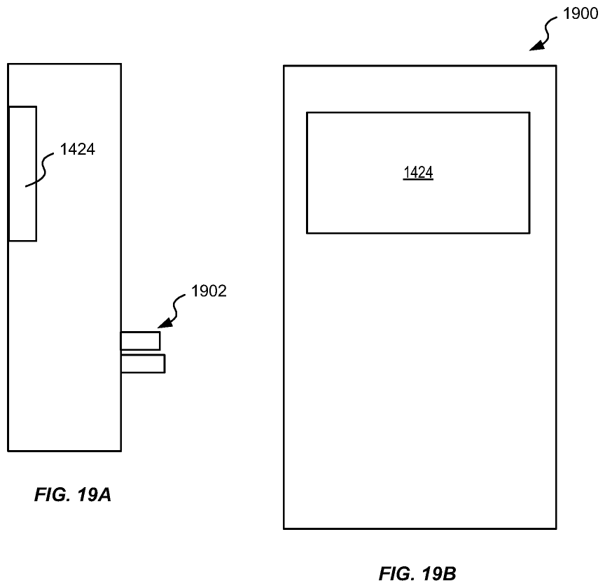

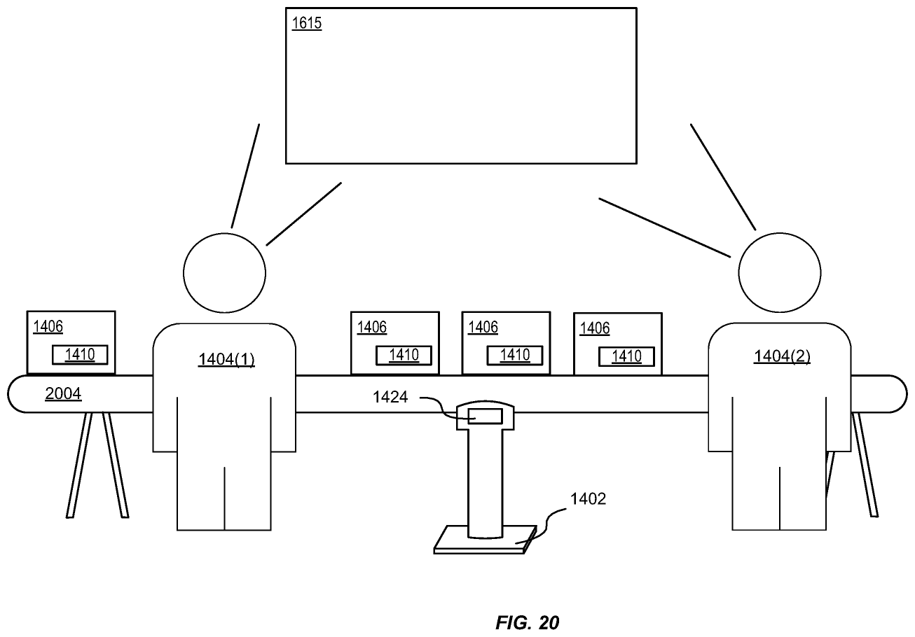

FIG. 14 shows an example wireless network 1400 having a portable wireless network enhancement device 1402 included therein to provide additional fidelity to infrastructure components within the wireless network 1400. FIG. 15 shows the portable wireless network enhancement device 1402 in additional detail, in embodiments. FIG. 16 shows a block diagram of various components of portable wireless network enhancement device, including the enhancement controller 1506 of FIG. 15 in further detail, in embodiments. FIG. 17 shows an embodiment of portable wireless network enhancement device having a cone form factor. FIG. 18 shows an embodiment of portable wireless network enhancement device having a box (or “briefcase”) form factor. FIG. 19A and FIG. 19B show a side view and front view, respectively, of a “pluggable” form factor in including a plug that directly plugs into a wall socket. FIG. 20 shows application of portable wireless network enhancement device in use with an external device, in an embodiment. FIGS. 14-20 are best viewed together with the following description.

The example wireless network 1400 of FIG. 14 is shown with a user 1404 unloading or loading one or more assets 1406 within a delivery vehicle cargo area 1408. Each of the one or more assets 1406 respectively includes a wireless node 1410 which may be used to provide wireless node data for use in tracking assets 1406 within wireless network 1400. Without portable wireless network enhancement device 1402, each wireless node 1410 may transmit data to, and receive data from other of the wireless nodes 1410, or stationary gateway 1412, which is an embodiment of the stationary gateway 1714 discussed above. Stationary gateway 1412 may be in communication with an external server 1414 (which is an embodiment of server 704 discussed above) via network 1415 (which is an embodiment of network 702 discussed above), which executes application 1416 (which is an example of application 706 discussed above), and stores the wireless node data in a database 1418 (which is an example of database 708 discussed above). Thus, it should be appreciated that portable wireless network enhancement device 1402 is an enhancement device to the network communications environment 700 discussed above. Portable wireless network enhancement device 1402 is not limited to being implemented within network communications environment 700, or wireless network 1400, but may be used in other applications having wireless network infrastructure components such as indoor environments (e.g., stadiums, airports, distribution centers, manufacturing warehouses and associated assembly lines, hospitals, etc.), outdoor environments (e.g., stadiums, parks, zoos, airports, train stations, etc.), or any other area where there is a human-asset interaction.

Wireless network 1400, and associated portable wireless network enhancement device 1402, addresses a problem that occurs in environments where a human operator (also referred to as a “user”) is manipulating assets or other tangible things that have wireless nodes (e.g., wireless node 1410) that provide data associated therewith. In typical such environments, the user (e.g., user 1402) must stop what they are doing to use a user device 1420 and associated application 1422 thereon to obtain any information associated with the wireless node 1410. The portable wireless network enhancement device 1402 solves this problem by including a human-interaction interface 1424 that allows the user to, without stopping what they are doing, obtain information from the portable wireless network enhancement device 1402. This allows for users to receive critical information to a task that indicates an event that may demand immediate intervention or disruption of a task by the users, with minimal delay. Similarly, users may interact with the portable wireless network enhancement device 1402 to quickly initiate follow-up actions to be performed by the portable wireless network enhancement device 1402 or by members of the wireless network 1400. In some embodiments, the user 1404 may interact with a component of the wireless network 1400 to confirm that a human is aware of an event that is being signaled by the portable wireless network enhancement device 1402. In further embodiments, interaction may include the user 1404 pressing a button, touching a touchscreen display, or actuating another component of the portable wireless network enhancement device 1402. Similarly, the user 1404 may interact with a component of the portable wireless network enhancement device 1402 to confirm to the system that the event being signaled is now resolved.

The portable wireless network enhancement device 1402 may optionally be in communication directly with the gateway 1412 (or other infrastructure hardware) and implement a communication bridge between the wireless node 1410 within delivery vehicle cargo area 1408 and the stationary gateway 1412. Alternatively, in situations where high latency is acceptable, the portable wireless network enhancement device 1402 may store data received from wireless node 1410 and upload it to external server 1414 or stationary gateway 1412 when it reaches communication range of the stationary gateway external server 1414 or another location that provides adequate signal strength and connectivity between external server 1414 and portable wireless network enhancement device 1402. For example, this may be done for specific sets of data that do not need to be instantaneously processed or uploaded to the external server 1414 (such as diagnostic data of one or more of the wireless nodes 1410). In some situations, to conserve battery of portable wireless network enhancement device 1402, the portable wireless network enhancement device 1402 may opt to have the gateway 1412 upload on behalf of the portable wireless network enhancement device 1402.

Portable wireless network enhancement device 1402 may take the form of a cone, pylon, or other self-standing form factor that enables the portable wireless network enhancement device 1402 to be placed anywhere within wireless network 1400 and provide said enhancement functionality to the wireless network 1400 while standing in the placed location. FIG. 17, for example, shows an embodiment 1700 of portable wireless network enhancement device 1402 having a cone form factor. FIG. 18, for example, shows an embodiment 1800 of portable wireless network enhancement device 1402 having a box (or “briefcase”) form factor. FIG. 19A and FIG. 19B, for example, show a side view and front view, respectively, of a “pluggable” form factor in including a plug 1902 that directly plugs into a wall socket. Although plug 1902 is shown integral with the housing of the pluggable form factor, it should be understood that it may be distant therefrom, and coupled to the housing via a cord. Portable wireless network enhancement device 1402 is shown including housing 1502 that is sized and shaped to enclose a power source 1504, an enhancement controller 1506, a wireless communication module 1508 and one or more human-interaction interface 1424. Housing 1502 may be made from any suitable material, including one or more materials selected from the group of materials including, but not limited to: plastic, PVC, rubber, metal, metal with plastic insert, composite materials, wood, etc.

In the specific embodiment of portable wireless network enhancement device 1402 shown in FIG. 15, housing 1502 includes a base 1510, an extension 1512 extending upward from the base, and a top area 1514 at an opposite end of the extension 1512 from the base 1510. The human-interaction interface 1424 is located at the top area 1514, but may be included in other areas without departing from the scope hereof. According to the coordinate axis 1511, base 1510 is shown having a first width and a first height, the extension 1512 is shown having a second width and a second height, the first width being greater than the second width. Furthermore, in the embodiment shown, the second height of extension 1512 is greater than the first height of base 1510. In at least some embodiments, the extension 1512 has a width that tapers from the base 1510 to the top area 1514 (such as the cone 1700 embodiment of FIG. 17; but the taper is not limited to the specific taper shown in FIG. 17). It should be appreciated that other lengths, widths, and heights may be implemented for any aspect of housing 1502 without departing from the scope hereof. One benefit of the width/height ratio described above is that the pylon form-factor shown in FIG. 15 enables the portable wireless network enhancement device 1402 to be placed anywhere desired while maintaining a upward location of top area 1514 so that user 1404 can readily interact with human-interaction interface 1424.

In the specific embodiment of FIG. 15, power source 1504 is located closer to base 1510 than top area 1514. This allows for a lowered center of gravity of portable wireless network enhancement device 1402 which makes it less-likely that the portable wireless network enhancement device 1402 will tip over and thus improves the self-standing capability of portable wireless network enhancement device 1402.

Wireless communication module 1508 includes at least one antenna 1516 and associated transceiver circuitry coupled with the antenna 1516 to receive and transmit wireless signals. In some embodiments, a single multi-radio antenna of the at least one antenna 1516 is used for multiple radio frequency communication protocols and is coupled to more than one respective wireless communication interfaces or transceiver circuits. For example, the single multi-radio antenna may be used to transmit and receive radio frequency signals used in some combination of Bluetooth-based, WiFi-based, and RFID communications. In at least some embodiments, the antenna 1516 has a length (shown in FIG. 15 extending in the height direction of axis 1511) greater than 50% of the height of the extension 1512. There may be more than one antenna 1516, such as a receiving antenna and a separate transmitting antenna. Moreover, the wireless communication module 1508 may implement a plurality of wireless communication protocols, and have an individual antenna 1516 dedicated to each communication protocol, or to a plurality of the communication protocols. For example, there may be one wireless communication module that implements a low-power communication interface, another that implements a medium-power communication interface, and another that implements a high-power communication interface. The plurality of wireless communication protocol embodiments provide the advantage that, because the portable wireless network enhancement device 1402 is a temporary or non-infrastructure-based addition to wireless network 1400, the portable wireless network enhancement device 1402 may be used to supplement wireless network 1400 to provide additional capability without requiring additional hardware/firmware/software to be permanently installed (e.g., additional infrastructure hardware). Additionally, the temporary nature of portable wireless network enhancement device 1402 enables the other components of wireless network 1400 to offload capability from the other components to the portable wireless network enhancement device 1402 to save power resources (particularly when battery-powered) of those other components of wireless network 1400.

In at least one embodiment, wireless communication module 1508 includes at least one interface and antenna (e.g., at least one antenna 1516) that implements an RFID reading capability so that wireless communication module 1508 may receive RFID-based wireless node data from one or more wireless nodes 1410. The one or more wireless nodes 1410 may include one or more RFID tags (passive or active RFID tags). The wireless communication module 1508 may read the RFID tags, receiving data and identifiers stored on the RFID tags and then relay that data to other wireless nodes of the network 1400 using another wireless communication channel such as Bluetooth-based communications or cellular-based communications, for example. In at least one embodiment, wireless communication module 1508 includes at least one interface and antenna that implements an RFID illuminating capability so that wireless communication module 1508 may illuminate an area proximate the portable wireless network enhancement device 1402 with an RFID-based wireless signal to trigger one or more wireless nodes 1410 to transmit an RFID response signal with wireless data from the one or more wireless nodes 1410. The features associated with illuminator 1420 and illumination signal 1421 discussed in U.S. Patent Publication No. 2423/0024103, entitled “Multi-communication-interface system for fine locationing”, and filed Sep. 12, 2422, may apply to the RFID illuminating capability and devices that implement said RFID illuminating capability herein. As such, U.S. Patent Publication No. 2423/0024103 is incorporated by reference herein to the extent that the illumination and response discussed therein, and associated devices, apply to illuminating capabilities discussed herein.

In some embodiments, the portable wireless network enhancement device 1402 includes multiple wireless communication and sensor hardware capabilities, including a plurality of different types of sensors and wireless communication systems for various wireless communication protocols. The portable wireless network enhancement device 1402 may be configured to only use a subset of the wireless communication and sensor capabilities for an assigned task, while deactivating or disabling other wireless communications and sensor capabilities and/or components when those capabilities/components are not needed for a given assigned task. Deactivating or disabling certain capabilities and/or components may allow the portable wireless network enhancement device 1402 to conserve battery, while still performing functions critical to completing an assigned task. The portable wireless network enhancement device 1402 may take on an agent identity/role that defines the subset of wireless communication and sensor capabilities, as well as hierarchical roles and tasks to complete in the scheme of the wireless network 1400. The agent identity/role may be assigned by the server 1414 or by other wireless nodes (e.g., wireless nodes 1410, user device 1420, stationary gateway 1412 or other portable wireless network enhancement devices 1402), as described above.

Housing 1502 may include further carrying means for assisting in maneuvering the portable wireless network enhancement device 1402 within a given area. The carrying means may be a handle, or other shape, protrusion, indention, or the like within housing 1502. As one example, in the briefcase embodiment 1800, a handle 1802 is shown that assists in maneuvering the portable wireless network enhancement device 1402.

Power source 1504 may be any source of power including rechargeable and non-rechargeable forms. In at least some embodiments, the power source 1504 is a line-power source including a plug for plugging in the portable wireless network enhancement device 1402 to an electrical outlet. An example of line-power source is shown as plug 1902 in FIG. 19A and FIG. 19B. In at least some embodiments, the power source 1504 is a removable rechargeable battery. The housing 1502 may include a battery slot configured to releasably retain the rechargeable battery. Moreover, in at least some embodiments, power source 1504 may include an energy harvesting device 1518. Energy harvesting device 1518 is shown in FIG. 15 as a solar panel located in top area top area 1514. However, energy harvesting device 1518 may be other types of energy harvesting devices, such as one or more of a solar panel, a wireless energy harvesting device, and a vibration-based energy harvesting device.

Similarly the energy harvesting device 1518 may be positioned elsewhere relative to the housing, in other embodiments. For example, FIG. 15 also shows an optional wireless charger 1530 located in the base 1510. Wireless charger 1530 may be a coil that interfaces with an electromagnetic field generated by a charging pad 1532 to transfer energy to power source 1504. Wireless charger 1530 may be in a location that corresponds to the charging pad 1532. Charging pad 1532 may be a component of a storage rack, integrated in flooring of a storage location, or otherwise placed in a storage location for storing portable wireless network enhancement device 1402 such that, when in storage, the charging pad 1532 wirelessly interfaces with wireless charger 1530 to charge power source 1504. For example, wireless charger 1530 and charging pad 1532 may include hardware/firmware necessary to implement a wireless charging protocol, such as the Qi standard, Power Matter Alliance (PMA) standard, or other wireless charging protocol.

Human-interaction interface 1424 may include one or more devices that enable portable wireless network enhancement device 1402 to interact, with or without user 1404 touching the portable wireless network enhancement device 1402. If the user 1404 does not need to interact with the portable wireless network enhancement device 1402, their use of wireless network 1400 is more efficient because they do not have to stop what they are doing to access user device 1420 to obtain information about wireless nodes 1410.

In at least some embodiments, human-interaction interface 1424 includes display 1520. Display 1520 may be a low-power use display, such as an E-ink display, or other type of display that uses minimal power from power source 1504. Display 1520 may be a higher-resolution display that uses more power, such as LED, LCD, OLED, or other types of displays that provide better resolution than E-ink displays (for example), but require more power to use. This are particularly useful in embodiments where power source 1504 is a line-powered device. Display 1520 may also be a single light that causes user 1404 to visually interpret information from portable wireless network enhancement device 1402.

In at least some embodiments, human-interaction interface 1424 includes one or more speaker 1522. Portable wireless network enhancement device 1402 in FIG. 15 is shown with two speakers 1522, but there may be more or fewer (e.g., one or three or more) without departing from the scope hereof.

In at least some embodiments, human-interaction interface 1424 includes one or more microphone 1524 used to detect voice and sound-related input from user 1404 into portable wireless network enhancement device 1402.

Portable wireless network enhancement device 1402 may include any combination of one or more additional sensors 1526, in at least some embodiments. For example, portable wireless network enhancement device 1402 may include one or more of a light sensor, a vibration sensor, a temperature sensor, a humidity sensor, a pressure sensor, an accelerometer, an orientation sensor, and a location sensor (e.g., cellular triangulation, GPS, GLONASS, and NAVSTAR and the like).

Human-interaction interface 1424 may include additional input/output devices, such as button 1528 that allows user 1404 to physically interact with portable wireless network enhancement device 1402. Button 1528 may be a component of display 1520, particularly when display 1520 is a touch-screen display.

Any of the components, or any subset thereof, within FIG. 15 may be included in any of the other form factors shown in FIG. 17, FIG. 18, FIG. 19A, or FIG. 19B (or any other form factor). Moreover, although shown in FIG. 15, a given component may be optional. For example, the human-interaction interface 1424 may include any one or more of display 1520, one or more speaker 1522, microphone 1524, button 1528, or any combination thereof. Moreover, in embodiments, energy harvesting device 1518 or one or more additional sensors 1526 are not included.

As shown in FIG. 16, portable wireless network enhancement device 1402 includes the enhancement controller 1506 that operates to provide, using various components of the portable wireless network enhancement device 1402 enhanced functionality within wireless network 1400. Enhancement controller 1506 includes a processor 1602 in operational communication with memory 1604. Memory 1604 stores one or more functional modules as computer readable instructions that, when executed by processor 1602 operate to control the portable wireless network enhancement device 1402 to provide the functionality described below.

In one embodiment, enhancement controller 1506 includes a wireless-node analyzer module 1606. Wireless-node analyzer module 1606 operates to transmit, using the wireless communication module, a node request signal 1608 to ones of the plurality of wireless nodes 1410 within operating range of the wireless communication module 1508. Wireless-node analyzer module 1606 receives, in response to the node request signal 1608, wireless-node data 1610 within a response signal 1612 from responding ones of the plurality of wireless nodes. In certain embodiments, the scanning and receiving implemented by the wireless-node analyzer module 1606 includes RFID-based scanning/receiving protocol. Moreover, in certain embodiments, the node request signal 1608 may be an RFID-based illumination signal which triggers one or more wireless nodes 1410 to respond to the illumination signal. The wireless-node data 1610 may include an identifier of the wireless node 1410 that generated the data within wireless-node data 1610, as well as one or more other data features such as sensor data, power level data, location data, etc. Moreover, the wireless-node data 1610 may include prior-stored data within the wireless node 1410 generating the response signal 1612, such as data stored but not already transmitted to another device, or data received from another device (e.g., another wireless node) at the wireless node 1410 for relay to the portable wireless network enhancement device 1402 and/or external server 1414 for further processing and/or storage. Moreover, response signal 1612 may be a relayed response signal in that in response to the node request signal 1608, a first wireless node 1410 transmits data to one or more additional wireless nodes 1410 or another device such as stationary gateway 1412, which then in turn transmits the wireless-node data 1610 ultimately to the portable wireless network enhancement device 1402. Thus, the wireless-node data 1610 as stored within memory 1604 is ultimately a database of data obtained from one or more wireless node 1410 or other devices.

Wireless-node analyzer module 1606 generate a user-interpretable signal 1614 based on the wireless-node data 1610, and outputs, using the human-interaction interface 1424 the user-interpretable signal 1614. Thus, the user-interpretable signal 1614 may cause human-interaction interface 1424 to activate to interact with user 1404. For example, where the human-interaction interface 1424 includes display 1520, the user-interpretable signal 1614 may cause display 1520 to display some or all of the wireless-node data 1610 that was associated with an event therein (e.g., the ID of the wireless node 1410 associated with the event). For example, where the human-interaction interface 1424 includes display 1520, the user-interpretable signal 1614 may cause display 1520 to flash, flash a specific color, illuminate with a specific color, illuminate with a given image, flash at a specific frequency/periodicity, show a graphic, text, or video, or other configuration of display 1520. As another example, where the human-interaction interface 1424 includes one or more speaker 1522, the user-interpretable signal 1614 may cause one or more speaker 1522 to audibly indicate an alert, or other user-interpretable sound that causes user 1404 to interact with portable wireless network enhancement device 1402.

FIG. 20 shows application of portable wireless network enhancement device 1402 in use with an external device 1615, in an embodiment. The user-interpretable signal 1614 may indicate that user 1404 should interact with (e.g., look at) another device other than portable wireless network enhancement device 1402. For example, portable wireless network enhancement device 1402 may be in wireless communication with an external device 1615. In the example illustrated in FIG. 20, external device 1615 includes a display (or array of displays) visible to multiple users 1404 at the same time, such as a display associated with an assembly line, distribution loading/unloading area, baggage claim at an airport, flight location, or the like. External device 1615 may also be one or more user devices 1420 discussed above. In a working environment, users 1404 may be focused on a given work task and not necessarily monitoring external device 1615. Use of portable wireless network enhancement device 1402 in such system allows for, in situations where user 1404 needs to see information on external device 1615, the human-interaction interface 1424 to be triggered (in response to user-interpretable signal 1614) to generate a sound, or visual indication, that user 1404 is to direct attention to external device 1615.

FIG. 20 shows a single portable wireless network enhancement device 1402 in use with two users 1404. However, there may be more or fewer users 1404 associated with each portable wireless network enhancement device 1402. For example, in one embodiment, there is one or more portable wireless network enhancement device 1402 that are shared among a plurality of users/workstations. As another example, each workstation, lane (e.g., group of users 1404 and associated workstations), grouping of lanes, or grouping of workstations has a dedicated one or more portable wireless network enhancement device 1402. The number of portable wireless network enhancement device 1402 may be modified ad-hoc to accommodate a changing density of assets being monitored and/or users in a given area.

In one example of operation, when a given asset 1406, as indicated by the wireless-node data 1610, is in a correct location, or has characteristics (e.g., temperature, pressure, etc.) necessary for that asset, the portable wireless network enhancement device 1402 may indicate a positive indication such as a noise or a light of a certain color (e.g., green). Alternatively, when a given asset 1406, as indicated by the wireless-node data 1610 associated with said asset 1406, is in a wrong location or has characteristics (e.g., temperature, pressure, etc.) that contradict necessary requirements for the given asset (as defined in mission-necessary data 1634, the portable wireless network enhancement device 1402 may indicate a negative indication such as a noise or a light of a certain color (e.g., red). Additionally, display 1520 or one or more speaker 1522 of human-interaction interface 1424 may indicate that user 1404 associated with that asset (e.g., a worker on a distribution line 2004 that is to be loading said asset into a specific bin or container) is to skip the task for the user 1404, or modify the task for the user 1404 (such as remove or replace the asset 1406 from distribution line 2004). The user-interpretable signal 1614 or another external-device signal 1613 may also be transmitted, using wireless communication module 1508, to external device 1615 to provide data associated with an event within wireless-node data 1610 such that display 1520 indicates that the user 1404 should look at external device 1615 and receive the indication that the user should modify its working task. As an example, where a given asset is located nearby a given portable wireless network enhancement device 1402, the external-device signal 1613 may cause the external device 1615 to indicate that the given asset, as identified within wireless-node data 1610, is nearby a specific portable wireless network enhancement device 1402.

The portable wireless network enhancement device 1402 may also serve as a portable gateway to one or more wireless node 1410 located on assets 1406 moving alone distribution line 2004. For example, portable wireless network enhancement device 1402 may be monitoring wireless-node data 1610 from wireless node 1410 of assets 1406 on distribution line 2004 and identify positive or negative information therein. For example, when wireless-node data 1610 indicates that a misload occurs, or that an asset 1406 does not have appropriate environmental characteristics (e.g., temperature, pressure, etc.), portable wireless network enhancement device 1402 may report back to a server (e.g., external server 1414), either directly or through a gateway (e.g., 1412) so that the error is reported to mission control.

As a working example of use of portable wireless network enhancement device 1402, assume a sorting environment that sorts hundreds of unit load devices (ULD). Each ULD, and the associated assets, may be associated with a wireless node 1410. “Package 5” may be identified (by wireless-node analyzer module 1606 analyzing base 1510, or another device) as in container B, but it should be in a container C. The user-interpretable signal 1614 may cause display 1520 and/or one or more speaker 1522 to indicate to the users associated with handling the packages and loading them into containers B and C to look at external device 1615 (or directly at human-interaction interface 1424) to figure out who they should coordinate with to resolve the location of “package 5.” The user associated with container B can stop container B and take package 5 out of the container B, and hand it to the appropriate user associated with container C.

In at least some embodiments, the wireless-node analyzer module 1606 generates the user-interpretable signal 1614 in response to an event being detected by the wireless-node analyzer module 1606 within the wireless-node data 1610. For example, where the portable wireless network enhancement device 1402 is monitoring location of one or more assets 1406, and the wireless-node data 1610 associated with a given asset indicates that that given asset has entered a location it is not supposed to be, then the user-interpretable signal 1614 maybe generated such that it causes human-interaction interface 1424 to indicate to user 1404 that the given asset is not where it is supposed to be. As an example, if the portable wireless network enhancement device 1402 is located proximate a delivery vehicle where user 1404 is loading and/or unloading asset 1406 into/out of the delivery vehicle, then user-interpretable signal 1614 may case display to flash green when the asset is properly being loaded/unloaded, or red when the asset is not properly loaded or unloaded.

Wireless-node analyzer module 1606 may include, or work in collaboration with, a location module 1616 that monitors a current characteristic 1618 of the portable wireless network enhancement device 1402. As such, location module 1616 operates as further computer-readable instructions that, when executed by processor 1602 operate to cause portable wireless network enhancement device 1402 to implement the following functionality. Current characteristic 1618 may be determined based on an on-board GPS sensor on the portable wireless network enhancement device 1402 (e.g., within the one or more additional sensors 1526). Current characteristic 1618 may be determined using a location signal that is used to triangulate the current characteristic 1618 based on cellular, or Wi-Fi, or other wireless protocol triangulation using the wireless communication module 1508. Current characteristic 1618 may be received from another device, such as stationary gateway 1412 that has a known location. The current characteristic 1618 may be used by location module 1616 in connection with a geofence 1620. When the wireless-node data 1610 indicates that one or more assets has breached geofence 1620, the wireless-node analyzer module 1606 (or location module 1616) may generate the user-interpretable signal 1614 such that human-interaction interface 1424 indicates that the given asset has breached the geofence 1620. For example, the user-interpretable signal 1614 may cause display 1520 to show the location of the breached asset, or display a warning that one or more assets, and their corresponding ID based on the wireless-node data 1610 has breached the geofence 1620. As another example, the user-interpretable signal 1614 may cause one or more speaker 1522 to audibly indicate the location of the breached asset, or audibly indicate a warning that one or more assets, and their corresponding ID based on the wireless-node data 1610 has breached the geofence 1620.

Location module 1616 may also analyze wireless-node data 1610 to store an asset location list 1622. Asset location list 1622 may be used to query for location of specific assets. For example, portable wireless network enhancement device 1402 may receive indication of a specific wireless node, or asset associated with the specific wireless node, to be searched. Location module 1616 determine if the specific wireless node is within the wireless node data 1610 (or where the wireless node is based on asset location list 1622). Location module 1616 (or wireless-node analyzer module 1606) may then generate the user-interpretable signal 1614 to cause human-interaction interface 1424 to indicate that the specific wireless node is nearby the portable wireless network enhancement device 1402 when asset location list 1622 includes the specific wireless node. For example, the display 1520 may display a text indication, or specific location of, the specific wireless node with respect to the portable wireless network enhancement device 1402. As another example, the one or more speaker 1522 may generate a noise, or play a given sound/voice playback, indicating location of the specific wireless node, or that the specific wireless node is nearby portable wireless network enhancement device 1402.

Portable wireless network enhancement device 1402 may further coordinate with additional portable wireless network enhancement devices 1402. For example, where a specific wireless node is being searched for, when a first portable wireless network enhancement device 1402 finds the specific wireless node (e.g., it is located in wireless-node data 1610 or asset location list 1622), the user-interpretable signal 1614 may not only cause the first portable wireless network enhancement device 1402 to indicate that the specific wireless node is there, but it may also be transmitted to the additional portable wireless network enhancement devices 1402 to cause them to display location of the specific wireless node. Thus, a network of portable wireless network enhancement device 1402 may determine and/or indicate which of the plurality of portable devices is closest to the specific wireless node.

Location module 1616 may further use current characteristic 1618 to optimize intended location of the portable wireless network enhancement device 1402. Location module 1616 may optimize location of portable wireless network enhancement device 1402 by comparing current characteristic 1618 against network characteristics of other wireless devices (e.g., one or more of wireless nodes 1410, infrastructure components of wireless network 1400 such as stationary gateway 1412, and/or additional portable wireless network enhancement devices 1402). In one example of optimizing intended location of the portable wireless network enhancement device 1402, includes analyzing received signal strength indicator (RSSI) data 1624 (within or based on wireless-node data 1610) to determine an optimized location 1626 of the portable device within the network. The generated user-interpretable signal 1614 may then cause the human-interaction interface 1424 to indicate direction and/or distance the portable wireless network enhancement device 1402 should be moved to result in a better coverage within wireless network 1400. In particular embodiments, the optimized location 1626 is determined based solely on RSSI data 1624 associated with only additional portable wireless network enhancement device 1402. Optimized location 1626 may result in positioning of the portable wireless network enhancement device 1402 with respect to one or more additional portable wireless network enhancement device 1402. In particular embodiments, the optimized location 1626 is determined based solely on RSSI data 1624 associated with only infrastructure components of wireless network 1400, such as one or more stationary gateways 1412. In another embodiments, location module 1616 may analyze the position of the portable wireless network enhancement device 1402 and determine that the portable wireless network enhancement device 1402 needs to change locations to complete a task or optimally fulfill a role assigned to it in the network 1400, based on other characteristics of the location, besides signal strength. For example, if the portable wireless network enhancement device 1402 requires light exposure to complete a task or charge one of its batteries, the location module 1616 may determine an optimized location 1626 that is different than its current location based on incident light on the portable wireless network enhancement device 1402.

The portable wireless network enhancement device 1402 may generate a variety of user-interpretable signals 1614 to cause human-interaction interface 1424 to indicate that the portable wireless network enhancement device 1402 needs to be moved. In an example, the portable wireless network enhancement device 1402 may display a red light when the portable wireless network enhancement device 1402 is in an invalid or non-optimal location, and may display a green light when it enters a location that is near a optimized location 1626. In some embodiments, the portable wireless network enhancement device 1402 emits audio through a speaker that indicates if the location of the portable wireless network enhancement device 1402 is acceptable for a current task or role. For example, the portable wireless network enhancement device 1402 may emit audio cues that indicate the portable wireless network enhancement device 1402 being closer or further away from the optimized location 1626. In other examples, the portable wireless network enhancement device 1402 may emit audio including verbal instructions for a user to move the portable wireless network enhancement device 1402 to a location, towards a trajectory, or towards a general area. The portable wireless network enhancement device 1402 may emit audio including verbal instructions that say “please move the portable wireless network enhancement device to a location with better cellular signal strength,” for example.

Wireless-node analyzer module 1606 may include, or work in collaboration with, a mission assignment module 1630 which assigns (e.g., determines or otherwise configures the operational settings of the portable wireless network enhancement device 1402) a mission task 1632 for the portable wireless network enhancement device 1402. As such, mission assignment module 1630 operates as further computer-readable instructions that, when executed by processor 1602 operate to cause portable wireless network enhancement device 1402 to implement the following functionality. Since the portable wireless network enhancement device 1402 may act as a gateway node mission assignment module 1630 may also assign tasks to other wireless nodes (for example if a long relay of communication bridges is required for data transfer). Control rights of mission assignment module 1630 may be defined based on whether the portable wireless network enhancement device 1402 is made a parent agent role or a child agent role with respect to surrounding wireless nodes of a given hierarchy of wireless nodes.

The mission assignment module 1630 may operate to receive a mission task from an external device (e.g., external server 1414, stationary gateway 1412, user device 1420, or one or more of the wireless nodes 1410). The mission assignment module 1630 may override a current mission task for the portable wireless network enhancement device 1402 using the received mission task, or may add to a list of current mission tasks for the portable wireless network enhancement device 1402. For example, an asset 1406 with critical temperature parameters may have a sensor tape node 1410 which reports an out of threshold temperature reading. The sensor tape node may transmit a request to the mission assignment module 1630 with high priority that the portable wireless network enhancement device 1402 change its operational mission task to signaling for intervention and uploading the event to the cloud (e.g. External server 1414), regardless of what the portable wireless network enhancement device's previous mission task was. Mission assignment module 1630 may cause portable wireless network enhancement device 1402 to prioritize executing the new mission task in parallel with previous mission task or may even deprioritize the previous mission task. An example of the portable wireless network enhancement device's previous mission task may be to perform diagnostic measurements for signal reception in the network, a task that is deprioritized or executed in parallel to the high priority task assigned to the portable wireless network enhancement device 1402 when it receives the request from the sensor tape node 1410.

The mission assignment module 1630 may operate in conjunction with one or more other functionality discussed herein. Mission assignment module 1630 may analyze the current characteristic 1618, and automatically assign or set its own mission task 1632 when the current characteristic 1618 meets a given threshold, according to some embodiments. The current characteristic 1618 may be a current location determined using location module 1616. Current characteristic 1618 may be any other characteristic of portable wireless network enhancement device 1402, such as but not limited to: a specific available power of power source 1504, signal reception available using wireless communication module 1508, priority of a request from another wireless node wireless node 1410, assignment by mission control (e.g., server 1414), a specific temperature determined using one or more additional sensors 1526, override or request by a nearby user (e.g., using user device 1420), a specific role determined using mission assignment module 1630, and the like. For example, in a distribution center application, when current characteristic 1618 indicates that portable wireless network enhancement device 1402 is located within a pre-defined threshold distance to a loading/unloading dock, mission task 1632 may be set to monitor loading and unloading of assets 1406 (based on received wireless-node data 1610 associated with wireless node 1410 coupled to assets 1406.

Mission assignment module 1630 analyze each assigned mission task 1632 to determine if mission-necessary data 1634 is already stored within memory 1604. For example, continuing the loading/unloading example in the above paragraph, if mission task 1632 is set to monitor loading/unloading of assets, mission assignment module 1630 may query memory 1604 to determine if 1634 includes a manifest for assets that are to be loaded/unloaded to a given vehicle.

The analysis of mission task 1632 against mission-necessary data 1634 may be further or alternatively based on available wireless-node data 1610. Mission assignment module 1630 may further analyze wireless-node data 1610 to identify types of assets, specific IDs of assets, or other information about the environment of the portable wireless network enhancement device 1402. For example, wireless-node data 1610 may indicate that the portable wireless network enhancement device 1402 is nearby a specific delivery vehicle, airplane, ULD, manufacturing line, conveyor belt, etc. This indication may cause mission assignment module 1630 to assign a mission task 1632 and/or determine if the necessary mission-necessary data 1634 is already available in memory 1604.

When mission-necessary data 1634 is not already within memory 1604, mission assignment module 1630 may transmit a data request 1636 to external device, such as external server 1414. Mission assignment module 1630 may then receive an data response 1638 including mission-necessary data 1634 and/or an update thereto.

In certain embodiments, the mission task 1632 may set a hierarchical role of portable wireless network enhancement device 1402 within a hierarchy of a plurality of wireless nodes within wireless network 1400. This hierarchical role may be transmitted to all other wireless components (e.g., wireless nodes 1410, infrastructure components such as gateway 1412, and the like). In embodiments, the hierarchical role is configured without input from external devices such as server 1414. By automatically configuring the mission task 1632 as a hierarchical role of the portable wireless network enhancement device 1402, and transmitting said hierarchical role to other devices within wireless network 1400, the wireless network 1400 is able to operate autonomously without intervention from external cloud-based servers. This provides the advantage of expediting the functionality of wireless network 1400, and allows for operational functionality even when there is limited or no access to external networks such as server 1414.

Moreover, in certain embodiments, the hierarchical role set by the portable wireless network enhancement device 1402 may override hierarchical roles set by all other nodes within wireless network 1400. In certain embodiments, the hierarchical role set by the portable wireless network enhancement device 1402 may override hierarchical roles set by other wireless nodes within wireless network 1400, but not line-powered infrastructure nodes such as line-powered gateways. This provides the advantage that the portable wireless network enhancement device 1402 utilizes its temporary nature to provide enhanced functionality that saves power for the wireless nodes within wireless network 1400.

Mission assignment module 1630 may also generate node mission tasks 1640 that assign a specific task to one or more of the wireless nodes 1410. For example, the node mission tasks 1640 may instruct one or more of a plurality of wireless nodes 1410 to transmit sensed data from one or more of a plurality of wireless nodes and let the portable wireless network enhancement device 1402 relay the received sensed data to an external server using the wireless communication module 1508. As another example, node mission tasks 1640 may instruct one or more wireless node 1410 to use portable wireless network enhancement device 1402 for communication to external devices, such as external server 1414 or stationary gateway 1412. This reduces power consumption particularly when the wireless nodes can use a low-power communication interface to transmit data to the portable wireless network enhancement device 1402, and then the portable wireless network enhancement device 1402 can use a higher-power communication interface to get said data to the external server. Moreover, a plurality of portable wireless network enhancement device 1402 may coordinate with each other to define a virtual transmission line. The virtual transmission line may allow for relay of data between multiple ones of the portable wireless network enhancement devices 1402.

Wireless-node analyzer module 1606 may include, or work in collaboration with, a power management module 1642 that operates to control power usage of portable wireless network enhancement device 1402. As such, power management module 1642 operates as further computer-readable instructions that, when executed by processor 1602 operate to cause portable wireless network enhancement device 1402 to implement the following functionality.

In one embodiment, power management module 1642 monitors a power level 1644 of power source 1504 and generates 1614 when the power level 1644 reaches a predetermined threshold. This indicates to user 1404 that power source 1504 needs replacing.

In certain embodiments, power management module 1642 may generate a wake signal 1646. Wake signal 1646 may cause one or more components of the portable device to transition from an inactive state to an active state in response to detection of a user in proximity to the portable wireless network enhancement device 1402. For example, the human-interaction interface 1424 may transition from an inactive state to an active state. “Inactive” for purposes of said wake signal 1646 may mean off in a no-power state, or merely in a low-power state. “Active” for purposes of said wake signal 1646 may mean “on” or otherwise in a higher-power state than inactive.

In at least one embodiment, the wake signal 1646 is generated based on detection of an authorized user in image or video data. For example, the one or more additional sensors 1526 discussed above may include a camera. the power management module 1642 may analyze image or video data from the camera to detect a user within a field of view of the camera. The power management module 1642 may then output the wake signal 1646 to the human-interaction interface (or other component(s) of portable wireless network enhancement device 1402) in response to detection of the user in the image or video data. In other embodiments, the wake signal 1646 is generated in response to receiving a wireless communication from a wireless node associated with an authorized user (e.g., a wireless node 1410 worn or attached to the user, or the user device 1420) or a wireless node associated with an asset tracked in the network 1400. For example, the wireless communication may be from a smart badge, wearable device, or user device associated with a user that is requesting services from the portable wireless network enhancement device 1402. In other embodiments, the wake signal 1646 may be generated based on receiving a corresponding input from a user via the input 1528 of the human-interaction interface 1424. For example, a user may indicate that the portable wireless network enhancement device 1402 is being deployed and needs to transition to an active state by pressing a button of the input 1528. In response, the power management module 1642 generates a wake signal for one or more components.

In certain embodiments, the transition from inactive to active state occurs when the user is determined to be authorized. In the above-embodiment based on image or video data, the authorized user may be determined based on facial recognition, clothing color and/or pattern, or other image-based authorization techniques. In certain embodiments, the power management module 1642 utilizes wireless communication module 1508 to authorize a given user. For example, the power management module 1642 may output wake signal 1646 to the human-interaction interface (or other component(s) of portable wireless network enhancement device 1402) in response to detection of an authorization device via wireless signal between the authorization device and wireless communication module 1508. The authorization device being an RFID tag, a wearable device, or a handheld device (such as but not limited to user device 1420).

Wireless-node analyzer module 1606 may include, or work in collaboration with, a human-interaction module 1650 that operates to detect user-interactions with one or more of display 1520 (when the display is a touch-screen), microphone 1524, or input button 1528 to receive and/or detect input 1652 from user 1404. As such, human-interaction module 1650 operates as further computer-readable instructions that, when executed by processor 1602 operate to cause portable wireless network enhancement device 1402 to implement the following functionality.

In at least some embodiments, human-interaction module 1650 and mission assignment module 1630 cooperate to determine mission task 1632 for the portable wireless network enhancement device 1402 based on input 1652. The mission task 1632 may be to provide further information or action related to previously provided user-interpretable signal 1614. For example, the mission task 1632 may include terminating the user-interpretable signal 1614 when the input 1652 is user voice input (obtained using microphone 1524) indicates that a user has resolved an event defined within the wireless node data. This provides the advantage that the user 1402 need not stop what they are doing to physically interact with portable wireless network enhancement device 1402, but instead can just speak to portable wireless network enhancement device 1402 to stop the alert caused by user-interpretable signal 1614. Alternatively, the user input 1652 may be detection of user touching input button 1528 and/or display 1520 (when display 1520 is a touch screen) to stop the action of human-interaction interface 1424 caused by the user-interpretable signal 1614.

In at least some embodiments, the user input 1652 may be a request by the user 1404 for additional information in response to noticing the human-interaction interface 1424 action in response to user-interpretable signal 1614. In such situations, the mission task 1632 may include outputting an additional user-interpretable signal that causes human-interaction interface 1424 to indicating further information associated with wireless data wireless-node data 1610. For example, the human-interaction interface 1424 may display or sound out the an event defined based on the wireless node data 1610. As an example, a loader/unloader may, in response to hearing an alarm or noticing a displayed notification, request for an indication of “what is wrong.” In response, the wireless-node analyzer module 1606 may provide additional information describing the event that triggered the user-interpretable signal 1614 in the first place, such as “Package being wrongly loaded or unloaded”, or (if the wireless node data 1610 indicates that a package experienced a fall) “Package was dropped, don't ship this one”, or (if the wireless node data 1610 indicates a given asset experienced a temperature event) “put package back in cold storage, temperature is too high”, or the like.

Enhancement controller 1506 may also implement self-monitoring to verify operational status of the portable wireless network enhancement device 1402. For example, enhancement controller 1506 may monitor an orientation sensor or accelerometer (e.g., example of one or more additional sensors 1526), to verify that the portable wireless network enhancement device 1402 is properly oriented (e.g., in an upright position). When the data from the orientation sensor or accelerometer indicates that the portable wireless network enhancement device 1402 is not properly positioned, enhancement controller 1506 may trigger an alert that is transmitted to external device such as stationary gateway 1412 or external server 1414, or user device 1420, or that is presented to a user 1404 via human-interaction interface 1424.

In at least some embodiments, the user input 1652 defines an action 1654 that the user intends to perform. In response, mission assignment module 1630 may analyze mission-necessary data 1634 and determine necessary assets to perform the action 1654 that the user intends to perform. Then, wireless-node analyzer module 1606 may generate the user-interpretable signal 1614 including indication that all of the one or more necessary assets are in proximity to (e.g., within a certain threshold distance) or that one or more of the one or more necessary assets are missing. One particular application of action 1654 may be when the one or more assets being medical supplies needed to perform a surgery or dental procedure. By the doctor working with portable wireless network enhancement device 1402, the doctor can implement a quick “check” to confirm all medical supplies are accounted for both before and after the medical procedure. As another example, the one or more assets may be tools needed to perform a job.

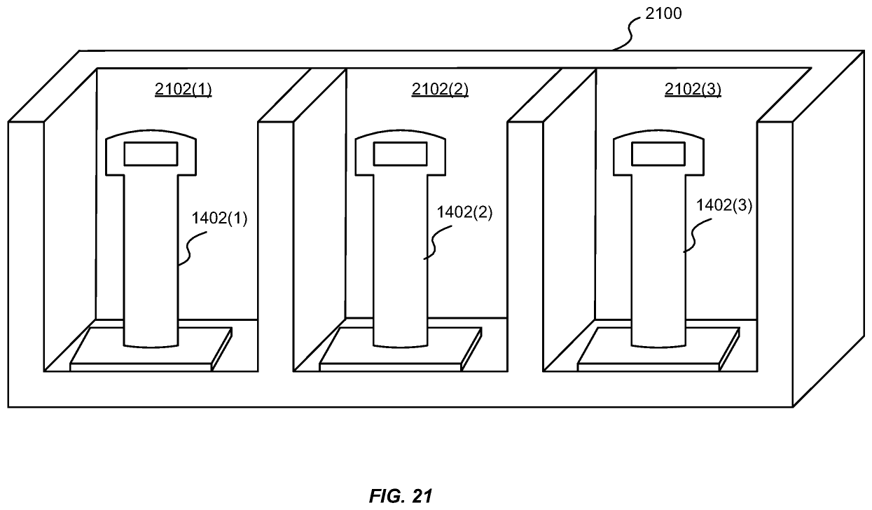

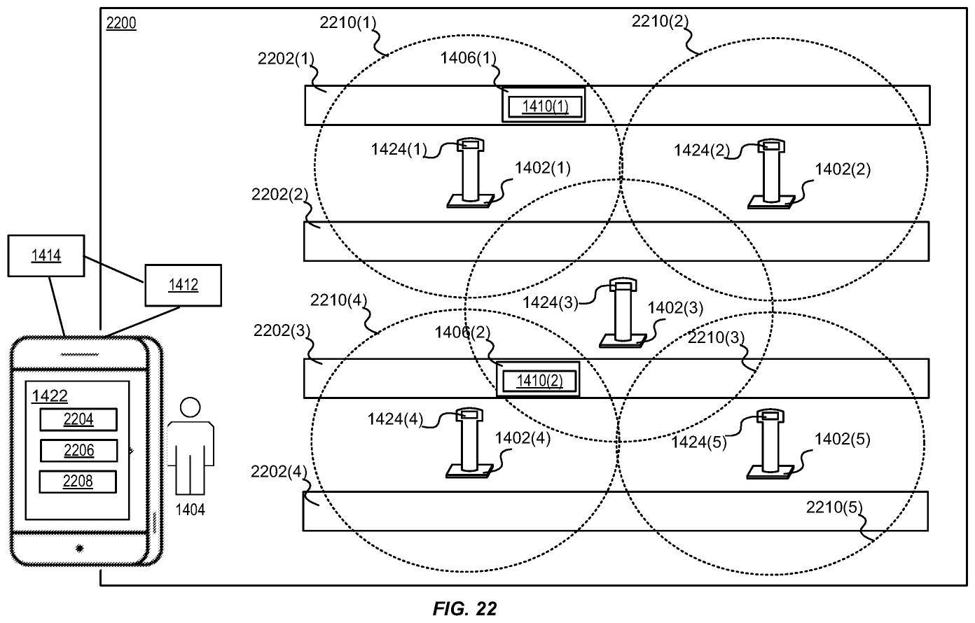

FIG. 21 shows an example storage rack 2100, storing a plurality of portable wireless network enhancement devices 1402(1)-(3), in an embodiment. Storage rack 2100 includes a plurality of slots 2102(1), 2102(2), 2102(3), each capable of receiving and storing one or more portable wireless network enhancement device 1402. Slots 2102 may include charging pad 1532 discussed above, or a different electrical connection, such that when portable wireless network enhancement device 1402 are placed in a respective slot 2102, the portable wireless network enhancement device 1402 is recharged.

In an embodiment, a set of a plurality of portable wireless network enhancement devices 1402 may include one or more subsets of portable wireless network enhancement devices, where each subset of devices includes different capabilities. In the example of FIG. 21, portable wireless network enhancement device 1402(1) may include a first capability, portable wireless network enhancement device 1402(2) may include a second capability, and portable wireless network enhancement device 1402(3) may include a third capability, where the first, second, and third capabilities are different. In use, a user or facility employee (e.g., user 1404) needs to take a portable wireless network enhancement device 1402 to a specific area for use as a HMI (human machine interface) beacon or a portable gateway node. Each of the plurality of portable wireless network enhancement device 1402 are stored together (e.g., in rack 2100), but may look indistinguishable (i.e., they may all look like cones/pylons/boxes/briefcases, etc. on the outside). In other embodiments, they may have labels with color, graphics, or text that indicate set of capabilities of the portable wireless network enhancement device 1402 (e.g. each subset may have a visual indicator that distinguishes a given subset of portable wireless network enhancement devices from other subset(s) of portable wireless network enhancement devices).

When user goes to perform a task that requires a portable wireless network enhancement device 1402, a device (e.g., server 1414, stationary gateway 1412, or the portable wireless network enhancement device 1402 (using mission assignment module 1630 for example) may determine which subsets of a plurality of portable wireless network enhancement devices are capable of performing the task. In response, the human-interaction interface 1424 of those subsets may be triggered (e.g., via user-interpretable signal 1614) to indicate (e.g., light up or flash a display with a graphic that indicates to the user, or output a sound, etc.) which of the portable wireless network enhancement devices 1402 are good candidates for the task.

The process of indicating which subset of a plurality of portable wireless network enhancement devices 1402 should be used at a given time may be initiated by the user 1404 inputting or selecting a given task using an app on a smartphone or tablet (e.g., user device 1420). Alternatively, this may be initiated by the cloud at server 1414 which issues instructions or a request to perform the task to the user 1404 and automatically alerts the portable wireless network enhancement device 1402 to check their capabilities and signal based on the check, or directly trigger human-interaction interface 1424 when the external server 1414 knows that a given portable wireless network enhancement device 1402 has the requisite capabilities. In other embodiments, the portable wireless network enhancement device 1402 may light up based on a wearable (e.g., a smart badge) or a smartphone automatically requesting the portable wireless network enhancement device 1402 to signal when the wearable or smartphone is in range.

FIG. 22 shows a working example of wireless network 1400, wherein a user 1404 may utilize user device 1420 to obtain information related to wireless node 1410, either from user device 1420 or additionally or alternatively using portable wireless network enhancement device 1402. Working example of FIG. 22 is in a warehouse 2200, wherein a plurality of assets 1406(1), 1406(2) each with a wireless node 1410(1), 1410(2), respectively, are positioned on one or more storage racks 2202, where there are four storage racks 2202(1), 2202(2), 2202(3), 2202(4) shown.

User 1404 may interact with associated application 1422 on user device 1420 to request information about assets 1406 or wireless node 1410 associated therewith. For example, user device 1420, using associated application 1422 thereon, may detect user input 2204 defining a request for information about a specific asset, such as asset 1406(1), or grouping of assets, or type of asset, or asset having specific characteristics associated therewith. The specific characteristic may be an error, such as wrong temperature or temperature history, improper location, improper loading, etc., or a positive event, such as appropriate temperature or temperature history, proper location, properly loaded, etc. In one example, the user input 2204 is a voice request input into user device 1420, such as via a Siri (on Apple devices), Alexa® (Amazon devices), Google Assistant, or other voice or virtual assistance applications. In another example, the user input 2204 is a text input via a touch screen.

In response to the user input 2204, user device 1420, using associated application 1422 thereon, may query wireless network 1400 for data 2206 regarding the requested asset 1406, grouping of assets, type of asset, or asset having specific characteristics associated therewith. The user input 2204 may not be limited to lost assets. Other examples of requests received as user input 2204 include: light up all portable wireless network enhancement device 1402 near ULDs that are misloaded before starting to load up planes. Light up all portable wireless network enhancement device 1402 that are near package cars that have damaged or compromised packages. Light up all portable wireless network enhancement device 1402 that are near equipment tape nodes that is signaling a rule violation or failure state. Light up all portable wireless network enhancement device 1402 near tape nodes that are signaling working/good conditions. In the above examples, the term “light up” refers to causing a respective portable wireless network enhancement device 1402 to generate a user-interpretable signal which may cause a human-interaction interface one the portable wireless network enhancement device to display a light, color, or image, emit audio through a speaker, vibrate the portable wireless network enhancement device 1402 using an integrated vibration device, or some other signal of the human-interaction interface. These examples are non-limiting and other requests may be input without departing from the scope hereof.

If the user device 1420 already has the necessary data regarding the requested asset 1406 (e.g., the data is already stored in memory of user device 1420), the query need not go to an external device. In one embodiment, user device 1420, using associated application 1422 thereon, obtains data 2206 as the wireless node data 1610 discussed above from one or more portable wireless network enhancement device 1402. Alternatively or additionally, user device 1420, using associated application 1422 thereon, obtains wireless node data 2206 from stationary gateway 1412. Alternatively or additionally, user device 1420, using associated application 1422 thereon, obtains wireless node data 2206 from external server 1414, either directly from external server 1414, or through an intermediary device such as stationary gateway 1412.

In response to the received wireless node data 2206, the user device 1420, using associated application 1422 thereon, may generate a query response 2208. The query response 2208 may be a listing of the data 2206. The query response 2208 may be the data 2206 in processed format. The processed format may be a navigation screen including directions for moving to the requested asset. The processed format may be a map displaying location of the requested asset in user input 2204, or a graph displaying historical sensed data (such as temperature, pressure, etc.), or any other processed information derived from data 2206.

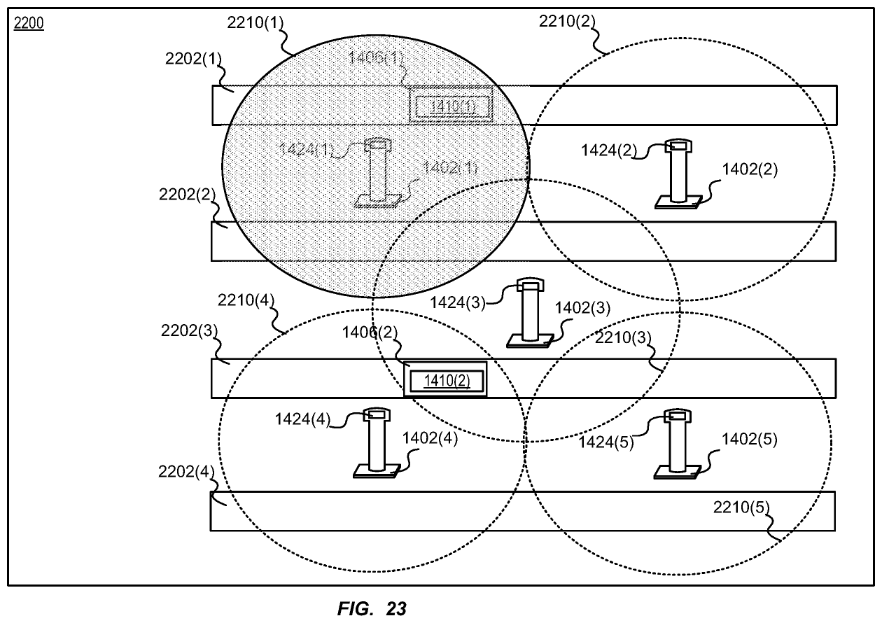

In embodiments, the wireless network 1400, based on user input 2204 may coordinate with one or more other devices, such as one or more portable wireless network enhancement device 1402. In the embodiment of FIG. 22, each portable wireless network enhancement device 1402 is shown having a wireless monitor area radius 2210 in dashed lines. This radius may be used to coordinate triggering one or more human-interaction interface 1424 of the plurality of portable wireless network enhancement devices 1402 based on the requested information in user input 2204. For example, when user input 2204 includes a request to find asset assets 1406(1), wireless network 1400 using either application 1422, or using one or more enhancement controller 1506 of the portable wireless network enhancement devices 1402, may analyze the wireless-node data 1610 gathered by the portable wireless network enhancement devices 1402, to identify the closest portable wireless network enhancement device 1402 nearby the requested asset 1406(1). In the example of FIG. 22, this would be portable wireless network enhancement device 1402(1). As such, human-interaction interface 1424(1) may be triggered (via a user-interpretable signal 1614 received or generated thereat) to signal to user 1404 that the asset 1406(1) is closest to the portable wireless network enhancement device 1402(1). For example, the human-interaction interface 1424(1) may flash a certain color, display a certain image, color, or text, or sound a certain sound indicating that the requested asset is nearby the given portable wireless network enhancement device 1402(1).

Where the requested asset is nearby more than one portable wireless network enhancement device 1402, such as asset 1406(2), more than one human-interaction interface 1424 may be triggered via a user-interpretable signal 1614 received or generated thereat) to signal to user 1404 that the asset 1406(1) is closest to the portable wireless network enhancement device 1402(1). This may allow the user to interact (listen or view) with each respective human-interaction interface 1424 to pinpoint proximate location of the requested asset.

Where query response 2208 includes a map, the map may include a virtual representation of portable wireless network enhancement device 1402(1) as well as the known wireless monitoring area radius 2210(1). In the virtual representation, the wireless monitor area radius 2210(1) may be shaded, highlighted, or otherwise distinguished from other ones of the wireless monitor area radius 2210 that are not nearby the requested asset. FIG. 23 shows an example map including a virtual representation of wireless monitor area radius 2210 showing asset 1406(1) closest to portable wireless network enhancement device 1402(1). The example map may be included in a user interface of an app executing on a user device or on a display of a portable wireless network enhancement device 1402, according to some embodiments.

The query response 2208 may include a history of communication with the asset being searched for. For example, where portable wireless network enhancement device 1402 has received wireless-node data 1610 from the wireless node 1410 within a threshold period, the portable wireless network enhancement device 1402 may trigger its human-interaction interface 1424 to emit a light via display 1520 or display an image that corresponds to how recently it has been in communication with the asset (such as green for current, yellow for somewhat recently, red for a long time ago). Similarly, this historical information may transmitted to user device 1420 for presentation to the user 1404 on user device 1420.

The above-discussed working example includes user 1404 interacting with user device 1420 to initiate obtaining information about assets 1406. However, it should be appreciated that the user 1404 may interact directly with one or more portable wireless network enhancement device 1402 instead of utilizing user device 1420. For example, user input 2204 may be user interaction with human-interaction interface 1424. In such example, the user input 2204 is a voice request input into portable wireless network enhancement device 1402 using microphone 1524, where portable wireless network enhancement device 1402 implements a Siri (on Apple devices), Alexa® (Amazon devices), Google Assistant, or other voice or virtual assistance applications. In another example, the user input 2204 is a text input via a touch screen embodiment of display 1520. Data 2206 may be wireless-node data 1610, or other data received by portable wireless network enhancement device 1402 from stationary gateway 1412 or external server 1414, or another device. Query response 2208 may be an example of user-interpretable signal 1614 that causes human-interaction interface 1424 to interact with user 1404 to provide information about the requested asset in user input 2204. This provides the advantage that the user 1404 need not access user device 1420 to obtain information about a specific asset.

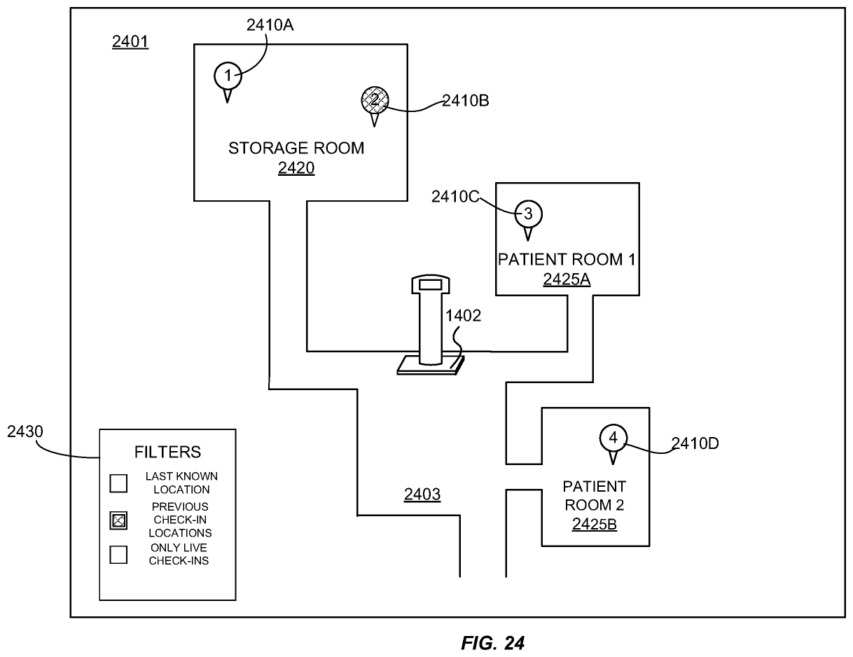

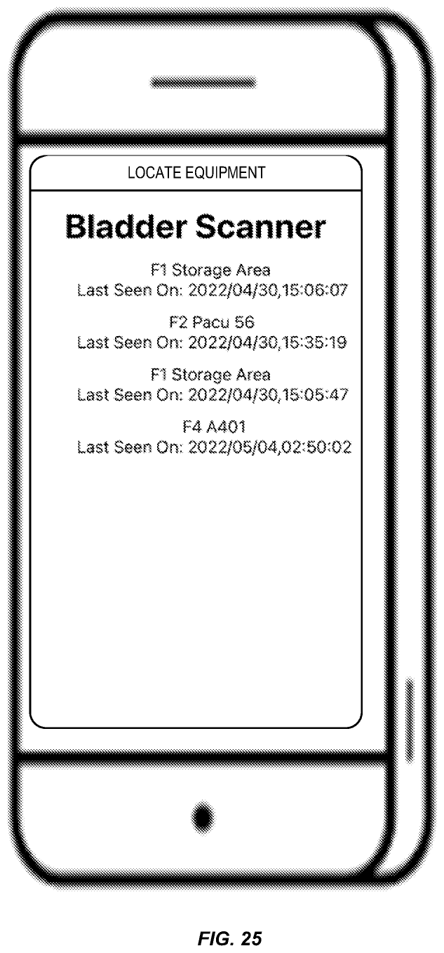

FIG. 24 shows a working example of wireless network 1400 wherein portable wireless network enhancement device 1402 is placed in a hospital setting to monitor location of one or more assets 1910A-D, in an embodiment. Virtual representation of a hospital 2401 is shown with a storage room 2420, and two patient rooms 1925A, 1925B, connected by a hallway 2403. Portable wireless network enhancement device 1402 is shown in hallway 2403, but may be placed anywhere in the hospital. Moreover, more than one portable wireless network enhancement device 1402 may be implemented without departing from scope hereof. The virtual representation of a hospital 2401 may be a map interface that may be displayed on a user device, on a web app, on a web dashboard, or on a display of a of portable wireless network enhancement device 1402, according to some embodiments. For example, the map interface may be displayed in response to a user query to locate one or more assets, such as bladder scanners in the hospital. The virtual representation of the hospital 2401 and map interface associated therewith may include one or more filters 2430, such as last-known location of a given asset, previous-known location of a given asset, and live location (check in) of an asset. Selection of a given filters 2430 may cause a list of information to be displayed on the display, such as a list of the filtered information as shown in FIG. 25, which shows a list of a history of last known locations.

One or more wireless nodes (e.g., wireless node 1410) may track the location of assets 2410 within the hospital 2401. Assets 2410 are an example of one or more assets 1406, and may be any medical device, such as, but not limited to, bladder scanners, imaging machines (ultrasound, X-Ray, etc.), IV pumps, hospital beds, oxygen equipment, or non-device information, such as the doctors, nurses, and hospital staff wearing or otherwise having a wireless node attached thereto. A user may perform voice queries to request tasks or information from the network 400. A voice query may include the user saying to the portable wireless network enhancement device 1402, “Where is the IV Pump”, which is received as input 1652, discussed above. In response, the portable wireless network enhancement device 1402 may obtain wireless-node data 1610 and search for location information for IV pumps or a specific IV pump. If a given information is not found in wireless-node data 1610, the portable wireless network enhancement device 1402 may request information from an external server (e.g., external server 1414), or another device such as another portable wireless network enhancement device 1402. The portable wireless network enhancement device 1402 may then use human-interaction interface 1424 to present relevant location information to the requesting user. For example, display 1520 may display at least a portion of the location information and/or speaker 1522 may play audio which describes at least a portion of the location information using text-to-speech.

Other voice queries include a user asking portable wireless network enhancement device 1402 additional questions. The user, for example, may ask “is there a patient currently in Patient Room 2?” Another example query may include, “what is the temperature in the Storage Room?” The portable wireless network enhancement device 1402 may retrieve relevant data (e.g., wireless-node data 1610) and generate a user-interpretable signal for the user, in response. The relevant data may be retrieved from wireless nodes in Patient Room 2 or from a server of the network 1400. The response may include displaying relevant information on a display or providing information over audio.

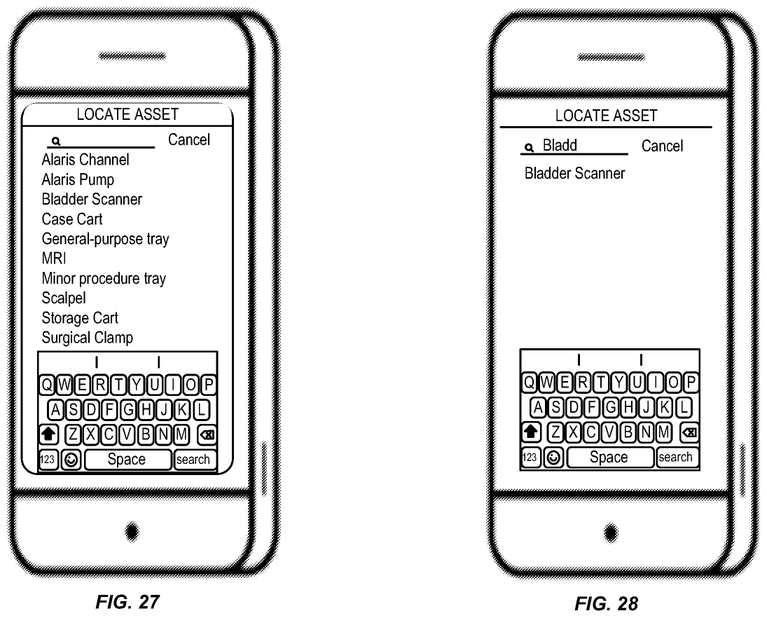

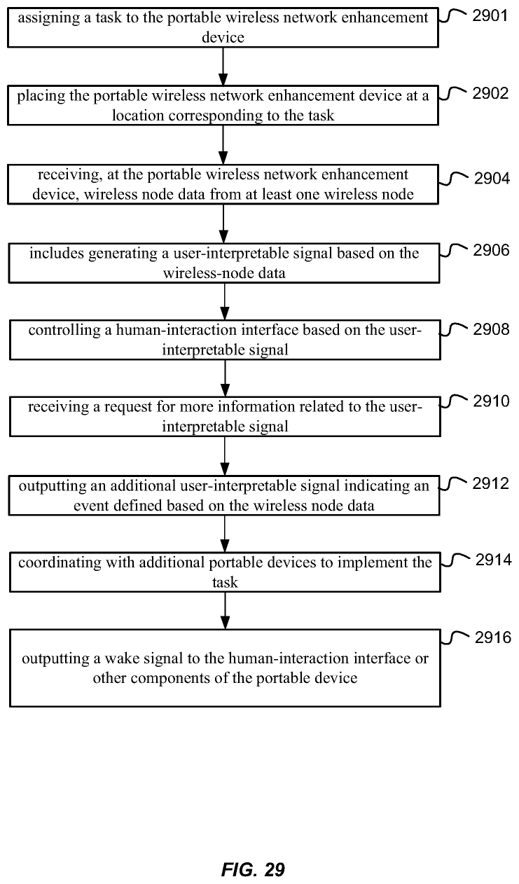

In other embodiments, voice queries and/or the generated responses are performed using a user device (e.g., user device 1420). The relevant information or location information shown in response to a voice query may be displayed on a user device via an app executing on user device or a web dashboard accessed using the user device. Similarly, the user device may generate audio in response to voice queries. A user app may display information or generate audio in response to a voice query received at a portable wireless network enhancement device 1402, according to some embodiments. See FIGS. 25-28 for examples of accessing the location information and performing voice queries using a user device, alternatively to embodiments where the user input and the display is provided by the portable wireless network enhancement device 1402.

The displayed information may further be filterable, such as via filters 2430 which include last known location, previous check-in locations, and live check-in locations. See filters 2430, in FIG. 24.

As discussed above, portable wireless network enhancement device 1402 may also display information using external device external device 1615. In certain embodiments, the external device 1615 may be a user device (e.g., user device 1420). FIG. 25 shows an example display of various searched—for “bladder scanners” in list-format, as opposed to map-format of FIG. 24.

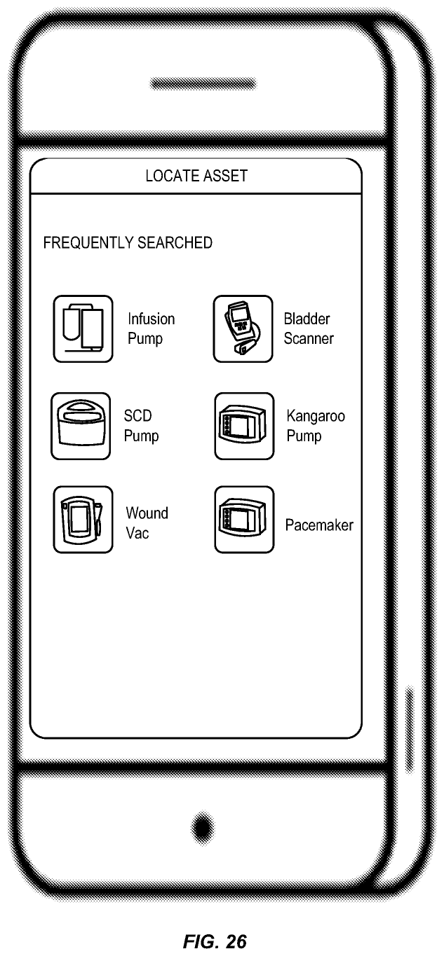

FIGS. 26-28 show a series of screen shots of potential user-device application 1422 that is used to provide input 1652. Associated application 1422 may implement a “locate asset” function wherein associated application 1422 displays a variety of devices having associated wireless node 1410 attached thereto. In the example of FIGS. 24-27, wireless node 1410 are attached to, or coupled with, medical devices including Alaris Channels, Alaris Pumps, Case Carts, General-purpose trays, MRI scanners, Minor procedure trays, Scalpels, Storage Carts, Surgical clamps, infusion pumps, SCD pumps, kangaroo pumps, wound vacs, and pacemakers.

In response to user inputting and selecting a device to be searched for, the user device 1420 may transmit a search signal to the portable wireless network enhancement device 1402, which is received as input 1652. The search signal may also be transmitted to and received by other wireless nodes of the network 1400 in an environment. In response, portable wireless network enhancement device 1402 may implement the above-discussed functionality of location module 1616 to search asset location list 1622 to identify where the requested device is. Once the device is found, the device location may be displayed using display 1520, or otherwise transmitted back to user device 1420 for display thereon.

In the above-discussion, much of the user input received (e.g., input 1652) is initiated by the user. However, the portable wireless network enhancement device 1402 may have an assigned task (e.g., mission task 1632) that enables the portable wireless network enhancement device 1402 to proactively request user input. For example, by monitoring wireless-node data 1610, and comparing that to a given manifest, or other set of conditions associated with the wireless network 1400, portable wireless network enhancement device 1402 may identify when a condition is not met or out of the ordinary. For example, using the medical environment of FIGS. 24-28, wireless-node data 1610 may indicate that a pump is within a trash can. In response, user-interpretable signal 1614 may be generated to display or speak a request using human-interaction interface 1424 such as “Somebody accidentally threw an IV pump in the trash can in room 13, do you have time to resolve?”. As another example, when wireless-node data 1610 indicates that no physical therapists (having a wireless node 1410 associated therewith) are in a given room where the patient of that room has physical therapy scheduled, user-interpretable signal 1614 may be generated to display or speak a request using human-interaction interface 1424 such as “patients in room 10 around the block needs physical therapy—are you available?”. As another example, where wireless-node data 1610 (or other sound-capturing device capable of reporting data within wireless network 1400), indicates excessive noise in a given room, user-interpretable signal 1614 may be generated to display or speak a request using human-interaction interface 1424 such as “There is excessive sounds in room 15, can you check to see if there is an emergency there?”. As yet another example, when a ventilator transmits data indicating an alarm in a hospital room, user-interpretable signal 1614 may be generated to display or speak a request using human-interaction interface 1424 such as “The ventilator is giving an alarm in room 50 and you are the closest nurse—can you help?” It should be appreciated that other proactive requests for user input may be implemented depending on the specific application and environment.

FIG. 29 is a flowchart of an example method 2900 for performing a task using a portable wireless network enhancement device. Method 2900 is implemented using portable wireless network enhancement device 1402, for example. Thus, various steps within method 2900 may implement functionality discussed above with respect to FIGS. 14-28. For example, method 2900 may include, even if a specific flowchart box is not shown in FIG. 29, any of the above-described functionality with respect to any one or more of enhancement controller 1506, wireless-node analyzer module 1606, location module 1616, mission assignment module 1630, power management module 1642, and/or human-interaction module 1650. Moreover, individual, or groupings of steps within method 2900 may be implemented without others. For example, step 2914 or step 2916, and various associated embodiments thereof discussed herein, may be claimed without other steps within method 2900. As another example, steps 2910 and 2912, and various associated embodiments thereof discussed herein, may be implemented without other steps within method 2900.

At step 2901, method 2900 includes assigning a task to the portable wireless network enhancement device. In one example of operation of step 2901, a mission task is received by mission assignment module 1630. For example, the mission task may be an unloading/unloading task, or a task for searching for a specific asset, or a task for relaying information from wireless nodes to an external device, such as server 1414. Step 2901 may include any of the above-discussed functionality of mission assignment module 1630. Step 2901 may include determining a mission task for the portable device based on current location of the portable wireless network enhancement device 1402 implementing method 2900. Step 2901 may include determining a mission task for the portable device based on user input received using the microphone 1524. Step 2901 may include determining a mission task for the portable device based on user input received using the human-interaction interface 1424. Step 2901 may include determining a mission task for the portable device based on a received mission task from an external device, such as any one or more of stationary gateway 1412, external server 1414, user device 1420, and wireless node 1410. Step 2901 may include configuring a hierarchical role of the portable device, and/or other wireless nodes, within a hierarchy of the plurality of wireless nodes. Step 2901 may include one or both of overriding a current mission task of the portable device, and adding an additional mission task.

At step 2902, method 2900 includes placing the portable wireless network enhancement device at a location corresponding to the task. In one example of step 2902, prior to placing the portable wireless network enhancement device at the location, determining the location based on a signal reception level of an area associated with the location. For example, one or more of the wireless node 1410, stationary gateway 1412, user device 1420 may identify available signal reception level at various locations within an area and report to external server 1414 or stationary gateway 1412 to allow wireless network 1400 to indicate that additional signal level is needed at a given area. Portable wireless network enhancement device 1402 allows for temporary enhancement of the signal reception level at those locations. As such, the portable wireless network enhancement device 1402 may function as a communication bridge for wireless nodes in the area associated with the location having a signal reception level that is inadequate for a given task.

At step 2904, method 2900 includes receiving, at the portable wireless network enhancement device, wireless node data from at least one wireless node. In one example of operation of step 2904, portable wireless network enhancement device 1402 receives wireless-node data 1610 from one or more wireless node 1410.

At step 2906, method 2900 includes generating a user-interpretable signal based on the wireless-node data. In one example of operation of step 2904, portable wireless network enhancement device 1402 generates user-interpretable signal 1614 as discussed above.

At step 2908, method 2900 includes control a human-interaction interface based on the user-interpretable signal. In one example of operation of step 2904, portable wireless network enhancement device 1402, controls human-interaction interface 1424 based on user-interpretable signal 1614. In one example of operation of step 2908, human-interaction interface 1424 is display 1520. In such example, step 2908 includes illuminating the display. In such example, step 2908 may flash the display, flash the display a specific color corresponding to a specific notification, illuminate the display (with or without flashing) with a specific color, display a given image on the display, flash the display at a specific frequency/periodicity, cause the display to show a graphic, text, or video, cause another configuration of display 1520, or some combination thereof. In one example of operation of step 2904, human-interaction interface 1424 is one or more speaker 1522. In such example, step 2904 may cause the one or more speaker 1522 to audibly indicate an alert, or other user-interpretable sound.

Step 2908 may alternatively or additionally include controlling an external device based on the user-interpretable signal. For example, the user-interpretable signal may be the above-discussed external-device signal 1613 that controls external device 1615.

In one example of steps 2901-2908, the mission task assigned in step 2901 may be based on user input defining an action that the user intends to perform. In such example, the mission task may specifically include identifying one or more assets required to perform the action that the user intends to perform. In such situation, step 2906 may include analyzing the wireless-node data to determine if asset-specific wireless nodes of the plurality of wireless nodes are in proximity to the portable device; and generate the user-interpretable signal including indication that all of the one or more assets are present or that one or more of the one or more assets are missing. Particular assets in this example may include medical supplies and/or tools needed to perform a job.

As another example of step 2901, the mission task assigned in step 2901 may include an asset-finding task. In such example, in step 2901, method 2900 may include receiving indication of a specific wireless node, or asset associated with the specific wireless node to be searched. Step 2906 may include determining if the specific wireless node is within the wireless-node data; and generating the user-interpretable signal to indicate that the specific wireless node is nearby the portable device. This example illustrates that aspects of method 2900 may be performed at portable wireless network enhancement device 1402, or at user device 1420, such as the functionality discussed above with respect to FIGS. 22-28.

Steps 2910-2912 are optional. At step 2910, method 2900 receives a request for more information related to the user-interpretable signal. At step 2912, if included also with step 2910, method 2900 may output an additional user-interpretable signal indicating an event defined based on the wireless-node data. Step 2912 may also be performed without step 2910, where method 2900 may output additional user-interpretable signal that causes the human-interaction interface 1424 to cease implementing the original user-interpretable signal of steps 2906 and 2908. Steps 2910-2912 provide the advantage that the user 1402 need not stop what they are doing to physically interact with portable wireless network enhancement device 1402, but instead can just speak (or otherwise interact with portable wireless network enhancement device 1402) to portable wireless network enhancement device 1402 to stop the alert caused by user-interpretable signal 1614.

Step 2914 is optional. At step 2914, method 2900 coordinates with additional portable devices to implement the task. For example, the portable wireless network enhancement device 1402 may be one of a plurality of portable wireless network enhancement device 1402 within the network of a plurality of wireless nodes. The plurality of portable wireless network enhancement devices 1402 may coordinate with one another to implement a given task. For example, if the task is finding an asset associated with a specific wireless node, the portable wireless network enhancement device 1402 may coordinate to determine which of a plurality of portable devices is closest to the specific wireless node.

As another example of step 2914, coordinating with other portable devices may include optimizing position of the portable device relative to another portable device to more efficiently implement the mission task. Optimizing the position of the portable device may include, using received signal strength indicator (RSSI) data within the wireless-node data, determining at least one of direction and distance that would yield an optimized location of the portable device within the network. In examples that optimize position of the portable wireless network enhancement device 1402, the user-interpretable signal generated in step 2908 may indicate at least one of the direction and the distance.

Step 2916 is optional. At step 2916, method 2900 outputs a wake signal to the human-interaction interface or other components of the portable device. Step 2916 is implemented using any of the above-functionality discussed above with respect to power management module 1642. In one example of step 2916, method 2900 includes transitioning one or more components of the portable device from an inactive state to an active state in response to detection of a user in proximity to the portable device. In another example of step 2916, the portable device includes a camera, and the method 2900 includes: analyze image or video data from the camera to detect a user within a field of view of the camera; and outputting the wake signal to the human-interaction interface in response to detection of the user.

### Additional Configuration Information

The foregoing description of the embodiments of the disclosure have been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

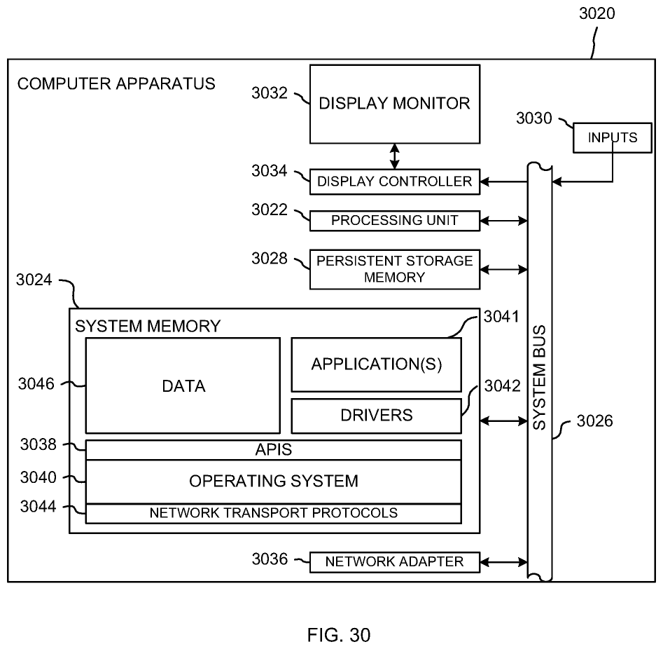

FIG. 30 shows an example embodiment of computer apparatus 3020 that, either alone or in combination with one or more other computing apparatus, is operable to implement one or more of the computer systems described in this specification. For example, computer apparatus 3020 may represent computing apparatus of any of segments 113 of FIGS. 1 and 2, wireless transducing circuit 410 of FIG. 4, segments 640, 670, and 680 of FIGS. 6A-6C, and any of the tape nodes derived therefrom, and server 704 of FIG. 7. Computer apparatus 3020 may also represent computing apparatus of any of portable wireless network enhancement device 1402, and the enhancement controller 1506 of FIGS. 14-16 discussed above. The computer apparatus 3020 includes a processing unit 3022, a system memory 3024, and a system bus 3026 that couples the processing unit 3022 to the various components of the computer apparatus 3020. The processing unit 3022 may include one or more data processors, each of which may be in the form of any one of various commercially available computer processors. The system memory 3024 includes one or more computer-readable media that typically are associated with a software application addressing space that defines the addresses that are available to software applications. The system memory 3024 may include a read only memory (ROM) that stores a basic input/output system (BIOS) that contains start-up routines for the computer apparatus 3020, and a random-access memory (RAM). The system bus 3026 may be a memory bus, a peripheral bus, or a local bus, and may be compatible with any of a variety of bus protocols, including PCI, VESA, Microchannel, ISA, and EISA. The computer apparatus 3020 also includes a persistent storage memory 3028 (e.g., a hard drive, a floppy drive, a CD ROM drive, magnetic tape drives, flash memory devices, and digital video disks) that is connected to the system bus 3026 and contains one or more computer-readable media disks that provide non-volatile or persistent storage for data, data structures and computer-executable instructions.

A user may interact (e.g., input commands or data) with the computer apparatus 3020 using one or more input devices 3030 (e.g. one or more keyboards, computer mice, microphones, cameras, joysticks, physical motion sensors, and touch pads including human-interaction interface 1424 discussed above). Information may be presented through a graphical user interface (GUI) that is presented to the user on a display monitor 3032, which is controlled by a display controller 3034 and is an example of display 1520. The computer apparatus 3020 also may include other input/output hardware (e.g., peripheral output devices, such as speakers and a printer). The computer apparatus 3020 connects to other network nodes through a network adapter 3036 (also referred to as a “network interface card” or NIC) which is an example of wireless communication module 1508.

A number of program modules may be stored in the system memory 3024, including application programming interfaces 3038 (APIs), an operating system (OS) 3040 (e.g., the Windows® operating system available from Microsoft Corporation of Redmond, Washington U.S.A.), software applications 3041 including one or more software applications programming the computer apparatus 3020 to perform one or more of the steps, tasks, operations, or processes of the positioning and/or tracking systems described herein, drivers 3042 (e.g., a GUI driver), network transport protocols 3044, and data 3046 (e.g., input data, output data, program data, a registry, and configuration settings).

### Combination of Features

The following establishes a list of clauses that relate to potential claims. It should be appreciated that the following clauses may be combined in any manner without departing from scope hereof.

Clause 1. A portable device for enhancing network of a plurality of wireless nodes, comprising: a housing sized and shaped to enclose: a power source; a wireless communication module including an antenna and associated transceiver circuitry coupled with the antenna to receive and transmit wireless signals; a human-interaction interface; a memory storing computer-readable instructions; and a processor in communication with the power source, the wireless communication module, and the memory; the housing being sized and shaped to self-stand when placed at a location; the computer-readable instructions, when executed by the processor, cause the portable device to: scan, using the wireless communication module, for ones of the plurality of wireless nodes within operating range of the wireless communication module; receive, in response to the scan, wireless-node data from responding ones of the plurality of wireless nodes; generate a user-interpretable signal based on the wireless-node data; and output, using the human-interaction interface, the user-interpretable signal.

Clause 2. The portable device of any preceding clause or combination of preceding clauses, the housing comprising: a base; an extension extending upward from the base; and a top area at an opposite end of the extension from the base.

Clause 3. The portable device of any preceding clause or combination of preceding clauses, the base having a first width and a first height, the extension having a second width and a second height, the first width being greater than the second width.

Clause 4. The portable device of any preceding clause or combination of preceding clauses, the second height being greater than the first height.

Clause 5. The portable device of any preceding clause or combination of preceding clauses, the power source being located closer to the base than the top area.

Clause 6. The portable device of any preceding clause or combination of preceding clauses, the antenna extending within the extension.

Clause 7. The portable device of any preceding clause or combination of preceding clauses, the antenna having a length greater than 50% of a height of the extension.

Clause 8. The portable device of any preceding clause or combination of preceding clauses, the antenna comprising a receiving antenna and a transmitting antenna.

Clause 9. The portable device of any preceding clause or combination of preceding clauses, the extension having a width that tapers from the base to the top area.

Clause 10. The portable device of any preceding clause or combination of preceding clauses, further comprising a wireless energy harvesting coil implementing a wireless charging protocol and located in the base, the wireless energy harvesting coil configured to charge a power source using electromagnetic energy received from a wireless energy harvesting pad external to the portable device.

Clause 11. The portable device of any preceding clause or combination of preceding clauses, the housing having a box form-factor.

Clause 12. The portable device of any preceding clause or combination of preceding clauses, the housing having a handle for maneuverability of the portable device.

Clause 13. The portable device of any preceding clause or combination of preceding clauses, the power source being a rechargeable battery.

Clause 14. The portable device of any preceding clause or combination of preceding clauses, comprising further computer-readable instructions that, when executed by the processor, cause the portable device to: monitor a charge level of the rechargeable battery; and output a charge-signal using the wireless communication module indicating that the rechargeable battery needs charging.

Clause 15. The portable device of any preceding clause or combination of preceding clauses, the housing having a battery slot configured to releasably retain the rechargeable battery.

Clause 16. The portable device of any preceding clause or combination of preceding clauses, the portable device further comprising an energy harvesting device.

Clause 17. The portable device of any preceding clause or combination of preceding clauses, the energy harvesting device including one or more of a solar panel, a wireless energy harvesting device, and a vibration-based energy harvesting device.

Clause 18. The portable device of any preceding clause or combination of preceding clauses, the power source being a line-power source.

Clause 19. The portable device of any preceding clause or combination of preceding clauses, the human-interaction interface including a display.

Clause 20. The portable device of any preceding clause or combination of preceding clauses, wherein the user-interpretable signal includes illuminating the display.

Clause 21. The portable device of any preceding clause or combination of preceding clauses, the human-interaction interface including a speaker.

Clause 22. The portable device of any preceding clause or combination of preceding clauses, the human-interaction interface including a microphone.

Clause 23. The portable device of any preceding clause or combination of preceding clauses, comprising further computer-readable instructions that, when executed by the processor, further cause the portable device to: determine a mission task for the portable device based on user input received using the microphone.

Clause 24. The portable device of any preceding clause or combination of preceding clauses, the mission task including terminating the user-interpretable signal when the user input indicates that a user has resolved an event defined within the wireless-node data.

Clause 25. The portable device of any preceding clause or combination of preceding clauses, the user input requesting more information related to the user-interpretable signal; the mission task including outputting an additional user-interpretable signal indicating an event defined based on the wireless-node data.

Clause 26. The portable device of any preceding clause or combination of preceding clauses, the user input defining an action that the user intends to perform; the mission task including: identify one or more assets required to perform the action, analyze the wireless-node data to determine if asset-specific wireless nodes of the plurality of wireless nodes are in proximity to the portable device, and generate the user-interpretable signal including indication that all of the one or more assets are present or that one or more of the one or more assets are missing.

Clause 27. The portable device of any preceding clause or combination of preceding clauses, the one or more assets being medical supplies needed to perform a surgery.

Clause 28. The portable device of any preceding clause or combination of preceding clauses, the one or more assets being tools needed to perform a job.

Clause 29. The portable device of any preceding clause or combination of preceding clauses, further comprising one or more of a light sensor, a vibration sensor, a temperature sensor, a humidity sensor, a pressure sensor, an accelerometer, and an orientation sensor.

Clause 30. The portable device of any preceding clause or combination of preceding clauses, the wireless communication module implementing a plurality of wireless communication protocols.

Clause 31. The portable device of any preceding clause or combination of preceding clauses, at least one of the plurality of wireless communication protocols including RFID reading capability.

Clause 32. The portable device of any preceding clause or combination of preceding clauses, comprising further computer-readable instructions that, when executed by the processor, further cause the portable device to: receive indication of a specific wireless node, or asset associated with the specific wireless node, to be searched; determine if the specific wireless node is within the wireless-node data; and generate the user-interpretable signal to indicate that the specific wireless node is nearby the portable device.

Clause 33. The portable device of any preceding clause or combination of preceding clauses, the portable device further comprising a display integral with the housing; the user-interpretable signal causing the display to indicate that the specific wireless node or asset is nearby the portable device.

Clause 34. The portable device of any preceding clause or combination of preceding clauses, the portable device being in wireless communication with a display external to the portable device; the user-interpretable signal causing the display to indicate that the specific wireless node or asset is nearby the portable device.

Clause 35. The portable device of any preceding clause or combination of preceding clauses, the user-interpretable signal further indicating that a user is to look at the display external to the portable device.

Clause 36. The portable device of any preceding clause or combination of preceding clauses, the portable device including a speaker; the user-interpretable signal causing the speaker to indicate that the specific wireless node or asset is nearby the portable device.

Clause 37. The portable device of any preceding clause or combination of preceding clauses, the portable device being one of a plurality of portable devices within the network of a plurality of wireless nodes; the portable device comprising further computer-readable instructions that, when executed by the processor, further cause the portable device to: coordinate with additional portable devices to determine which of the plurality of portable devices is closest to the specific wireless node.

Clause 38. The portable device of any preceding clause or combination of preceding clauses, the memory storing a current location of the portable device; the portable device comprising further computer-readable instructions that, when executed by the processor, cause the portable device to: set a mission task of the portable device based on the current location.

Clause 39. The portable device of any preceding clause or combination of preceding clauses, the memory storing a current location of the portable device; the portable device comprising further computer-readable instructions that, when executed by the processor, cause the portable device to optimize position of the portable device relative to another portable device.

Clause 40. The portable device of any preceding clause or combination of preceding clauses, comprising additional computer-readable instructions that, when executed by the processor, cause the portable device to: using received signal strength indicator (RSSI) data within the wireless-node data, determine at least one of direction and distance that would yield an optimized location of the portable device within the network; wherein the user-interpretable signal indicates at least one of the direction and the distance.

Clause 41. The portable device of any preceding clause or combination of preceding clauses, the RSSI data including RSSI data from another portable device, wherein the optimized location results in positioning of the portable device with respect to the another portable device.

Clause 42. The portable device of any preceding clause or combination of preceding clauses, the current location being defined based on a GPS device located within the housing.

Clause 43. The portable device of any preceding clause or combination of preceding clauses, the current location being defined based on a location signal received using the wireless communication module.

Clause 44. The portable device of any preceding clause or combination of preceding clauses, comprising a node manager as further computer-readable instructions stored within the memory that, when executed by the processor, further cause the portable device to: configure, based at least in part on result of the scan, a hierarchical role of the portable device within a hierarchy of the plurality of wireless nodes.

Clause 45. The portable device of any preceding clause or combination of preceding clauses, the hierarchical role configured by the portable device overriding any other hierarchical roles within the network.

Clause 46. The portable device of any preceding clause or combination of preceding clauses, the hierarchical role including receiving sensed data from one or more of the plurality of nodes and relaying the received sensed data to an external server using the wireless communication module.

Clause 47. The portable device of any preceding clause or combination of preceding clauses, further comprising transitioning one or more components of the portable device from an inactive state to an active state in response to detection of a user in proximity to the portable device.

Clause 48. The portable device of any preceding clause or combination of preceding clauses, further comprising: a camera; and, further computer readable instructions that, when executed by the processor, cause the portable device to: analyze image or video data from the camera to detect a user within a field of view of the camera; output a wake signal to the human-interaction interface in response to detection of the user.

Clause 49. The portable device of any preceding clause or combination of preceding clauses, comprising further computer-readable instructions that, when executed by the processor, cause the portable device to: output a wake signal to the human-interaction interface and/or other components of the portable device in response to detection of an authorization device associated with a user.

Clause 50. The portable device of any preceding clause or combination of preceding clauses, the authorization device being an RFID tag, a wearable device, or a handheld device.

Clause 51. The portable device of any preceding clause or combination of preceding clauses, comprising further computer-readable instructions that, when executed by the processor, cause the portable device to: coordinate with additional portable devices to define a virtual transmission line via relay of data between the portable devices.

Clause 52. The portable device of any preceding clause or combination of preceding clauses, comprising further computer-readable instructions that, when executed by the processor, cause the portable device to analyze the wireless-node data to identify when one or more of the wireless nodes breaches a geofence defined within the memory of the portable device; wherein the user-interpretable signal indicates that a wireless node has breached the geofence.

Clause 53. The portable device of any preceding clause or combination of preceding clauses, comprising further computer-readable instructions that, when executed by the processor, cause the portable device to receive a mission task from an external device.

Clause 54. The portable device of any preceding clause or combination of preceding clauses, the external device being a server.

Clause 55. The portable device of any preceding clause or combination of preceding clauses, the external device being one of the plurality of wireless nodes.

Clause 56. The portable device of any preceding clause or combination of preceding clauses, the mission task one or both of overriding a current mission task of the portable device, and adding an additional mission task.

Clause 57. A method for performing a task using a portable wireless network enhancement device, the method comprising: assigning a task to the portable wireless network enhancement device; receiving, at the portable wireless network enhancement device, wireless node data from at least one wireless node; generating a user-interpretable signal based on the wireless-node data; and, control a human-interaction interface based on the user-interpretable signal.

Clause 58. The method of any preceding clause after clause 57 or combination of preceding clauses after clause 57, the task being a loading or unloading task.

Clause 59. The method of any preceding clause after clause 57 or combination of preceding clauses after clause 57, the at least one wireless node being associated with assets being loaded and unloaded, and/or at least one container in which the assets are being loaded into or unloaded from.

Clause 60. The method of any preceding clause after clause 57 or combination of preceding clauses after clause 57, the user-interpretable signal indicating an asset being improperly loaded.

Clause 61. The method of any preceding clause after clause 57 or combination of preceding clauses after clause 57, the user-interpretable signal indicating an asset being properly loaded.

Clause 62. The method of any preceding clause after clause 57 or combination of preceding clauses after clause 57, further comprising generating the user-interpreted signal when the wireless node data indicates a wireless node is improperly being loaded into a container.

Clause 63. The method of any preceding clause after clause 57 or combination of preceding clauses after clause 57, further comprising outputting a misload signal to an external server when the wireless node data indicates a wireless node is improperly being loaded into a container and not unloaded after a period of time.

Clause 64. The method of any preceding clause after clause 57 or combination of preceding clauses after clause 57, further comprising placing the portable wireless network enhancement device at a location corresponding to the task.

Clause 65. The method of any preceding clause after clause 57 or combination of preceding clauses after clause 57, further comprising: prior to placing the portable wireless network enhancement device at the location, determining the location based on a signal reception level of an area associated with the location.

Clause 66. The method of any preceding clause after clause 57 or combination of preceding clauses after clause 57, wherein the portable wireless network enhancement device functions as a communication bridge for wireless nodes in the area associated with the location.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A portable device for enhancing network of a plurality of wireless nodes, comprising:
a housing sized and shaped to enclose:
a power source;
a wireless communication module including an antenna and associated transceiver circuitry coupled with the antenna to receive and transmit wireless signals;
a human-interaction interface;
a memory storing computer-readable instructions; and
a processor in communication with the power source, the wireless communication module, and the memory;
the housing being sized and shaped to self-stand when placed at a location;
the computer-readable instructions, when executed by the processor, cause the portable device to:
scan, using the wireless communication module, for ones of the plurality of wireless nodes within operating range of the wireless communication module;
receive, in response to the scan, wireless-node data from responding ones of the plurality of wireless nodes;
generate a user-interpretable signal based on the wireless-node data; and
output, using the human-interaction interface, the user-interpretable signal.

2. The portable device of claim 1, the housing comprising:
a base;
an extension extending upward from the base; and
a top area at an opposite end of the extension from the base.

3. The portable device of claim 1, the housing having a box form-factor.

4. The portable device of claim 1, the housing having a handle for maneuverability of the portable device.

5. The portable device of claim 1, the power source being a rechargeable battery; the housing having a battery slot configured to releasably retain the rechargeable battery.

6. The portable device of claim 1, the portable device further comprising an energy harvesting device.

7. The portable device of claim 1, the human-interaction interface including a display.

8. The portable device of claim 1, the human-interaction interface including a speaker.

9. The portable device of claim 1, the human-interaction interface including a microphone.

10. The portable device of claim 9, comprising further computer-readable instructions that, when executed by the processor, further cause the portable device to:
determine a mission task for the portable device based on user input received using the microphone.

11. The portable device of claim 10, the mission task including terminating the user-interpretable signal when the user input indicates that a user has resolved an event defined within the wireless-node data.

12. The portable device of claim 10,
the user input defining an action that the user intends to perform;
the mission task including:
identify one or more assets required to perform the action,
analyze the wireless-node data to determine if asset-specific wireless nodes of the plurality of wireless nodes are in proximity to the portable device, and
generate the user-interpretable signal including indication that all of the one or more assets are present or that one or more of the one or more assets are missing.

13. The portable device of claim 1, the wireless communication module implementing a plurality of wireless communication protocols; at least one of the plurality of wireless communication protocols including RFID reading capability.

14. The portable device of claim 1, comprising further computer-readable instructions that, when executed by the processor, further cause the portable device to:
receive indication of a specific wireless node, or asset associated with the specific wireless node, to be searched;
determine if the specific wireless node is within the wireless-node data; and
generate the user-interpretable signal to indicate that the specific wireless node is nearby the portable device.

15. A method for performing a task using a portable wireless network enhancement device, the method comprising:
assigning a task to the portable wireless network enhancement device;
receiving, at the portable wireless network enhancement device, wireless-node data from at least one wireless node;
generating a user-interpretable signal based on the wireless-node data; and,
control a human-interaction interface based on the user-interpretable signal.

16. The method of claim 15, the task being a loading or unloading task.

17. The method of claim 16, the at least one wireless node being associated with assets being loaded and unloaded, and/or at least one container in which the assets are being loaded into or unloaded from.

18. The method of claim 16, the user-interpretable signal indicating an asset being improperly loaded.

19. The method of claim 16, the user-interpretable signal indicating an asset being properly loaded.

20. The method of claim 15, further comprising outputting a misload signal to an external server when the wireless node data indicates a wireless node is improperly being loaded into a container and not unloaded after a period of time.
